(19) United States
(12) Patent Application Publication
(10) Pub. No.: US 2005/0152543 A1
(43) Pub. Date: Jul. 14, 2005

(54) Printer and print system

(76) Inventors: Toshihiro Shima, Nagano-ken (JP); Teruhito Kojima, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/980,432

(22) Filed: Nov. 2, 2004

(30) Foreign Application Priority Data
Nov. 4, 2003 (JP) 2003-374722
Nov. 6, 2003 (JP) 2003-377129
Nov. 13, 2003 (JP) 2003-383561

(51) Int. Cl. H04L 9/00

(52) U.S. Cl. 380/51; 380/277

(57) ABSTRACT

A printer disclosed herein has: a first printer position information acquisition which acquires first printer position information; a first common key generator which creates a first variable based on the first printer position information and generates a first common key with the first variable; a first common key storage in which the generated first common key is stored; a first common key transmitter which transmits the first common key to a print client; an encrypted print data receiver which receives encrypted print data from the print client; a second printer position information acquisition which acquires second printer position information; a second common key generator which creates a second variable based on the second printer position information and generates a second common key with the second variable; and a print data acquisition which decrypts the encrypted print data with the second common key to acquire the print data.

### BACKGROUND OF THE INVENTION

1. Field of the Invention

The present invention relates to a printer and a print system, and particularly relates to a printer capable of restricting the place where print data can be printed and a print system including such a printer.

2. Description of the Related Art

Recently, as a business model using a printer, a model, in which a printer manufacturer lends a printer to a user without charge and the user pays the printer manufacturer only usage fees proportional to the number of sheets the user printed with this printer, is attracting considerable attention. In such a business model, in addition to a charge proportional to the number of printed sheets, a charge proportional to the period of use, a charge proportional to the amount of ink used, and the like are conceivable.

There is a demand that when print data is transmitted from a print client such as a computer to a printer, the security of the print data be ensured by restricting the position of a printer capable of printing this print data. In response to such a demand, there is disclosed a technique for not only encrypting print data and transmitting it from a computer to a printer, but also restricting the position of a printer capable of decrypting this encrypted print data in Japanese Patent application Laid-open No. Hei 11-331144 (hereinafter referred to as Patent Document 1).

In a print system in this Patent Document 1, an encryption server manages an encryption key and a decryption key. When a computer which transmits data acquires the encryption key from the encryption server, the computer designates a position to which the decryption key may be transmitted and simultaneously encrypts the print data with the encryption key and transmits this encrypted print data to the printer. The printer which has received the encrypted print data transmits the position of the printer to the encryption server. The encryption server transmits the decryption key to the printer only when the position of the printer matches the position designated by the computer.

In the aforementioned business model in which the printer is lent without charge, if the user sells the printer borrowed from the printer manufacturer without permission or lends the printer to another person, the printer manufacturer cannot charge for the use of the printer. Therefore, the printer manufacturer wants to limit the place where the lent printer can be used, that is, the place where a proper print operation can be executed to a place of the user to whom the printer is lent.

In the print system in Patent Document 1, when the encrypted data is transmitted, only the position of the printer capable of decrypting the data can be designated, and therefore even in the case of a printer moved without permission, a print operation can be executed if the position of the printer is correctly designated.

### SUMMARY OF THE INVENTION

Hence, the present invention is made in view of the aforementioned problem, and one of objects of the present invention is to provide a printer capable of executing a print operation only in a place registered in advance and a print system including such a printer.

In order to accomplish the aforementioned and other objects, according to one aspect of the present invention, a printer which executes a print operation based on print data, comprises:
a first printer position information acquisition which acquires first printer position information to specify a place where the printer is installed;
a first common key generator which creates a first variable based on the first printer position information and generates a first common key with the first variable;
a first common key storage in which the generated first common key is stored;
a first common key transmitter which transmits the first common key stored in the first common key storage to a print client in response to a request from the print client;
an encrypted print data receiver which receives encrypted print data generated by encrypting print data with the first common key from the print client;
a second printer position information acquisition which acquires second printer position information to specify a place where the printer is installed;
a second common key generator which creates a second variable based on the second printer position information and generates a second common key with the second variable; and
a print data acquisition which decrypts the encrypted print data with the second common key to acquire the print data.

According to another aspect of the present invention, a control method of a printer which executes a print operation based on print data, comprises the steps of:
acquiring first printer position information to specify a place where the printer is installed;
creating a first variable based on the first printer position information and generating a first common key with the first variable;
storing the generated first common key in a first common key storage;
transmitting the first common key stored in the first common key storage to a print client in response to a request from the print client;
receiving encrypted print data generated by encrypting print data with the first common key from the print client;
acquiring second printer position information to specify a place where the printer is installed;
creating a second variable based on the second printer position information and generating a second common key with the second variable; and
decrypting the encrypted print data with the second common key to acquire the print data.

According to another aspect of the present invention, a print system includes a printer which executes a print operation based on print data and a print client connected to the printer, wherein
the printer comprises:
a first printer position information acquisition which acquires first printer position information to specify a place where the printer is installed;
a first common key generator which creates a first variable based on the first printer position information and generates a first common key with the first variable; and
a first common key in which the generated first common key is stored,
the print client comprises:
a first common key transmission request transmitter which transmits a first common key transmission request to request transmission of the first common key to the printer,
the printer further comprises:
a first common key transmission request receiver which receives the first common key transmission request; and
a first common key transmitter which transmits the first common key stored in the first common key storage to the print client when the first common key transmission request has been received,
the print client further comprises:
a first common key receiver which receives the first common key;
an encrypted print data generator which encrypts print data with the first common key to generate encrypted print data; and
an encrypted print data transmitter which transmits the encrypted print data to the printer, and
the printer further comprises:
an encrypted print data receiver which receives the encrypted print data;
a second printer position information acquisition which acquires second printer position information to specify a place where the printer is installed;
a second common key generator which creates a second variable based on the second printer position information and generates a second common key with the second variable; and
a print data acquisition which decrypts the encrypted print data with the second common key to acquire the print data.

According to another aspect of the present invention, a control method of a print system including a printer which executes a print operation based on print data and a print client connected to the printer, comprises the steps of:
acquiring first printer position information to specify a place where the printer is installed;
creating a first variable based on the first printer position information and generating a first common key with the first variable in the printer;
storing the generated first common key in a first common key storage of the printer;
transmitting a first common key transmission request to request transmission of the first common key from the print client to the printer;
receiving the first common key transmission request in the printer;
transmitting the first common key stored in the first common key storage from the printer to the print client when the first common key transmission request has been received in the printer;
receiving the first common key in the print client;
encrypting print data with the first common key to generate encrypted print data in the print client;
transmitting the encrypted print data from the print client to the printer;
receiving the encrypted print data in the printer;
acquiring second printer position information to specify a place where the printer is installed;
creating a second variable based on the second printer position information and generating a second common key with the second variable in the printer; and
decrypting the encrypted print data with the second common key to acquire the print data in the printer.

According to another aspect of the present invention, a data receiving device which executes a process based on received data, comprises:
a first data receiving device position information acquisition which acquires first data receiving device position information to specify a place where the data receiving device is installed;
a first common key generator which creates a first variable based on the first data receiving device position information and generates a first common key with the first variable;
a first common key storage in which the generated first common key is stored;
a first common key transmitter which transmits the first common key stored in the first common key storage to a data transmitting device in response to a request from the data transmitting device;
an encrypted data receiver which receives encrypted data generated by encrypting data with the first common key from the data transmitting device;
a second data receiving device position information acquisition which acquires second data receiving device position information to specify a place where the data receiving device is installed;
a second common key generator which creates a second variable based on the second data receiving device position information and generates a second common key with the second variable; and
a data acquisition which decrypts the encrypted data with the second common key to acquire the data.

According to another aspect of the present invention, a data transmitting and receiving system includes a data receiving device which executes a process based on data and a data transmitting device connected to the data receiving device, wherein
the data receiving device comprises:
a first data receiving device position information acquisition which acquires first data receiving device position information to specify a place where the data receiving device is installed;
a first common key generator which creates a first variable based on the first data receiving device position information and generates a first common key with the first variable; and
a first common key storage in which the generated first common key is stored,
the data transmitting device comprises:
a first common key transmission request transmitter which transmits a first common key transmission request to request transmission of the first common key to the data receiving device,
the data receiving device further comprises:
a first common key transmission request receiver which receives the first common key transmission request; and
a first common key transmitter which transmits the first common key stored in the first common key storage to the data transmitting device when the first common key transmission request has been received,
the data transmitting device further comprises:
a first common key receiver which receives the first common key;
an encrypted data generator which encrypts data with the first common key to generate encrypted data; and
an encrypted data transmitter which transmits the encrypted data to the data receiving device, and
the data receiving device further comprises:
an encrypted data receiver which receives the encrypted data;
a second data receiving device position information acquisition which acquires second data receiving device position information to specify a place where the data receiving device is installed;
a second common key generator which creates a second variable based on the second data receiving device position information and generates a second common key with the second variable; and
a data acquisition which decrypts the encrypted data with the second common key to acquire the data.

According to another aspect of the present invention, a printer which executes a print operation based on print data, comprises:
a first printer position information acquisition which acquires first printer position information to specify a place where the printer is installed;
a printer public key generator which generates a printer public key with a passphrase containing at least the first printer position information;
a printer public key storage in which the printer public key generated by the printer public key generator is stored;
a printer public key transmitter which transmits the printer public key stored in the printer public key storage to a print client in response to a request from the print client;
an encrypted client public key receiver which receives an encrypted client public key generated by encrypting a client public key with the printer public key from the print client;
a second printer position information acquisition which acquires second printer position information to specify a place where the printer is installed;
a printer private key generator which generates a printer private key with a passphrase containing at least the second printer position information; and
a client public key acquisition which decrypts the encrypted client public key received by the encrypted client public key receiver with the printer private key to acquire the client public key.

According to another aspect of the present invention, a control method of a printer which executes a print operation based on print data, comprises the steps of:
acquiring first printer position information to specify a place where the printer is installed;
generating a printer public key with a passphrase containing at least the first printer position information;
storing the generated printer public key in a printer public key storage;
transmitting the printer public key stored in the printer public key storage to a print client in response to a request from the print client;
receiving an encrypted client public key generated by encrypting a client public key with the printer public key from the print client;
acquiring second printer position information to specify a place where the printer is installed;
generating a printer private key with a passphrase containing at least the second printer position information; and
decrypting the received encrypted client public key with the printer private key to acquire the client public key.

According to another aspect of the present invention, a print system includes a printer which executes a print operation based on print data and a print client connected to the printer, wherein
the printer comprises:
a first printer position information acquisition which acquires first printer position information to specify a place where the printer is installed;
a printer public key generator which generates a printer public key with a passphrase containing at least the first printer position information; and
a printer public key storage in which the printer public key generated by the printer public key generator is stored,
the print client comprises:
a public key transmission request transmitter which transmits a public key transmission request to request transmission of the printer public key to the printer,
the printer further comprises:
a public key transmission request receiver which receives the public key transmission request transmitted form the print client; and
a printer public key transmitter which transmits the printer public key stored in the printer public key storage to the print client in response to the received public key transmission request,
the print client further comprises:
a printer public key receiver which receives the printer public key transmitted from the printer;
an encrypted client public key generator which generates an encrypted client public key by encrypting a client public key with the printer public key; and
an encrypted client public key transmitter which transmits the encrypted client public key to the printer, and
the printer further comprises:
an encrypted client public key receiver which receives the encrypted client public key transmitted from the print client;
a second printer position information acquisition which acquires second printer position information to specify a place where the printer is installed;
a printer private key generator which generates a printer private key with a passphrase containing at least the second printer position information; and
a client public key acquisition which decrypts the encrypted client public key received by the encrypted client public key receiver with the printer private key to acquire the client public key.

According to another aspect of the present invention, a control method of a print system including a printer which executes a print operation based on print data and a print client connected to the printer, comprises the steps of:
acquiring first printer position information to specify a place where the printer is installed in the printer;
generating a printer public key with a passphrase containing at least the first printer position information in the printer;
storing the generated printer public key in a printer public key storage of the printer;
transmitting a public key transmission request to request transmission of the printer public key from the print client to the printer;
receiving the public key transmission request transmitted form the print client in the printer;
transmitting the printer public key stored in the printer public key storage from the printer to the print client in response to the received public key transmission request;
receiving the printer public key transmitted from the printer in the print client;
generating an encrypted client public key by encrypting a client public key with the printer public key in the print client;
transmitting the encrypted client public key from the print client to the printer;
receiving the encrypted client public key transmitted from the print client in the printer;
acquiring second printer position information to specify a place where the printer is installed;
generating a printer private key with a passphrase containing at least the second printer position information; and
decrypting the received encrypted client public key with the printer private key to acquire the client public key.

According to another aspect of the present invention, a data receiving device which executes a process based on received data, comprises:
a first data receiving device position information acquisition which acquires first data receiving device position information to specify a place where the data receiving device is installed;
a data receiving device public key generator which generates a data receiving device public key with a passphrase containing at least the first data receiving device position information;
a data receiving device public key storage in which the data receiving device public key generated by the data receiving device public key generator is stored;
a data receiving device public key transmitter which transmits the data receiving device public key stored in the data receiving device public key storage to a data transmitting device in response to a request from the data transmitting device;
an encrypted data transmitting device public key receiver which receives an encrypted data transmitting device public key generated by encrypting a data transmitting device public key with the data receiving device public key from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information; and
a data transmitting device public key acquisition which decrypts the encrypted data transmitting device public key received by the encrypted data transmitting device public key receiver with the data receiving device private key to acquire the data transmitting device public key.

According to another aspect of the present invention, a data transmitting and receiving system includes a data receiving device which executes a process based on received data and a data transmitting device connected to the data receiving device, wherein
the data receiving device comprises:
a first data receiving device position information acquisition which acquires first data receiving device position information to specify a place where the data receiving device is installed;
a data receiving device public key generator which generates a data receiving device public key with a passphrase containing at least the first data receiving device position information; and
a data receiving device public key storage in which the data receiving device public key generated by the data receiving device public key generator is stored,
the data transmitting device comprises:
a public key transmission request transmitter which transmits a public key transmission request to request transmission of the data receiving device public key to the data receiving device,
the data receiving device further comprises:
a public key transmission request receiver which receives the public key transmission request transmitted form the data transmitting device; and
a data receiving device public key transmitter which transmits the data receiving device public key stored in the data receiving device public key storage to the data transmitting device in response to the received public key transmission request,
the data transmitting device further comprises:
a data receiving device public key receiver which receives the data receiving device public key transmitted from the data receiving device;
an encrypted data transmitting device public key generator which generates an encrypted data transmitting device public key by encrypting a data transmitting device public key with the data receiving device public key; and
an encrypted data transmitting device public key transmitter which transmits the encrypted data transmitting device public key to the data receiving device, and
the data receiving device further comprises:
an encrypted data transmitting device public key receiver which receives the encrypted data transmitting device public key transmitted from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information; and
a data transmitting device public key acquisition which decrypts the encrypted data transmitting device public key received by the encrypted data transmitting device public key receiver with the data receiving device private key to acquire the data transmitting device public key.

According to another aspect of the present invention, a printer which executes a print operation based on print data, comprises:
a first printer position information acquisition which acquires first printer position information to specify a place where the printer is installed;
a printer public key generator which generates a printer public key with a passphrase containing at least the first printer position information;
a printer public key storage in which the printer public key generated by the printer public key generator is stored;
a printer public key transmitter which transmits the printer public key stored in the printer public key storage to a print client in response to a request from the print client;
an encrypted client random number receiver which receives an encrypted client random number generated by encrypting a client random number with the printer public key from the print client;
a second printer position information acquisition which acquires second printer position information to specify a place where the printer is installed;
a printer private key generator which generates a printer private key with a passphrase containing at least the second printer position information;
a client random number acquisition which decrypts the encrypted client random number with the printer private key to acquire the client random number;
a printer random number generator which generates a printer random number;
a common key generator which generates a common key with the printer random number and the client random number;
an encrypted print data receiver which receives encrypted print data generated by encrypting print data from the print client; and
a print data acquisition which decrypts the encrypted print data with the common key to acquire the print data.

According to another aspect of the present invention, a control method of a printer which executes a print operation based on print data, comprises the steps of:
acquiring first printer position information to specify a place where the printer is installed;
generating a printer public key with a passphrase containing at least the first printer position information;
storing the generated printer public key in a printer public key storage;
transmitting the printer public key stored in the printer public key storage to a print client in response to a request from the print client;
receiving an encrypted client random number generated by encrypting a client random number with the printer public key from the print client;
acquiring second printer position information to specify a place where the printer is installed;
generating a printer private key with a passphrase containing at least the second printer position information;
decrypting the encrypted client random number with the printer private key to acquire the client random number;
generating a printer random number;
generating a common key with the printer random number and the client random number;
receiving encrypted print data generated by encrypting print data from the print client; and
decrypting the encrypted print data with the common key to acquire the print data.

According to another aspect of the present invention, a print client which generates print data, comprises:
a first client position information acquisition which acquires first client position information to specify a place where the print client is installed;
a client public key generator which generates a client public key with a passphrase containing at least the first client position information;
a client public key storage in which the client public key generated by the client public key generator is stored;
a client public key transmitter which transmits the client public key stored in the client public key storage to a printer;
an encrypted printer random number receiver which receives an encrypted printer random number generated by encrypting a printer random number with the client public key from the printer;
a second client position information acquisition which acquires second client position information to specify a place where the print client is installed;
a client private key generator which generates a client private key with a passphrase containing at least the second client position information;
a printer random number acquisition which decrypts the encrypted printer random number with the client private key to acquire the printer random number;
a client random number generator which generates a client random number;
a common key generator which generates a common key with the printer random number and the client random number;
an encrypted print data generator which generates encrypted print data by encrypting print data with the common key; and
an encrypted print data transmitter which transmits the encrypted print data to the printer.

According to another aspect of the present invention, a control method of a print client which generates print data, comprises the steps of:
acquiring first client position information to specify a place where the print client is installed;
generating a client public key with a passphrase containing at least the first client position information;
storing the generated client public key in a client public key storage;
transmitting the client public key stored in the client public key storage to a printer in response to a request from the printer;
receiving an encrypted printer random number generated by encrypting a printer random number with the client public key from the printer;
acquiring second client position information to specify a place where the print client is installed;
generating a client private key with a passphrase containing at least the second client position information;
decrypting the encrypted printer random number with the client private key to acquire the printer random number;
generating a client random number;
generating a common key with the printer random number and the client random number;
generating encrypted print data by encrypting print data with the common key; and
transmitting the encrypted print data to the printer.

According to another aspect of the present invention, a print system includes a printer which executes a print operation based on print data and a print client connected to the printer, wherein
the printer comprises:
a first printer position information acquisition which acquires first printer position information to specify a place where the printer is installed;
a printer public key generator which generates a printer public key with a passphrase containing at least the first printer position information; and
a printer public key storage in which the printer public key generated by the printer public key generator is stored,
the print client comprises:
a printer public key transmission request transmitter which transmits a printer public key transmission request to request transmission of the printer public key to the printer,
the printer further comprises:
a printer public key transmission request receiver which receives the printer public key transmission request transmitted from the print client; and
a printer public key transmitter which transmits the printer public key stored in the printer public key storage to the print client when the printer public key transmission request has been received,
the print client further comprises:
a printer public key receiver which receives the printer public key transmitted from the printer;
a client random number generator which generates a client random number;
an encrypted client random number generator which generates an encrypted client random number by encrypting the client random number with the printer public key; and
an encrypted client random number transmitter which transmits the encrypted client random number to the printer, and
the printer further comprises:
an encrypted client random number receiver which receives the encrypted client random number transmitted from the print client;
a second printer position information acquisition which acquires second printer position information to specify a place where the printer is installed;
a printer private key generator which generates a printer private key with a passphrase containing at least the second printer position information;
a client random number acquisition which decrypts the encrypted client random number with the printer private key to acquire the client random number;
a printer random number generator which generates a printer random number;
a common key generator which generates a common key with the printer random number and the client random number;
an encrypted print data receiver which receives encrypted print data generated by encrypting print data from the print client; and
a print data acquisition which decrypts the encrypted print data with the common key to acquire the print data.

According to another aspect of the present invention, a control method of a print system including a printer which executes a print operation based on print data and a print client connected to the printer, comprises the steps of:
acquiring first printer position information to specify a place where the printer is installed;
generating a printer public key with a passphrase containing at least the first printer position information in the printer;
storing the generated printer public key in a printer public key storage;
transmitting a printer public key transmission request to request transmission of the printer public key from the print client to the printer;
receiving the printer public key transmission request transmitted from the print client in the printer;
transmitting the printer public key stored in the printer public key storage from the printer to the print client when the printer public key transmission request has been received;
receiving the printer public key transmitted from the printer in the print client;
generating a client random number in the print client;
generating an encrypted client random number by encrypting the client random number with the printer public key;
transmitting the encrypted client random number from the print client to the printer;
receiving the encrypted client random number transmitted from the print client in the printer;
acquiring second printer position information to specify a place where the printer is installed;
generating a printer private key with a passphrase containing at least the second printer position information in the printer;
decrypting the encrypted client random number with the printer private key to acquire the client random number in the printer;
generating a printer random number in the printer;
generating a common key with the printer random number and the client random number in the printer;
transmitting encrypted print data generated by encrypting print data from the print client to the printer;
receiving the encrypted print data in the printer; and
decrypting the encrypted print data with the common key to acquire the print data in the printer.

According to another aspect of the present invention, a data receiving device which executes a process based on received data, comprises
a first data receiving device position information acquisition which acquires first data receiving device position information to specify a place where the data receiving device is installed;
a data receiving device public key generator which generates a data receiving device public key with a passphrase containing at least the first data receiving device position information;
a data receiving device public key storage in which the data receiving device public key generated by the data receiving device public key generator is stored;
a data receiving device public key transmitter which transmits the data receiving device public key stored in the data receiving device public key storage to a data transmitting device in response to a request from the data transmitting device;
an encrypted data transmitting device random number receiver which receives an encrypted data transmitting device random number generated by encrypting a data transmitting device random number with the data receiving device public key from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information;
a data transmitting device random number acquisition which decrypts the encrypted data transmitting device random number with the data receiving device private key to acquire the data transmitting device random number;
a data receiving device random number generator which generates a data receiving device random number;
a common key generator which generates a common key with the data receiving device random number and the data transmitting device random number;
an encrypted data receiver which receives encrypted data generated by encrypting data from the data transmitting device; and
a data acquisition which decrypts the encrypted data with the common key to acquire the data.

According to another aspect of the present invention, a data transmitting device which generates data to be transmitted, comprises:
a first data transmitting device position information acquisition which acquires first data transmitting device position information to specify a place where the data transmitting device is installed;
a data transmitting device public key generator which generates a data transmitting device public key with a passphrase containing at least the first data transmitting device position information;
a data transmitting device public key storage in which the data transmitting device public key generated by the data transmitting device public key generator is stored;
a data transmitting device public key transmitter which transmits the data transmitting device public key stored in the data transmitting device public key storage to a data receiving device in response to a request from the data receiving device;
an encrypted data receiving device random number receiver which receives an encrypted data receiving device random number generated by encrypting a data receiving device random number with the data transmitting device public key from the data receiving device;
a second data transmitting device position information acquisition which acquires second data transmitting device position information to specify a place where the data transmitting device is installed;
a data transmitting device private key generator which generates a data transmitting device private key with a passphrase containing at least the second data transmitting device position information;
a data receiving device random number acquisition which decrypts the encrypted data receiving device random number with the data transmitting device private key to acquire the data receiving device random number;
a data transmitting device random number generator which generates a data transmitting device random number;
a common key generator which generates a common key with the data receiving device random number and the data transmitting device random number;
an encrypted data generator which generates encrypted data by encrypting data with the common key; and
an encrypted data transmitter which transmits the encrypted data to the data receiving device.

According to another aspect of the present invention, a data transmitting and receiving system includes a data receiving device which executes a process based on received data and a data transmitting device connected to the data receiving device, wherein
the data receiving device comprises:
a first data receiving device position information acquisition which acquires first data receiving device position information to specify a place where the data receiving device is installed;
a data receiving device public key generator which generates a data receiving device public key with a passphrase containing at least the first data receiving device position information; and
a data receiving device public key storage in which the data receiving device public key generated by the data receiving device public key generator is stored,
the data transmitting device comprises:
a data receiving device public key transmission request transmitter which transmits a data receiving device public key transmission request to request transmission of the data receiving device public key to the data receiving device,
the data receiving device further comprises:
a data receiving device public key transmission request receiver which receives the data receiving device public key transmission request transmitted from the data transmitting device; and
a data receiving device public key transmitter which transmits the data receiving device public key stored in the data receiving device public key storage to the data transmitting device when the data receiving device public key transmission request has been received,
the data transmitting device further comprises:
a data receiving device public key receiver which receives the data receiving device public key transmitted from the data receiving device;
a data transmitting device random number generator which generates a data transmitting device random number;
an encrypted data transmitting device random number generator which generates an encrypted data transmitting device random number by encrypting the data transmitting device random number with the data receiving device public key; and
an encrypted data transmitting device random number transmitter which transmits the encrypted data transmitting device random number to the data receiving device, and
the data receiving device further comprises:
an encrypted data transmitting device random number receiver which receives the encrypted data transmitting device random number transmitted from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information;
a data transmitting device random number acquisition which decrypts the encrypted data transmitting device random number with the data receiving device private key to acquire the data transmitting device random number;
a data receiving device random number generator which generates a data receiving device random number;
a common key generator which generates a common key with the data receiving device random number and the data transmitting device random number;
an encrypted data receiver which receives encrypted data generated by encrypting data from the data transmitting device; and
a data acquisition which decrypts the encrypted data with the common key to acquire the data.

### BRIEF DESCRIPTION OF THE DRAWINGS

FIG. 1 is a diagram showing the uses of a common key, a public key, and a private key in a print system according to a first embodiment;

FIG. 2 is a block diagram showing the overall configuration of the print system according to the first embodiment;

FIG. 3 is a block diagram showing the hardware configuration of a printer according to the first embodiment;

FIG. 4 is a block diagram showing a modification of the hardware configuration of the printer;

FIG. 5 is diagram showing the hardware configuration of a print client according to the first embodiment;

FIG. 6 is a flowchart explaining a common key generation process in the first embodiment;

FIG. 7 is a diagram showing an example of the structure of a common key storage of the printer in the first embodiment;

FIG. 8 is a flowchart explaining a common key request process in the first embodiment;

FIG. 9 is a diagram showing an example of the structure of a public key/private key storage table in the first embodiment;

FIG. 10 is a diagram showing an example of the structure of a common key storage of the print client in the first embodiment;

FIG. 11 is a flowchart explaining a common key transmission process in the first embodiment;

FIG. 12 is a flowchart explaining a print request process in the first embodiment;

FIG. 13 is a flowchart explaining a print execution process in the first embodiment;

FIG. 14 is a functional block diagram showing a case where the processes of the print system according to the first embodiment are realized by hardware;

FIG. 15 is a diagram showing the uses of a common key, a printer public key, a printer private key, a client public key, and a client private key in a print system according to a second embodiment;

FIG. 16 is a flowchart explaining a printer public key generation process in the second embodiment;

FIG. 17 is a diagram showing an example of the structure of a printer public key storage in the second embodiment;

FIG. 18 is a flowchart explaining a client public key/private key generation process in the second embodiment;

FIG. 19 is a diagram showing an example of the structure of a client public key/private key storage in the second embodiment;

FIG. 20 is a flowchart explaining a print request process in the second embodiment (First part);

FIG. 21 is a flowchart explaining the print request process in the second embodiment (Second part);

FIG. 22 is a flowchart explaining a print execution process in the second embodiment (First part);

FIG. 23 is a flowchart explaining the print execution process in the second embodiment (Second part);

FIG. 24 is a flowchart explaining the print execution process in the second embodiment (third part);

FIG. 25 is a functional block diagram showing a case where the processes of the print system according to the second embodiment are realized by hardware;

FIG. 26 is a diagram showing the uses of a common key, a printer public key, a printer private key, a client public key, and a client private key in a print system according to a third embodiment;

FIG. 27 is a flowchart explaining a print request process in the third embodiment (First part);

FIG. 28 is a flowchart explaining the print request process in the third embodiment (Second part);

FIG. 29 is a flowchart explaining a print execution process in the third embodiment (First part);

FIG. 30 is a flowchart explaining the print execution process in the third embodiment (Second part);

FIG. 31 is a functional block diagram showing a case where the processes of the print system according to the third embodiment are realized by hardware;

FIG. 32 is a diagram showing the uses of a common key, a public key, and a private key in a print system according to a fourth embodiment;

FIG. 33 is a diagram showing the hardware configuration of a print client according to the fourth embodiment;

FIG. 34 is a diagram showing a modification of the hardware configuration of the print client;

FIG. 35 is a flowchart explaining a printer public key generation process in the fourth embodiment;

FIG. 36 is a diagram showing an example of the structure of a printer public key storage in the fourth embodiment;

FIG. 37 is a flowchart explaining a client public key generation process in the fourth embodiment;

FIG. 38 is a diagram showing an example of the structure of a client public key storage in the fourth embodiment;

FIG. 39 is a flowchart explaining a print request process in the fourth embodiment (First part);

FIG. 40 is a flowchart explaining the print request process in the fourth embodiment (Second part);

FIG. 41 is a flowchart explaining the print request process in the fourth embodiment (Third part);

FIG. 42 is a flowchart explaining a print execution process in the fourth embodiment (First part);

FIG. 43 is a flowchart explaining the print execution process in the fourth embodiment (Second part);

FIG. 44 is a flowchart explaining the print execution process in the fourth embodiment (Third part); and

FIG. 45 is a functional block diagram showing a case where the processes of the print system according to the fourth embodiment are realized by hardware.

### DETAILED DESCRIPTION OF THE EMBODIMENTS

### First Embodiment

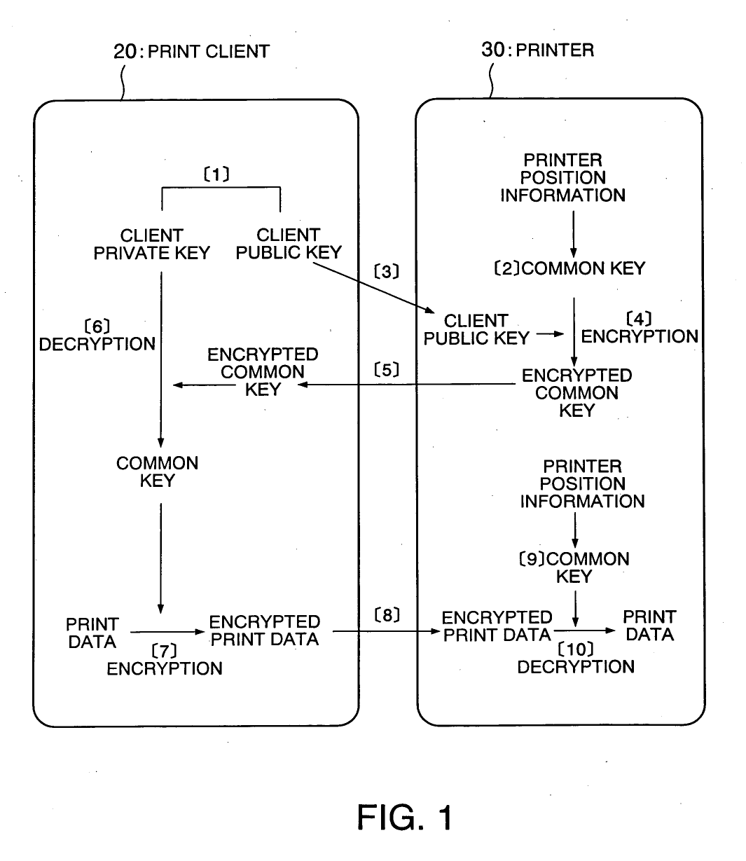

First, a summary of a process of a print system according to the first embodiment of the present invention will be presented based on FIG. 1. As shown in FIG. 1, in this embodiment, a print client 20 generates a public key (client public key) and a private key (client private key) by a public key cryptography at any given timing and holds them (step [1]).

On the other hand, a printer 30 creates a variable with at least printer position information indicating a position where the printer 30 is installed, and generates a common key with this variable (step [2]). This variable may be created based on the printer position information, may be created based on device-specific information on the printer 30 in addition to the printer position information, may be created based on the device-specific information on the printer 30 and a random number in addition to the printer position information, or may be created based on the random number in addition to the printer position information.

Then, the printer 30 acquires a client public key of the print client 20 (step [3]), and encrypts a common key with this client public key to generate an encrypted common key (step [4]). Thereafter, the printer 30 transmits this encrypted common key to the print client (step [5]).

The print client 20 decrypts the received encrypted common key with the client private key to acquire the common key and holds this common key (step [6]). When printing is instructed by a user, the print client 20 encrypts print data with this common key to generate encrypted print data (step [7]). Subsequently, the print client 20 transmits this encrypted print data to the printer 30 (step [8]).

The printer 30 which has received the encrypted print data acquires again printer position information at this point in time, creates a variable with at least this printer position information, and generates a common key with this variable (step [9]). The method of creating this variable needs to be the same method as in the aforementioned step [2]. Subsequently, the printer 30 decrypts the encrypted print data with this generated common key to acquire the print data (step [10]). Then, the printer 30 executes a print operation based on this print data.

After all, in the printer 30, the encrypted print data can be decrypted if the printer 30 is not moved from a position where the common key was generated in step [2], but the encrypted print data cannot be decrypted if the printer 30 is moved. This is because if both pieces of printer position information are different, the common key generated in step [2] and the common key generated in step [9] are different.

As can be known from the above description, the timing when the encrypted common key is transmitted from the printer 30 to the print client 20 may be any given timing between the installation of the printer 30 and the occurrence of a print request. However, in order to restrict the position of the printer 30 at the time of execution of a print operation, the generation of the common key in step [9] needs to be performed after the printer 30 has received the encrypted print data from the print client 20.

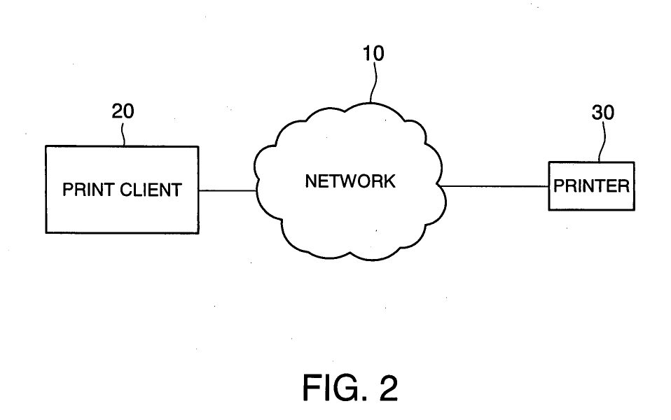

Next, the configuration of the print system according to this embodiment will be explained based on FIG. 2. FIG. 2 is a block diagram showing the hardware configuration of the print system according to this embodiment.

As shown in FIG. 2, the print system according to this embodiment includes the print client 20 connected to a network 10 and the printer 30 also connected to the network 10. In this embodiment, the network 10 is constituted by the Internet using TCP/IP (transmission control protocol/internet protocol). However, the form of the network 10 is not limited to the Internet, and, for example, it may be constituted by a LAN such as Ethernet (registered trademark).

The print client 20 is composed of any of various kinds of computers, for example, called a host computer and a personal computer. In this embodiment, in particular, the print client 20 generates encrypted print data by encrypting print data with a common key and transmits this encrypted print data to the printer 30 via the network 10. The number of print clients connected to the network 10 is optional, and it may be one or more than one. Moreover, the print client is not limited to a computer, and, for example, it may be a digital camera with a necessity to print a taken image, a content server in which print image data is stored as contents, or the like.

Further, in this embodiment, the printer 30 is a so-called network printer. In this embodiment, particularly, the printer 30 receives encrypted print data from the print client 20 and decrypts this encrypted print data with a common key and executes a print operation.

In this embodiment, the printer 30 is directly connected to the network 10, and the printer 30 has its own peculiar network address. Accordingly, the print client 20 can transmit the encrypted print data to the printer 30 by designating this network address.

Incidentally, the printer 30 is directly connected to the network 10 in FIG. 2, but may be connected thereto via a printer server. The number of printers connected to the network 10 is optional, and it may be one or more than one.

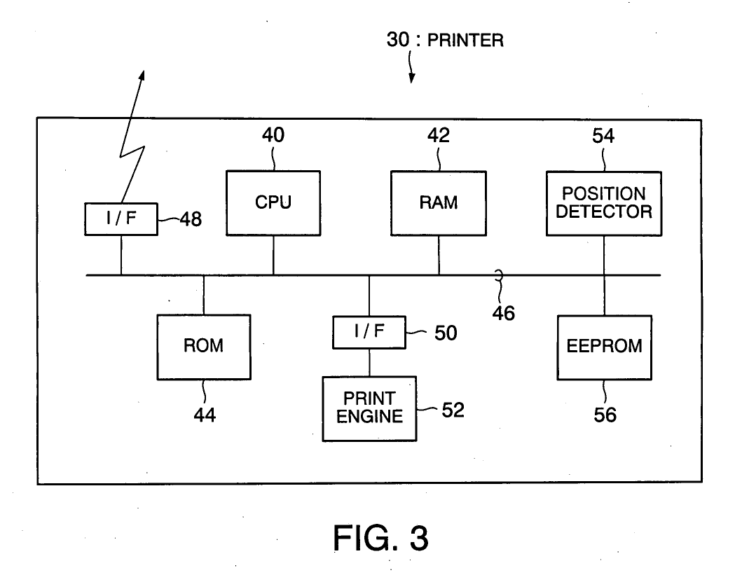

FIG. 3 is a block diagram for explaining the internal configuration of the printer 30. As shown in FIG. 3, the printer 30 includes a CPU (Central Processing Unit) 40, a RAM (Random Access Memory) 42, and a ROM (Read Only Memory) 44, and they are connected to each other via an internal bus 46. A communication interface 48 is connected to the internal bus 46, and the printer 30 is connected to the aforementioned network 10 via the communication interface 48. In addition, an interface 50 is connected to the internal bus 46, and a print engine 52 is connected to the interface 50.

Moreover, a position detector 54 is connected to the internal bus 46. This position detector 54 has a function of specifying a position where the printer 30 is installed. In this embodiment, the position detector 54 is constituted, for example, by a GPS (global positioning system), and the latitude, longitude, and altitude of the position where the printer 30 is installed can be specified. It is said that the accuracy of the GPS at the present time is approximately ±10 m in the latitude, the longitude, and the altitude, respectively.

However, the constitution of the position detector 54 is not limited to the constitution using the GPS, and, for example, when the printer 30 is connected to the network 10 by a wireless LAN, the position of the printer 30 may be specified based on a wireless base station which accommodates the printer 30. Alternatively, the position of the printer 30 may be specified by using mobile communication technology including the PHS (Personal Handyphone System).

Further, it is also possible that the position detector 54 includes both a GPS function and a PHS function and normally detects an installation position by the GPS, but when the position detector 54 cannot detect the position by the GPS due to radio wave conditions, it may detect the position by the PHS.

Furthermore, the printer 30 according to this embodiment includes an EEPROM (Electrically Erasable Programmable ROM) 56 connected to the internal bus 46 as a nonvolatile semiconductor memory device. Information stored in the EEPROM 56 is held even when the printer 30 is powered off.

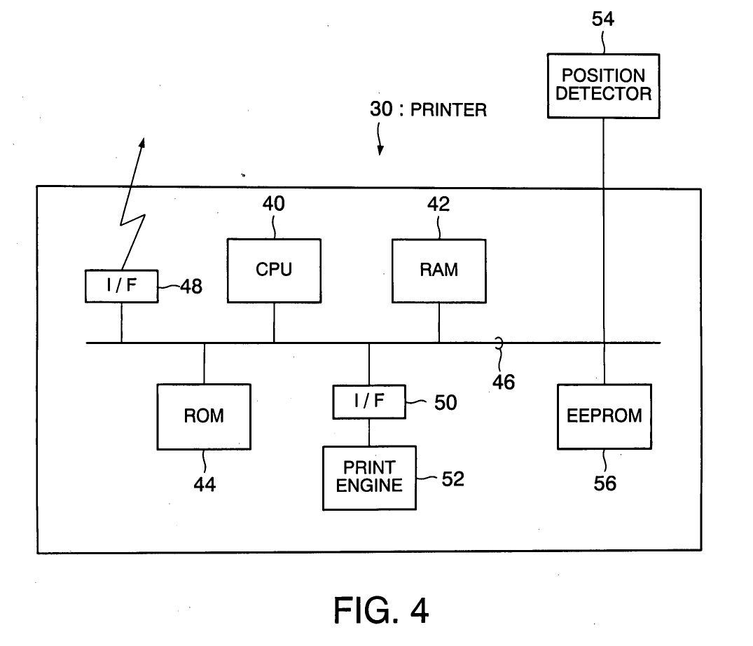

Additionally, although the position detector 54 is contained in the printer 30 in FIG. 3, the position detector 54 may be provided outside the printer 30 as shown in FIG. 4. For example, it is possible that when the necessity arises, a cellular phone equipped with the GPS is connected to the printer 30, and thereby the printer 30 has a position detection function.

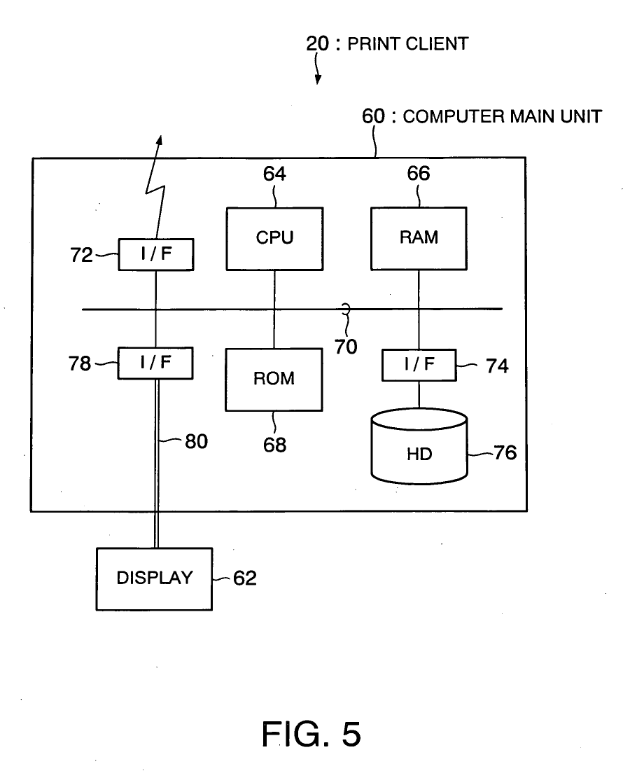

FIG. 5 is a block diagram for explaining the internal configuration of the print client 20. As shown in FIG. 5, the print client 20 according to this embodiment includes a computer main unit 60 and a display 62.

The computer main unit 60 includes a CPU 64, a RAM 66, and a ROM 68, and they are connected to each other via an internal bus 70. A communication interface 72 is connected to the internal bus 70, and the print client 20 is connected to the aforementioned network 10 via the communication interface 72.

Moreover, an interface 74 is connected to the internal bus 70, and a hard disk 76 which is a large capacity storage is connected to the interface 74. Further, an interface 78 is connected to the internal bus 70, and the aforementioned display 62 is connected via a cable 80 which extends from the interface 78.

Next, processes executed in the printer 30 and the print client 20 to realize the process explained by means of FIG. 1 will be explained in detail.

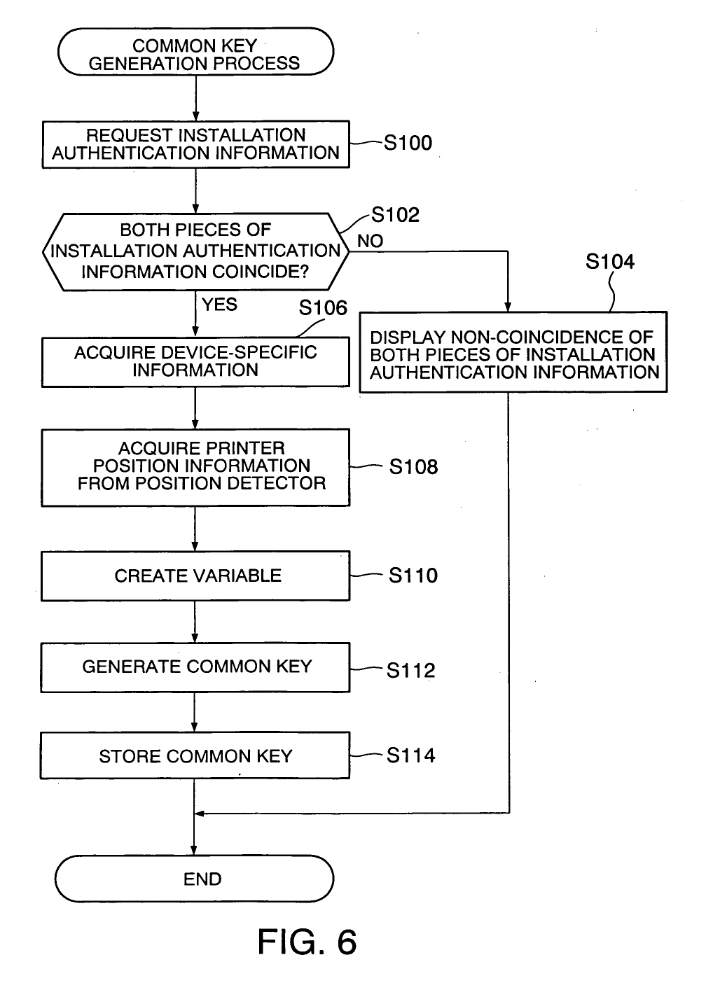

First, a common key generation process executed in the printer 30 when the printer 30 is installed will be explained based on FIG. 6. FIG. 6 is a flowchart explaining the common key generation process executed in the printer 30. This common key generation process is realized by making the CPU 40 read and execute a common key generation program stored in the ROM 44 of the printer.

As shown in FIG. 6, first, the printer 30 requests an operator of the printer 30 to input installation authentication information (step S100). For example, the printer 30 displays an instruction to input installation authentication information on a display panel provided on this printer 30. The operator, for example, operates an operation panel provided on the printer 30 to input installation authentication information. For example, in this embodiment, the installation authentication information is composed of a combination of an ID and a password for installation authentication information. Hence, the operator inputs these ID and password for installation authentication information from the operation panel.

Then, the printer 30 judges whether the inputted installation authentication information coincides with installation authentication information previously registered with this printer 30 (step S102). More specifically, the printer 30 judges whether the ID and the password for installation authentication information inputted by the operator as described above coincide with an ID and a password for installation authentication information previously registered with the printer 30. In this embodiment, for example, when the printer 30 is shipped, these ID and password for installation authentication information are stored in the EEPROM 56, and only a manufacturer of this printer 30 can know these ID and password for installation authentication information.

When these two pieces of installation authentication information do not coincide (step S102: No), the printer 30 displays non-coincidence of the two pieces of installation authentication information on the display panel of the printer 30 (step S104), and ends this common key generation process.

On the other hand, when these two pieces of installation authentication information coincide (step S102: Yes), the printer 30 acquires device-specific information on the printer 30 (step S106). Here, the device-specific information is identification information specifically assigned to the printer 30, and it is, for example, a manufacturer's serial number, a MAC address, or the like of the printer 30.

Then, the printer 30 acquires printer position information on the printer 30 at this point in time from the position detector 54 (step S108). Subsequently, the printer 30 creates one variable with the device-specific information and the printer position information (step S110). There are various methods of creating the variable, and in this embodiment, one variable is created by adding digitized device-specific information to digitized printer position information.

Thereafter, the printer 30 generates a common key with the created variable by a common key cryptography (step S112). The common key cryptography has the property that the same common key is generated again if the same variable is used. Then, the printer 30 stores and holds the generated common key (step S114). Thus, the common key generation process according to this embodiment is completed.

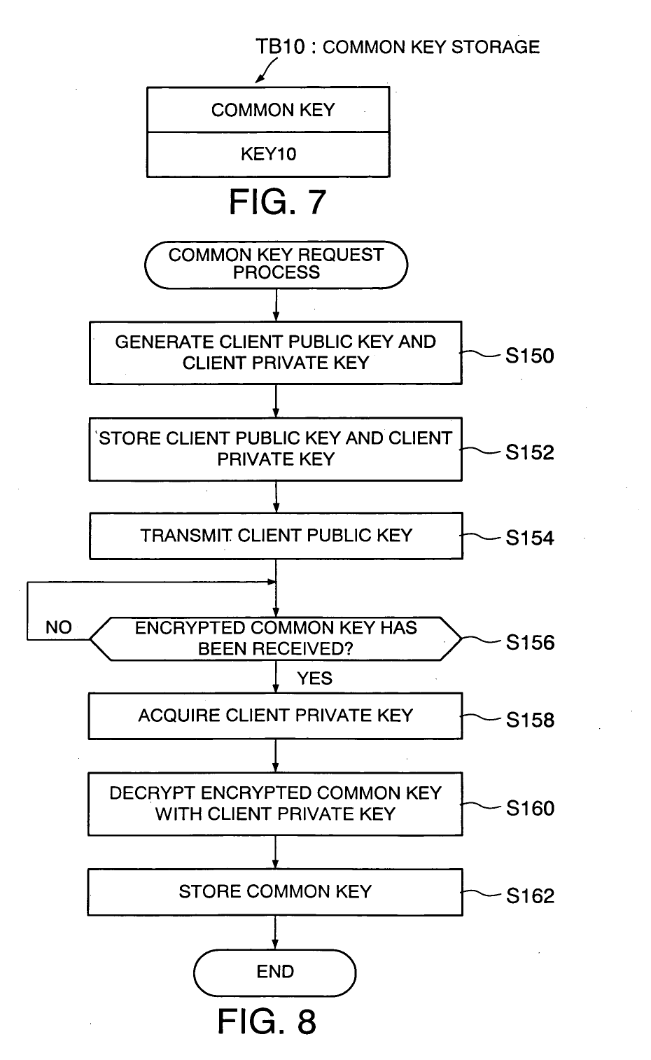

FIG. 7 is a diagram showing an example of a common key storage TB10 in which the common key is stored in step S114. In this embodiment, this common key storage TB10 is formed in the EEPROM 56. Therefore, the common key stored in the common key storage TB10 is held in a nonvolatile manner even if the printer 30 is powered off.

Next, a common key request process executed in the print client 20 will be explained based on FIG. 8. FIG. 8 is a flowchart explaining the common key request process executed in the print client 20. This common key request process is realized by making the CPU 64 read and execute a common key request program stored in the ROM 68 or the hard disk 76 of the print client 20.

In this embodiment, this common key request process is started when a user instructs the print client 20 to acquire the common key of the printer 30. For example, the user instructs the print client 20 to acquire the common key of the printer 30 when the print client 20 is installed.

First, as shown in FIG. 8, the print client 20 generates a client public key and a client private key by the public key cryptography (step S150). Subsequently, the print client 20 stores the generated client public key and client private key in a public key/private key storage (step 5152).

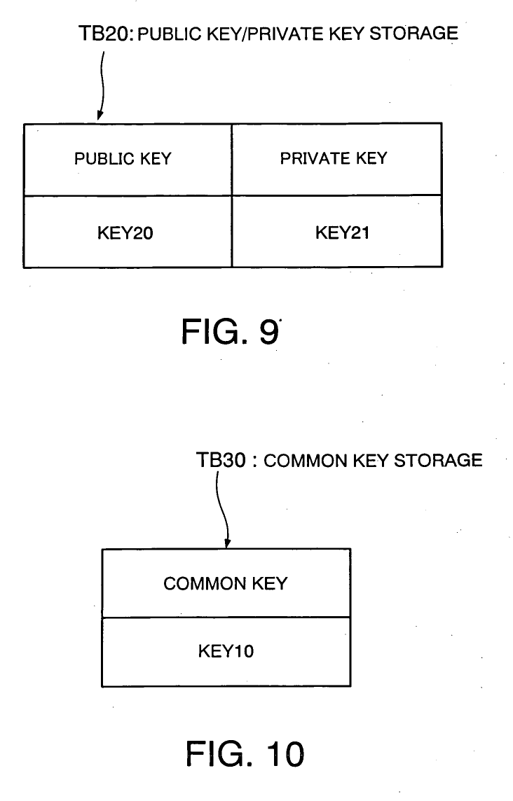

FIG. 9 is a diagram showing an example of the structure of a public key/private key storage TB20 according to this embodiment. In this embodiment, this public key/private key storage TB20 is formed in the hard disk 76. Therefore, the client public key and the client private key stored in this public key/private key storage TB20 are held in a nonvolatile manner even if the print client 20 is powered off.

Then, as shown in FIG. 8, the print client 20 transmits the client public key to the printer 30 (step S154). Subsequently, the print client 20 judges whether an encrypted common key has been received from the printer 30 (step S156). When the encrypted common key has not been received (step S156: No), the print client 20 stands by while repeating the process in step S156.

On the other hand, when the encrypted common key has been received (step S156: Yes), the print client 20 acquires the client private key from the public key/private key storage TB20 (step S158). Subsequently, the print client 20 decrypts the encrypted common key with this client private key to acquire the common key (step S160).

Thereafter, the print client 20 stores this common key in a common key storage (step S162). Thus, the common key request process according to this embodiment is completed.

FIG. 10 is a diagram showing an example of a common key storage TB30 in which the common key is stored in step S162. In this embodiment, this common key storage TB30 is formed in the hard disk 76. Therefore, the common key stored in this common key storage TB30 is held in a nonvolatile manner even if the print client 20 is powered off.

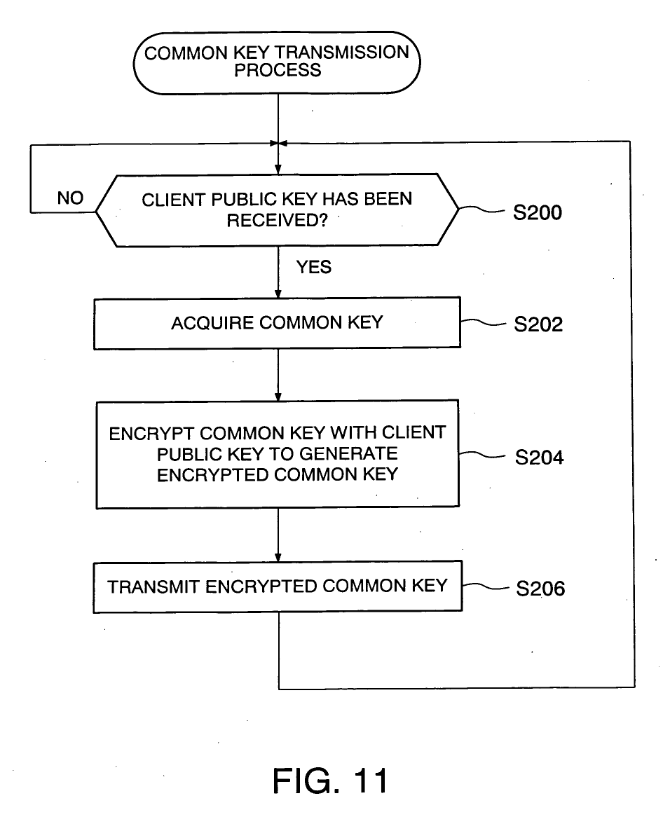

Next, a common key transmission process executed in the printer 30 corresponding to the common key request process in the print client 20 will be explained based on FIG. 11. FIG. 11 is a flowchart explaining the common key transmission process executed in the printer 30. The common key transmission process is realized by making the CPU 40 read and execute a common key transmission program stored in the ROM 44 of the printer. This common key transmission process is regularly executed.

As shown in FIG. 11, first, the printer 30 judges whether the client public key has been received from the print client 20 (step S200). When the client public key has not been received (step S200: No), the printer 30 stands by while repeating the process in step S200.

On the other hand, when the client public key has been received (step S200: Yes), the printer 30 acquires the common key from the common key storage TB10 (step S202). Subsequently, the printer 30 encrypts the acquired common key with the client public key to generate the encrypted common key (step S204).

Thereafter, the printer 30 transmits the generated encrypted common key to the print client 20 (step S206). Then, the printer 30 returns to the aforementioned process in step S200.

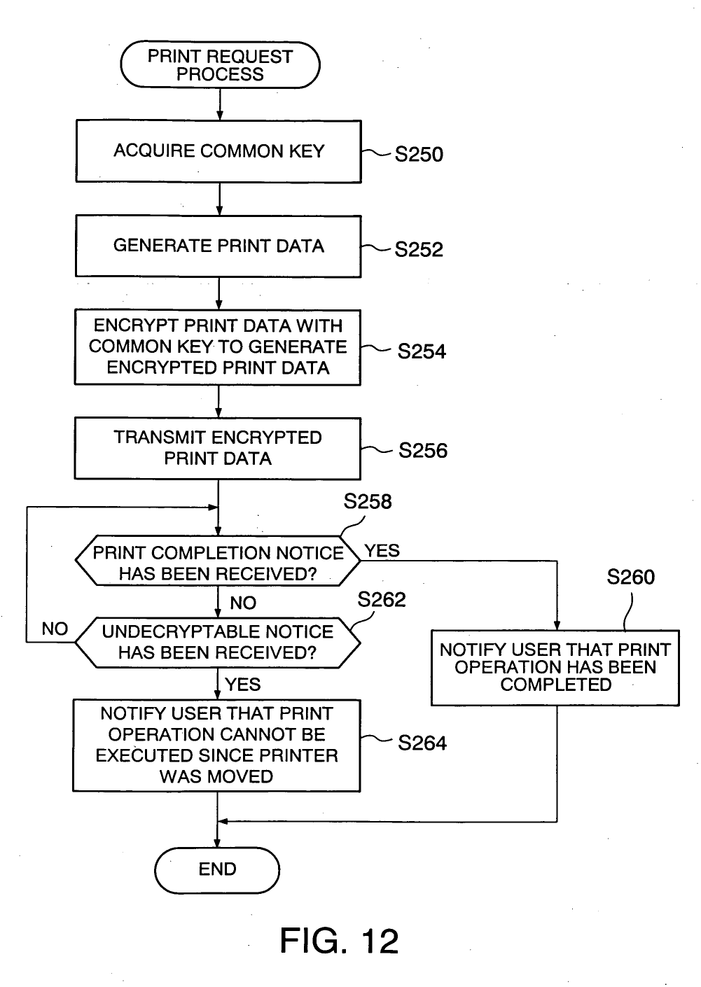

FIG. 12 is a flowchart explaining a print request process executed in the print client 20. This print request process is realized by making the CPU 64 read and execute a print request program stored in the ROM 68 or the hard disk 76 of the print client. In this embodiment, this print request process is started when the user creates data to be printed and instructs the print client 20 to print the data with the printer 30.

As shown in FIG. 12, first, the print client 20 acquires the common key from the common key storage TB30 (step S250). Subsequently, the print client 20 generates print data (step S252). This print data is original data required when the printer 30 executes a print operation.

Then, the print client 20 encrypts the print data generated in step S252 with the common key acquired in step S250 to generate encrypted print data (step S254). Subsequently, the print client 20 transmits the encrypted print data to the printer 30 (step S256).

Thereafter, the print client 20 judges whether a print completion notice has been received from the printer 30 (step S258). When the print completion notice has been received (step S258: Yes), the print client 20 notifies the user that the print operation has been completed (step S260), and this print request process is completed.

On the other hand, when judging that the print completion notice has not been received in step S258 (step S258: No), the print client 20 judges whether an undecryptable notice has been received from the printer 30 (step S262). When the undecryptable notice has not been received (step S262: No), the print client 20 repeats the aforementioned process from step S258.

On the other hand, when the undecryptable notice has been received (step S262: Yes), the print client 20 notifies the user that since the printer 30 was moved, the encrypted print data cannot be decrypted, and thereby the print operation has not been executed by the printer 30 (step S264). Thus, the print request process is completed.

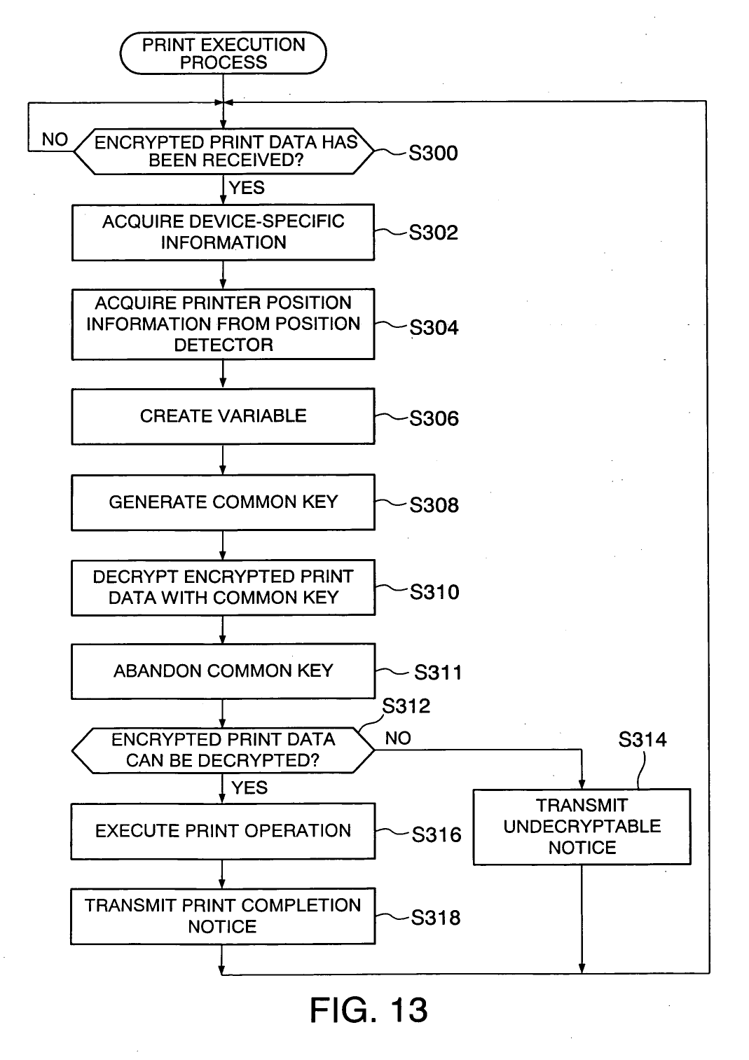

Next, a print execution process executed in the printer 30 corresponding to the print request process in the print client 20 will be explained based on FIG. 13. FIG. 13 is a flowchart explaining the print execution process executed in the printer 30. This print execution process is realized by making the CPU 40 read and execute a print execution program stored in the ROM 44 of the printer 30. In this embodiment, this print execution process is regularly executed.

As shown in FIG. 13, the printer 30 judges whether the encrypted print data has been received from the print client 20 (step S300). When the encrypted print data has not been received (step S300: No), the printer 30 stands by while repeating the process in step S300.

On the other hand, when the encrypted print data has been received (step S300: Yes), the printer 30 acquires device-specific information (step S302). Subsequently, the printer 30 acquires again printer position information on the printer 30 at this point in time from the position detector 54 (step S304).

Then, the printer 30 creates one variable with the device-specific information and the printer position information (step S306). The method of creating this variable needs to be the same method as in step S110 in the aforementioned common key generation process. Then, the printer 30 generates a common key with this variable by the common key cryptography (step S308).

Thereafter, the printer 30 decrypts the encrypted print data with this common key to acquire the print data (step S310). Then, the printer 30 abandons the common key generated in step S308 (step S311). Subsequently, the printer 30 judges whether the encrypted print data can be decrypted (step S312). When the encrypted print data cannot be decrypted (step S312: No), the printer 30 transmits the undecryptable notice to the print client 20 (step S314), and returns to the aforementioned process in step S300.

On the other hand, when judging that the encrypted print data can be decrypted (step S312: Yes), the printer 30 executes a print operation based on the acquired print data (step S316). More specifically, the printer 30 performs a language interpretation of the print data and generates print request data fitting the print engine 52. Then, by transmitting this print request data to the print engine 52, print sheets or the like are printed by the print engine 52.

Then, the printer 30 transmits the print completion notice to the print client 20 (step S318). Thereafter, the printer 30 returns to the aforementioned process in step S300.

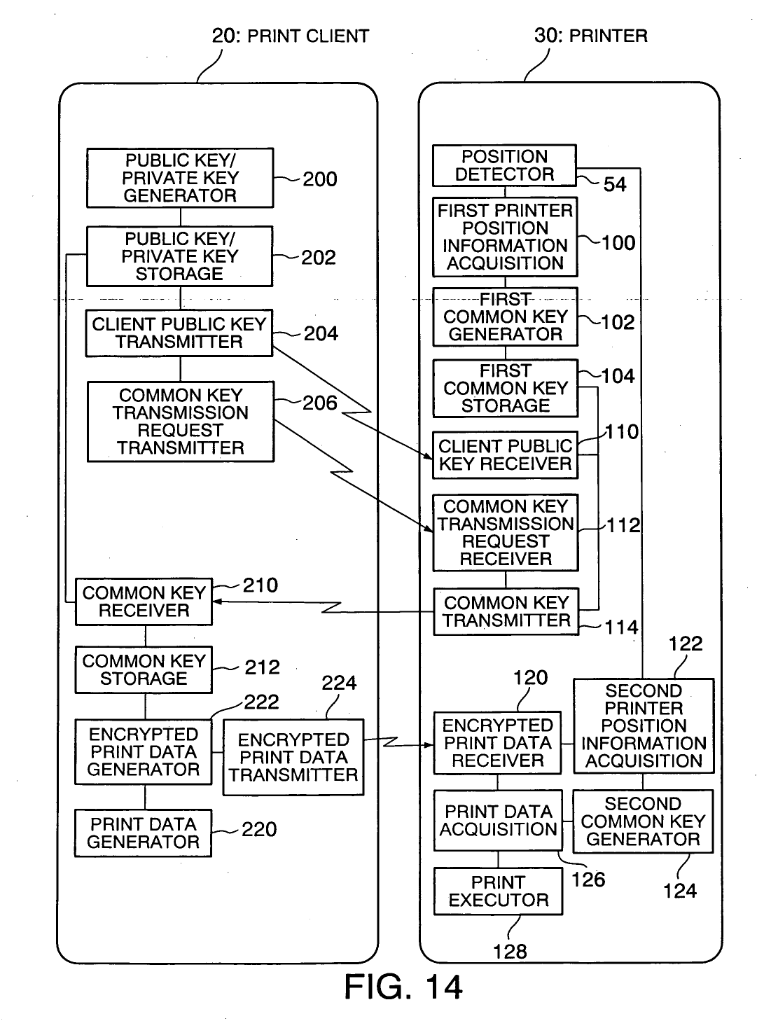

FIG. 14 is a functional block diagram showing a configuration when the aforementioned respective processes are realized by hardware. As shown in FIG. 14, when the printer 30 is installed, a first printer position information acquisition 100 acquires printer position information to specify a place where the printer 30 is installed from the position detector 54 and regards this printer position information as first printer position information. A first common key generator 102 generates a common key with at least this first printer position information. Then, the common key generated by the first common key generator is stored in a first common key storage 104.

On the other hand, after the print client 20 is installed, a public key/private key generator 200 of the print client 20 generates a client public key and a client private key by the public key cryptography at any given timing before a print request is made. These client public key and client private key are stored in a public key/private key storage 202.

The client public key stored in the public key/private key storage 202 is transmitted from a client public key transmitter 204 to the printer 30 at any given timing before the print request is made. This client public key is received by a client public key receiver 110 of the printer 30. Similarly, at any given timing before the print request is made, a common key transmission request is transmitted from a common key transmission request transmitter 206 to the printer 30. This common key transmission request is received by a common key transmission request receiver 112 of the printer 30.

When the common key transmission request has been received by the common key transmission request receiver 112, a common key transmitter 114 acquires the common key from the first common key storage 104 and transmits this common key to the print client 20. In particular, in this embodiment, the common key transmitter 114 encrypts the common key with the client public key received by the client public key receiver 110 and transmits it as an encrypted common key to the print client 20.

The common key transmitted from the printer 30 is received by a common key receiver 210 of the print client 20 and stored in a common key storage 212. In particular, in this embodiment, the common key is received as the encrypted common key, whereby the common key receiver 210 acquires the client private key from the public key/private key storage 202 and decrypts the encrypted common key with this client private key to acquire the common key.

A print data generator 220 of the print client 20 generates print data based on a print request instruction from the user. An encrypted print data generator 222 acquires the common key from the common key storage 212 and encrypts the print data with this common key to generate encrypted print data. An encrypted print data transmitter 224 transmits the encrypted print data to the printer 30.

This encrypted print data is received by an encrypted print data receiver 120 of the printer 30. When the encrypted print data has been received, a second printer position information acquisition 122 acquires printer position information at this point in time from the position detector 54. A second common key generator 124 generates a common key with at least this printer position information.

A print data acquisition 126 decrypts the encrypted print data with this common key to acquire the print data. Then, a print executor 128 executes a print operation based on the print data.

As described above, according to the print system of this embodiment, the print client 20 can make a proper print request only in a place where the client public key was generated, whereby the place where the print client 20 can be used can be restricted.

Namely, in the printer 30 of this embodiment, when the printer is moved to a place different from the place where the common key was initially generated, the encrypted print data transmitted from the print client 20 cannot be decrypted correctly, so that the correct print data cannot be acquired. Consequently, a proper print operation cannot be executed.

Moreover, in this embodiment, the print data is encrypted with the common key. It is generally said that the speed at which data is decrypted with a common key generated by the common key cryptography is approximately 1000 times higher than the speed at which the data is decrypted with a private key generated by the public key cryptography. Hence, print data with a large data amount can be decrypted rapidly with the common key.

Further, along with the above, according to the print system of this embodiment, the print client 20 can substantially restrict the position of the printer able to print the encrypted print data which is encrypted and then transmitted, so that the execution of a print operation by a printer installed in a position where the user of the print client 20 does not intend to perform printing can be avoided.

It should be mentioned that the present invention is not limited to the aforementioned first embodiment, and various changes may be made therein. For example, in the aforementioned embodiment, the variable is created based on the device-specific information in addition to the printer position information, but the device-specific information need not necessarily be used when the variable is created.

Moreover, in the aforementioned embodiment, by transmitting the client public key from the print client 20 to the printer 30, the common key is transmitted from the printer 30 to the print client 20, but a common key transmission request to request the transmission of the common key may be additionally transmitted from the print client 20 to the printer 30. In this case, the printer 30 transmits the common key to the print client 20 upon receipt of the common key transmission request.

Further, the common key transmitted from the printer 30 to the print client 20 need not necessarily be encrypted. However, when the common key is not encrypted, there is a risk that the common key is stolen by a third party.

Furthermore, the explanation was given with the printer as an example of a data receiving device which restricts the position where it can be used, but the present invention is not limited to the printer. A data transmitting device is also not limited to the print client.

For example, in a data transmitting and receiving system, a data transmitting device may be a digital camera for taking images and a data receiving device may be a data server which stores data on the images taken by the digital camera. In this case, when the data server is installed, a common key is generated based on position information, and this common key is transmitted to the digital camera. The digital camera encrypts data with the common key and transmits it as encrypted data to the data server. The data server acquires again position information at this point in time and generates a common key based on this position information. Then, the data server decrypts the encrypted data with the generated common key. When the encrypted data can be decrypted, the data server stores the acquired data.

### Second Embodiment

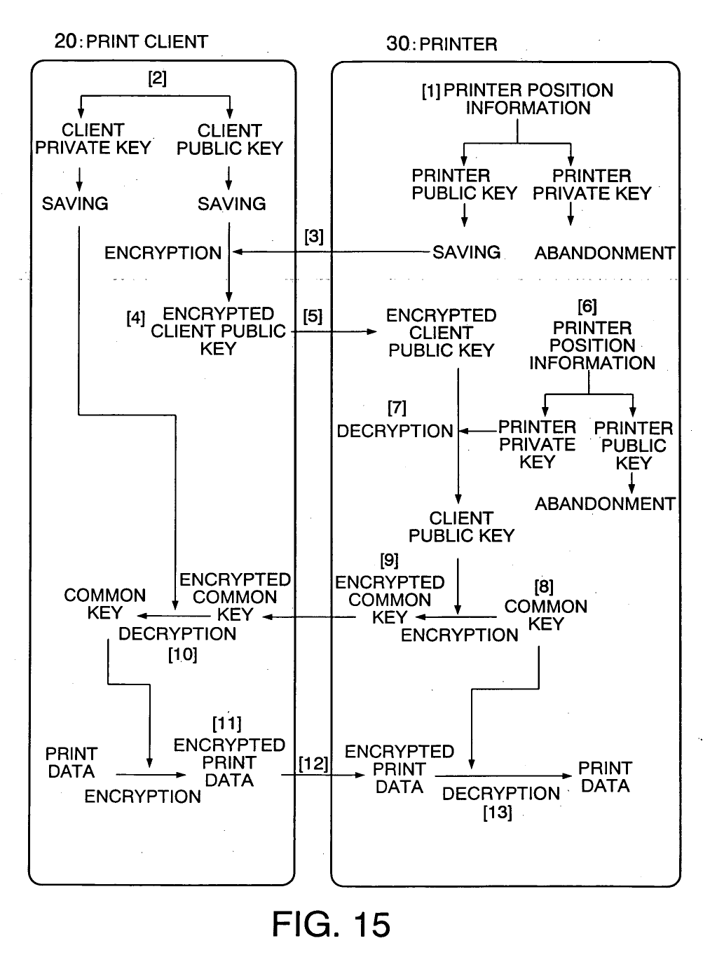

First, a summary of a process of a print system according to the second embodiment of the present invention will be presented based on FIG. 15. As shown in FIG. 15, in this embodiment, when the printer 30 is installed, the printer 30 generates a public key (printer public key) and a private key (printer private key) with a passphrase containing at least printer position information indicating a position where the printer 30 is installed, and holds the printer public key but abandons printer private key (step [1]).

On the other hand, the print client 20 generates a public key (client public key) and a private key (printer private key) with a passphrase or the like inputted by the user and holds both of these client public key and client private key (step [2]). The client public key and the client private key generated by the print client 20 are a public key and a private key which are independent of position information on the print client 20.

The print client 20 requests the printer 30 to transmit the printer public key at any given timing, and the printer 30 transmits the printer public key to the print client 20 (step [3]).

The print client 20 which has received the printer public key encrypts the client public key with the printer public key to generate an encrypted client public key (step [4]). Then, this encrypted client public key is transmitted from the print client 20 to the printer 30 (step [5]).

The printer 30 which received the encrypted client public key decrypts this encrypted client public key at a point in time when the printer 30 has accepted a print request from the print client 20 to acquire the client public key. More specifically, the printer 30 acquires printer position information at this point in time and generates a printer public key and a printer private key with a passphrase containing at least this printer position information (step [6]). Then, the printer 30 decrypts the received encrypted client public key with the generated printer private key (step [7]). At this time, the printer public key is abandoned without being saved.

If the position of the printer 30 is not moved from a place where the printer public key was generated in step [1], the printer 30 can decrypt the encrypted client public key, and acquire the client public key. However, if the position of the printer 30 is moved from the place where the printer public key was generated in step [1], the printer 30 cannot decrypt the encrypted client public key, and cannot acquire the client public key.

Thereafter, the printer 30 generates a common key with an appropriate random number or the like (step [8]), encrypts the common key with the acquired client public key and transmits it as an encrypted common key to the print client 20 (step [9]).

When having received the encrypted common key, the print client 20 decrypts the received encrypted common key with the saved client private key to acquire the common key (step [10]). Subsequently, the print client 20 encrypts print data with this common key (step [11]), and transmits it as encrypted print data to the printer 30 (step [12]).

The printer 30 which has received this encrypted print data decrypts the encrypted print data with the common key to acquire the print data (step [13]). After all, in this print system, the encrypted client public key can be decrypted with the printer private key acquired in step [6] in the printer 30 which is not moved from the installation position, but cannot be decrypted in the printer 30 which is moved therefrom. Hence, the position where the printer 30 can be properly used can be limited to the position where the printer public key was generated in step [1].

As can be known from the above description, in the print client 20, the client public key and the client private key are generated at any given timing, and they only need to be generated before a print request is made to the printer 30.

The encrypted client public key is also transmitted from the print client 20 to the printer 30 at any given timing. If the encrypted client public key is transmitted from the print client 20 to the printer 30 when a print request is made, this becomes a trigger for the print request, and hence the printer 30 is required to execute step [6] to acquire the printer private key at a point in time when the printer 30 has received the encrypted client public key. On the other hand, if the encrypted client public key is transmitted from the print client 20 to the printer 30 in advance before the print request is made, the printer 30 needs to hold the received encrypted client public key without decrypting it. Then, the printer 30 needs to execute the step [6] to acquire the printer private key at a point in time when the printer 30 has accepted the print request from the print client 20.

Incidentally, the configuration of the print system according to this embodiment, the configuration of the printer 30, and the configuration of the print client 20 are the same as those in the aforementioned first embodiment.

Next, processes executed in the printer 30 and the print client 20 to realize the process explained by means of FIG. 15 will be explained in detail.

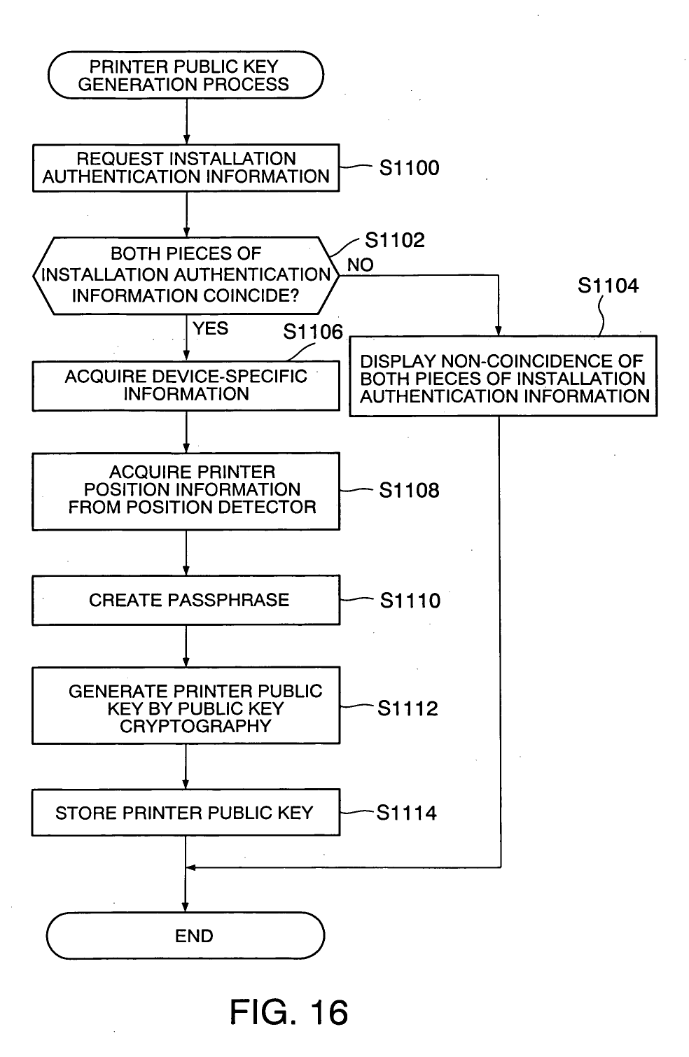

First, a printer public key generation process executed in the printer 30 when the printer 30 is installed will be explained based on FIG. 16. FIG. 16 is a flowchart explaining the printer public key generation process executed in the printer 30. This printer public key generation process is realized by making the CPU 40 read and execute a printer public key generation program stored in the ROM 44 of the printer.

As shown in FIG. 16, first, the printer 30 requests an operator of the printer 30 to input installation authentication information (step S1100). For example, the printer 30 displays an instruction to input installation authentication information on a display panel provided on this printer 30. The operator, for example, operates an operation panel provided on the printer 30 to input installation authentication information. For example, in this embodiment, the installation authentication information is composed of a combination of an ID and a password for installation authentication information. Hence, the operator inputs these ID and password for installation authentication information from the operation panel.

Then, the printer 30 judges whether the inputted installation authentication information coincides with installation authentication information previously registered with this printer 30 (step S1102). More specifically, the printer 30 judges whether the ID and the password for installation authentication information inputted by the operator as described above coincide with an ID and a password for installation authentication information previously registered with the printer 30. In this embodiment, for example, when the printer 30 is shipped, these ID and password for installation authentication information are stored in the EEPROM 56, and only a manufacturer of this printer 30 can know these ID and password for installation authentication information.

When these two pieces of installation authentication information do not coincide (step S1102: No), the printer 30 displays non-coincidence of the two pieces of installation authentication information on the display panel of the printer 30 (step S1104), and ends this printer public key generation process.

On the other hand, when these two pieces of installation authentication information coincide (step S1102: Yes), the printer 30 acquires device-specific information on the printer 30 (step S1106). Here, the device-specific information is identification information specifically assigned to the printer 30, and it is, for example, a manufacturer's serial number, a MAC address, or the like of the printer 30.

Then, the printer 30 acquires printer position information on the printer 30 at this point in time from the position detector 54 (step S1108). Subsequently, the printer 30 creates a passphrase with the device-specific information and the printer position information (step S1110). There are various methods of creating the passphrase, and in this embodiment, the passphrase is created by simply joining the printer position information after the device-specific information. Incidentally, the passphrase may contain data other than these device-specific information and printer position information.

Thereafter, the printer 30 generates a printer public key with the created passphrase by a public key cryptography (step S1112). The public key cryptography has the property that the same public key and private key are generated again if the same passphrase is used. Then, the printer 30 stores and holds the generated printer public key (step S1114). Incidentally, even if a printer private key is generated when the printer public key is generated, this printer private key is abandoned without being saved. Thus, the printer public key generation process according to this embodiment is completed.

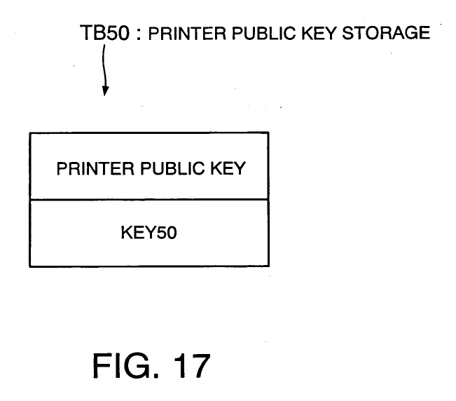

FIG. 17 is a diagram showing an example of a printer public key storage TB50 in which the printer public key is stored in step S1114. In this embodiment, this printer public key storage TB50 is formed in the EEPROM 56. Therefore, the printer public key stored in the printer public key storage TB50 is held in a nonvolatile manner even if the printer 30 is powered off.

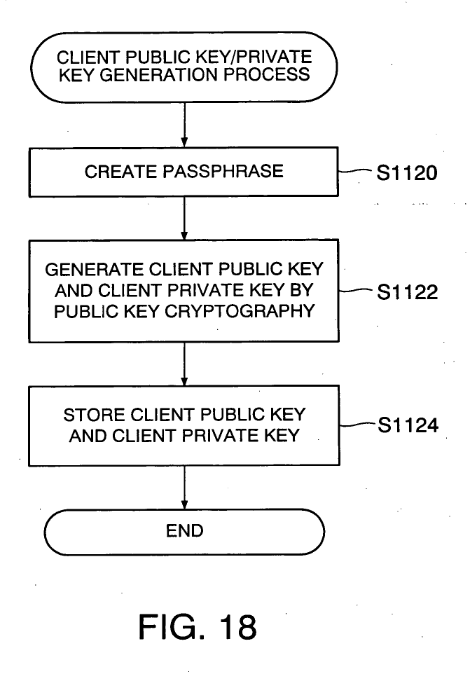

FIG. 18 is a flowchart explaining a client public key/private key generation process executed in the print client 20. This client public key/private key generation process is realized by making the CPU 64 read and execute a client public key/private key generation program stored in the ROM 68 or the hard disk 76 of the print client. This client public key/private key generation process is required to be started at any given timing before print data is transmitted. For example, in this embodiment, this client public key/private key generation process is started by the user at any given timing after the print client 20 is installed by the user.

First, the print client 20 creates a passphrase (step S1120). There are various methods of creating the passphrase, and in this embodiment, the passphrase is created by the user inputting any given phrase or the printer 30 generating a random number.

Thereafter, the print client 20 generates a client public key and a client private key with the created passphrase by the public key cryptography (step S1122). Then, the print client 20 stores and holds the generated client public key and client private key (step S1124). Thus, the client public key/private key generation process according to this embodiment is completed.

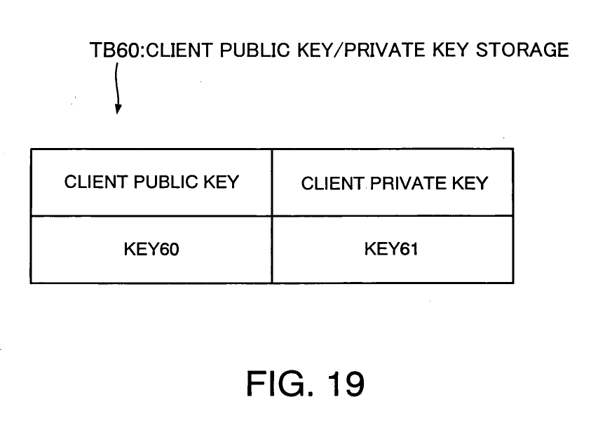

FIG. 19 is a diagram showing an example of a client public key/private key storage TB60 in which the client public key and the client private key are stored in step S1124. In this embodiment, this client public key/private key storage TB60 is formed in the hard disk 76. Therefore, the client public key and the client private key stored in this client public key/private key storage TB60 are held in a nonvolatile manner even if the print client 20 is powered off.

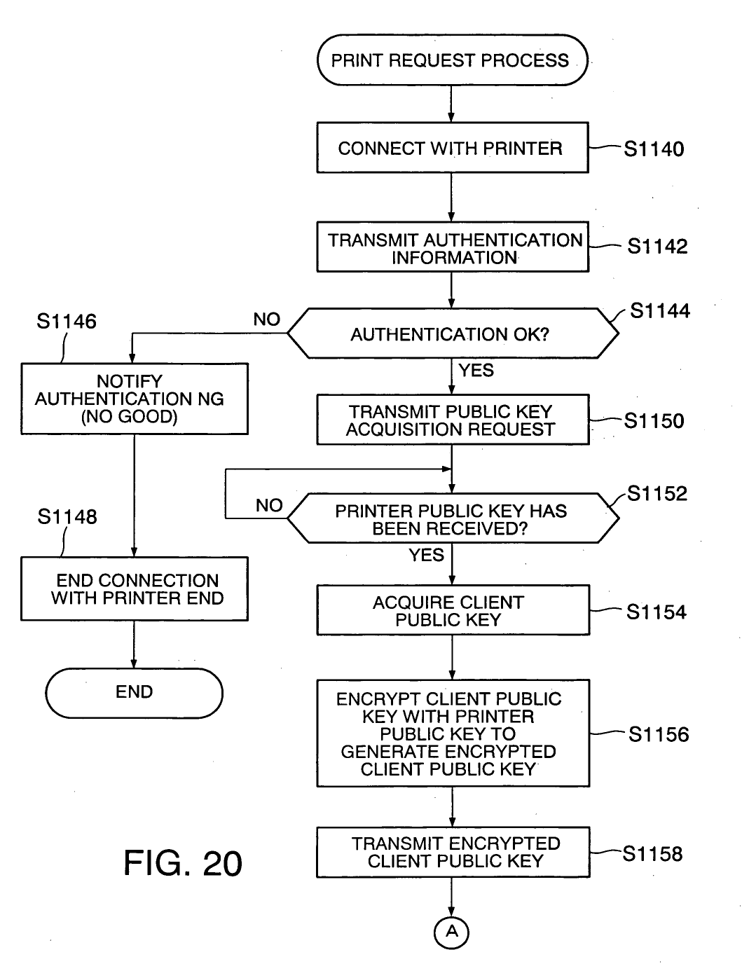

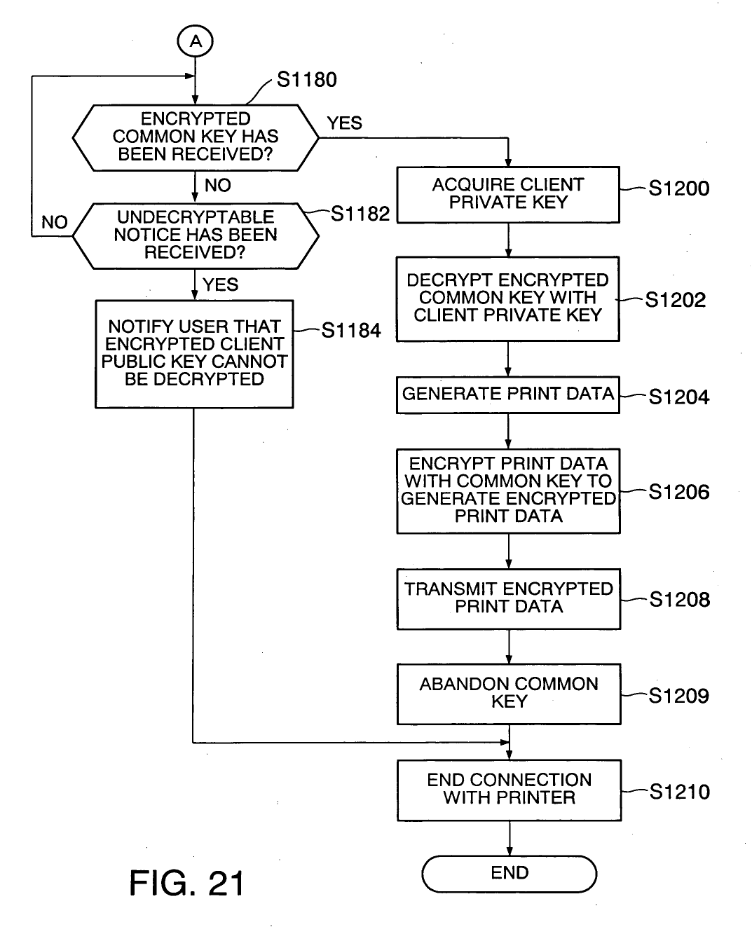

FIG. 20 and FIG. 21 are flowcharts explaining a print request process executed in the print client 20. This print request process is realized by making the CPU 64 read and execute a print request program stored in the ROM 68 or the hard disk 76 of the print client. In this embodiment, this print request process is started when the user creates data to be printed and instructs the print client 20 to print the data with the printer 30.

As shown in FIG. 20, the print client 20 first connects with the printer 30 (step S1140). In this embodiment, the print client 20 establishes a connection between the print client 20 and the printer 30 by designating the network address of the printer 30.

Thereafter, the print client 20 transmits authentication information to the printer 30 (step S1142). In this embodiment, a combination of a client ID to specify the print client and a password is used as the authentication information. Accordingly, the print client 20 transmits the client ID and the password to the printer 30.

Subsequently, the print client 20 receives an authentication result indicating whether authentication has been accepted from the printer 30, and judges whether the authentication has been accepted by the printer 30 based on the authentication result (step S1144).

When judging that the authentication has not been accepted (step S1144: No), the print client 20 notifies the user that the authentication has not been accepted by the printer 30, so that the printer public key cannot be acquired (step S1146). Then, the print client 20 ends the connection with the printer 30 (step S1148), and ends this print request process.

On the other hand, when judging that the authentication has been accepted in step S1144 (step S1144: Yes), the print client 20 transmits a public key acquisition request to the printer 30 (step S1150). Then, the print client 20 judges whether a printer public key has been received from the printer 30 (step S1152). When the printer public key has not been received from the printer 30 (step S1152: No), the print client 20 stands by while repeating the process in step S1152.

On the other hand, when the printer public key has been received from the printer 30 (step S1152: Yes), the print client 20 acquires the client public key from the client public key/private key storage TB60 (step S1154). Then, the print client 20 encrypts the client public key with the printer public key received in step S1152 to generate an encrypted client public key (step S1156). Subsequently, the print client 20 transmits this generated encrypted client public key to the printer 30 (step S1158).

Incidentally, the authentication process in step S1142, step S1144, and step S1146 is not always necessary and it is possible to omit this authentication process.

Thereafter, as shown in FIG. 21, the print client 20 judges whether an encrypted common key has been received from the printer 30 (step S1180). When the encrypted common key has not been received (step S1180: No), the print client 20 judges whether an undecryptable notice has been received from the printer 30 (step S1182).

When the undecryptable notice has not been received (step S1182: No), the print client 20 repeats the process from step S1180. On the other hand, when the undecryptable notice has been received (step S1182: Yes), the print client 20 notifies the user that the encrypted client public key cannot be decrypted by the printer 30 (step S1184). Then, the print client 20 ends the connection with the printer 30 and ends the print request process.

On the other hand, when judging in step S1180 that the encrypted common key has been received (step S1180: Yes), the print client 20 acquires the client private key from the client public key/private key storage TB60 (step S1200). Then, the print client 20 decrypts the received encrypted common key with this client private key to acquire a common key (step S1202).

Thereafter, the print client 20 generates print data (step S1204). This print data is data required when the printer 30 actually executes a print operation.

Subsequently, the print client 20 encrypts the print data with the common key decrypted in step S1202 to generate encrypted print data (step S1206). Then, the print client 20 transmits this encrypted print data to the printer 30 (step S1208). More specifically, the print client 20 designates the network address of the printer 30 and sends out the encrypted print data to the network 10. Subsequently, the print client 20 abandons the common key acquired in step S1202 (step S1209). Then, the print client 20 ends the connection with the printer 30 (step S1210), and this print request process is completed.

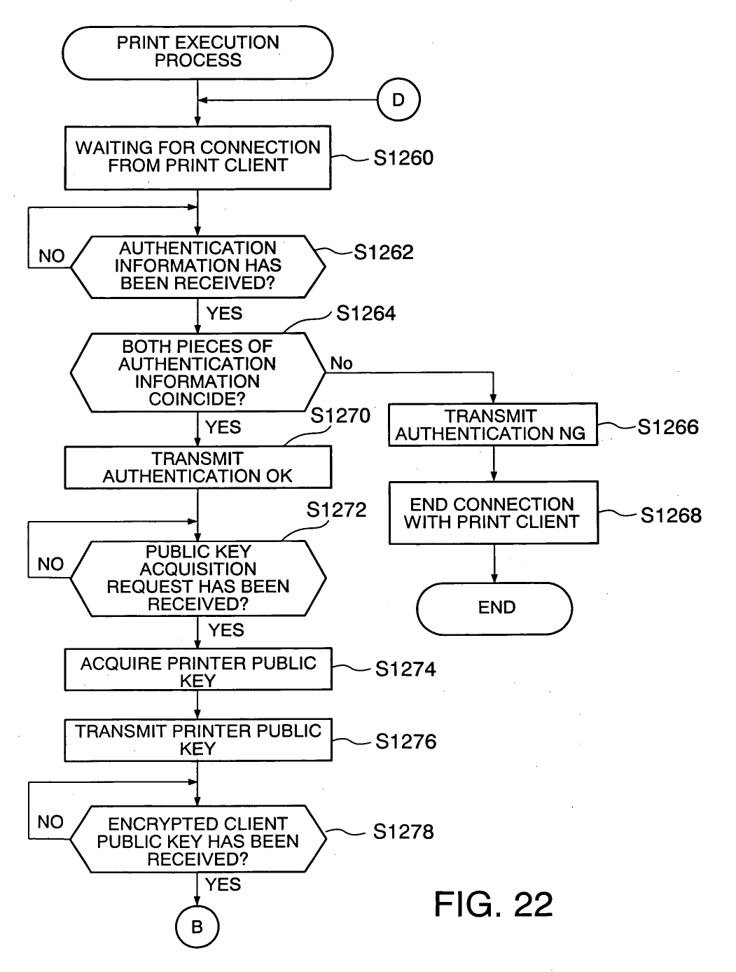

Next, a print execution process executed in the printer 30 corresponding to the print request process in the print client 20 will be explained based on FIG. 22 to FIG. 24. FIG. 22 to FIG. 24 are flowcharts explaining the print execution process executed in the printer 30. This print execution process is realized by making the CPU 40 read and execute a print execution program stored in the ROM 44 of the printer 30. In this embodiment, this print execution process is regularly executed.

As shown in FIG. 22, the printer 30 is waiting for a connection from the print client 20, and establishes a connection with the print client 20 when the connection is requested by the print client 20 (step S1260). Subsequently, the printer 30 judges whether the authentication information has been received from the print client 20 (step S1262). When the authentication information has not been received (step S1262: No), the printer 30 stands by while repeating the process in step S1262.

On the other hand, when the authentication information has been received from the print client 20 (step S1262: Yes), the printer 30 judges whether this authentication information coincides with authentication information previously registered with the printer 30 (step S1264). More specifically, since the print client ID and the password are transmitted as the authentication information from the print client 20 as described above, the printer 30 judges whether these print client ID and password coincide with a print client ID and a password which are previously registered with the printer 30.

When these two pieces of authentication information do not coincide (step S1264: No), the printer 30 transmits the authentication result indicating that the authentication has not been accepted to the print client 20 (step S1266). Then, the printer 30 ends the connection with the print client 20 (step S1268) and ends this print execution process.

On the other hand, when judging in step S1264 that these two pieces of authentication information coincide (step S1264: Yes), the printer 30 transmits the authentication result indicating that the authentication has been accepted to the print client 20 (step S1270).

Thereafter, the printer 30 judges whether the public key acquisition request has been received from the print client 20 (step S1272). When the public key acquisition request has not been received (step S1272: No), the printer 30 stands by while repeating the process in step S1272.

When the public key acquisition request has been received (step S1272: Yes), the printer 30 acquires the printer public key from the printer public key storage TB50 (step S1274). Subsequently, the printer 30 transmits this printer public key to the print client 20 (step S1276).

Then, the printer 30 judges whether the encrypted client public key has been received from the print client 20 (step S1278). When the encrypted client public key has not been received (step s1278: No), the printer 30 stands by while repeating the process in step S1278.

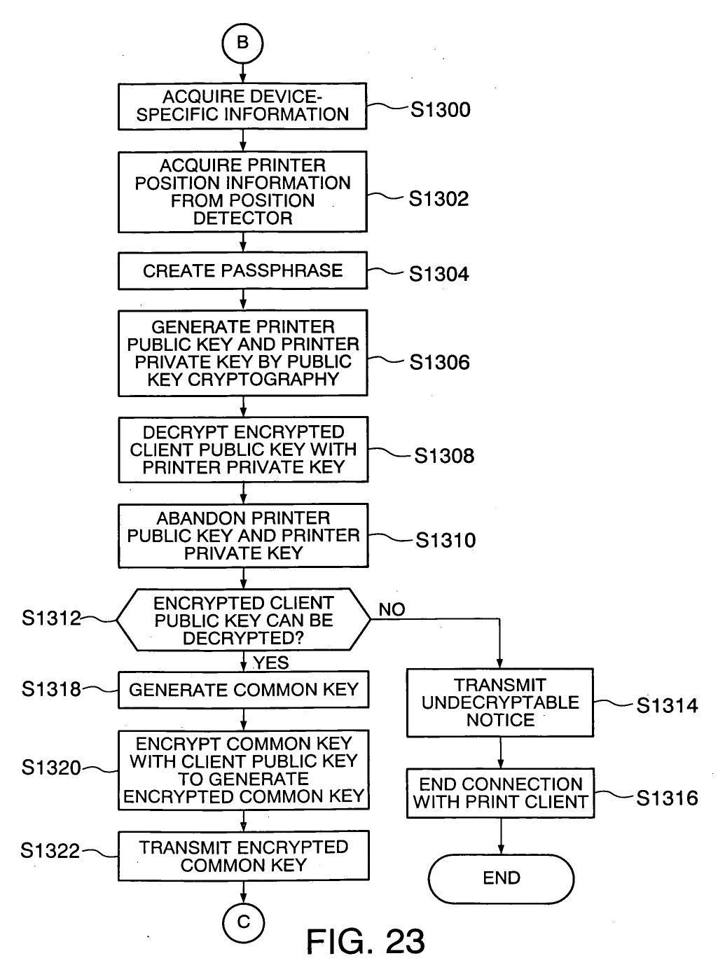

On the other hand, when the encrypted client public key has been received (step S1278: Yes), as shown in FIG. 23, the printer 30 acquires its own device-specific information (step S1300). Subsequently, the printer 30 acquires printer position information on the printer 30 at this point in time from the position detector 54 (step S1302). The reason why the printer position information is acquired from the position detector 54 each time as just described is that there is a possibility that the printer 30 is moved to a different place from a place where the printer 30 was initially installed, and in order that, in such a case, the print operation will not be executed by the printer 30.

Then, the printer 30 creates a passphrase based on the device-specific information and the printer position information (step S1304). The method of creating the passphrase needs to be the same method as in step S1110 in the aforementioned public key generation process. This is because, if the passphrases are different, the encrypted client public key transmitted from the print client 20 cannot be decrypted with a printer private key.

Thereafter, the printer 30 generates a printer public key and a printer private key with the passphrase by the public key cryptography (step S1306). Subsequently, the printer 30 decrypts the received encrypted client public key with the generated printer private key to acquire the client public key (step S1308). Then, the printer 30 abandons the printer public key and the printer private key generated in step S1306 (step S1310).

Thereafter, the printer 30 judges whether the encrypted client public key can be decrypted with the printer private key (step S1312). When the encrypted client public key cannot be decrypted (step S1312: No), the printer 30 transmits the undecryptable notice as the print result information to the print client 20 (step S1314), ends the connection with the print client 20 (step S1316), and ends this print execution process. Namely, when places when the printer public key generation process was executed and when this print execution process is executed are different, it means that the printer 30 has been moved to a different place, and hence the printer private key to decrypt the encrypted client public key cannot be generated. Accordingly, the printer 30 cannot execute a print operation.

On the other hand, when the encrypted client public key can be decrypted with the printer private key (step S1312: Yes), the printer 30 generates the common key for example, with a random number (step S1318). Various common key cryptographies such as the DES (data encryption standard) method, triple DES, and Rijndael are known.

Then, the printer 30 encrypts the common key generated in step S1318 with the client public key acquired in step S1308 to generate the encrypted common key (step S1320).

Subsequently, the printer 30 transmits this encrypted common key to the print client 20 (step S1322). More specifically, the printer 30 designates the network address of the print client 20 and sends out the encrypted common key to the network 10.

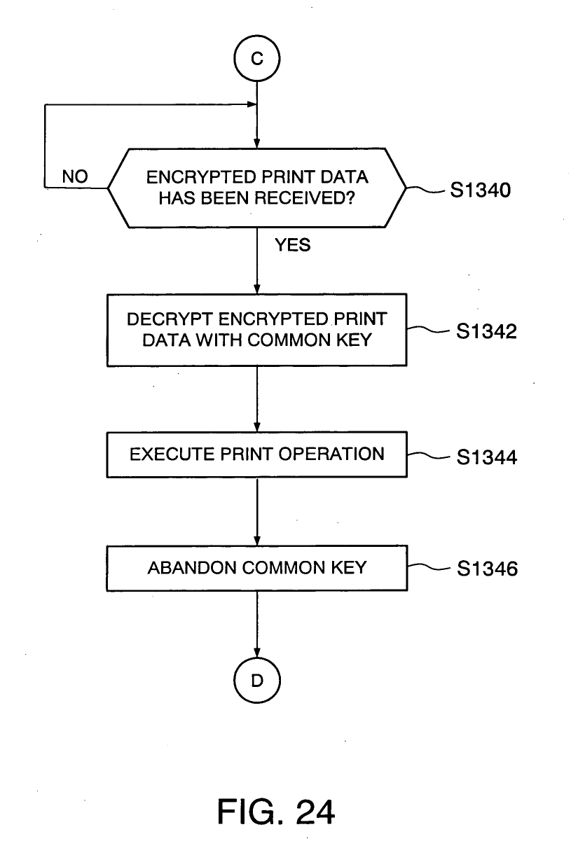

Then, as shown in FIG. 24, the printer 30 judges whether the encrypted print data has been received from the print client 20 (step S1340). When the encrypted print data has not been received (step S1340: No), the printer 30 stands by while repeating the process in step S1340.

On the other hand, when the encrypted print data has been received (step S1340: Yes), the printer 30 decrypts this received encrypted print data with the common key generated in step S1318 to acquire the print data (S1342). Subsequently, the printer 30 executes a print operation by driving the print engine 52 based on the acquired print data (step S1344). More specifically, the printer 30 performs a language interpretation of the print data and generates print request data fitting the print engine 52. Then, by transmitting this print request data to the print engine 52, print sheets or the like are printed by the print engine 52.

Thereafter, the printer 30 abandons the common key generated in step S1318 (step S1346). Then, the printer 30 returns to the aforementioned process in step S1260.

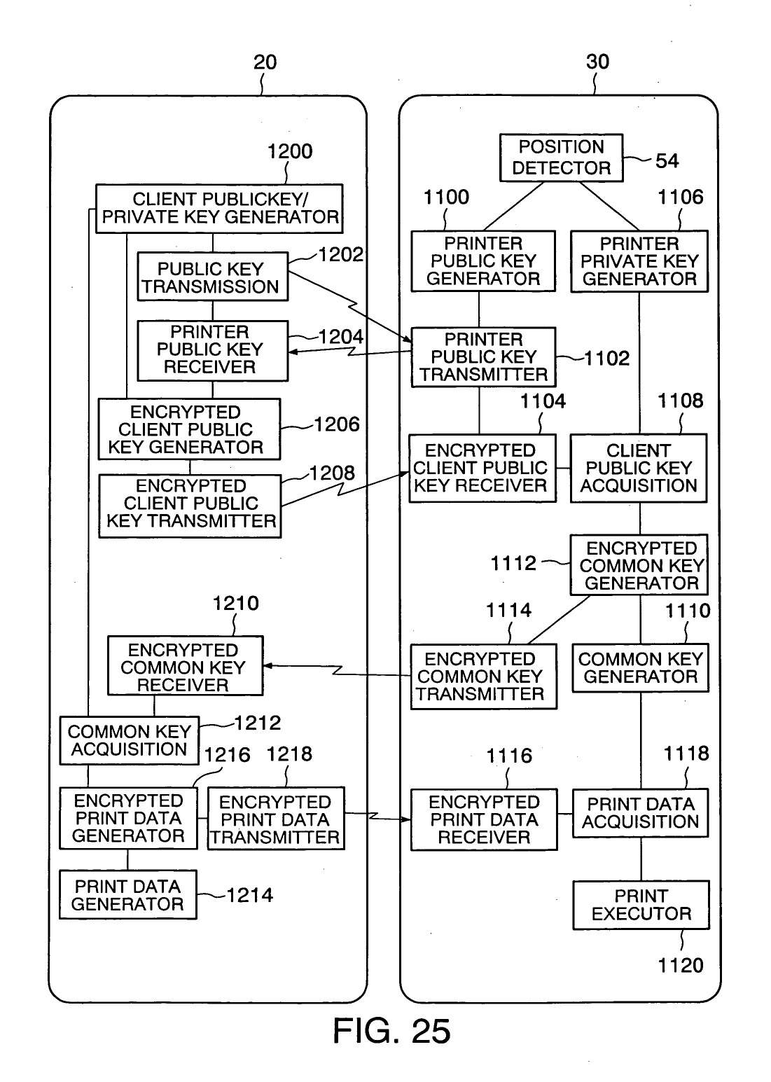

FIG. 25 is a functional block diagram showing a configuration when the aforementioned respective processes are realized by hardware. As shown in FIG. 25, in the printer 30, the position detector 54 which acquires printer position information to specify a place where the printer 30 is installed is provided. A printer public key generator 1100 acquires printer position information from the position detector 54 and generates a printer public key with a passphrase containing at least this printer position information and holds this printer public key.

The print client 20 includes a client public key/private key generator 1200 which generates and holds a client public key and a client private key. The print client 20 further includes a public key transmission request transmitter 1202 which transmits a public key transmission request to request the transmission of the printer public key to the printer 30.

A printer public key transmitter 1102 of the printer 30 receives the public key transmission request transmitted from the print client 20 and transmits the printer public key to the print client 20.

A printer public key receiver 1204 of the print client 20 receives the printer public key transmitted from the printer 30. An encrypted client public key generator 1206 encrypts the client public key with the printer public key to generate an encrypted client public key. An encrypted client key transmitter 1208 transmits the encrypted client public key to the printer 30.

An encrypted client public key receiver 1104 of the printer 30 receives the encrypted client public key transmitted from the print client 20. A printer private key generator 1106 acquires printer position information from the position detector 54 and generates a printer private key with a passphrase containing at least this printer position information.

A client public key acquisition 1108 decrypts the encrypted client public key received by the encrypted client public key receiver 1104 with the printer private key to acquire the client public key.

A common key generator 1110 of the printer 30 generates a common key by the common key cryptography. An encrypted common key generator 1112 encrypts the common key with the client public key acquired by the client public key acquisition 1108 to generate an encrypted common key. An encrypted common key transmitter 1114 transmits this generated encrypted common key to the print client 20.

An encrypted common key receiver 1210 of the print client 20 receives the encrypted common key transmitted from the printer 30. A common key acquisition 1216 decrypts the received encrypted common key with the client private key to acquire the common key. A print data generator 1214 generates print data. An encrypted print data generator 1216 encrypts the print data generated by the print data generator 1214 with the common key to generate encrypted print data. An encrypted print data transmitter 1218 transmits this generated encrypted print data to the printer 30.

An encrypted print data receiver 1116 of the printer 30 receives the encrypted print data transmitted from the print client 20. A print data acquisition 1118 decrypts the encrypted print data with the common key generated by the common key generator 1110 to acquire the print data. Then, a print executor 1120 executes a print operation based on this print data.

As described above, according to the print system of this embodiment, the printer 30 can execute a proper print operation only in a place where the public key was generated, whereby the place where the printer 30 can be used can be limited to the place where the public key was generated. Namely, in the printer 30 of this embodiment, when the printer 30 is moved to a place different from the place where the printer public key was generated, the encrypted client public key transmitted from the print client 20 cannot be decrypted correctly, so that the correct client public key cannot be acquired.

Moreover, in this embodiment, the print data is encrypted with the common key. It is generally said that the speed at which data is decrypted with a common key generated by the common key cryptography is approximately 1000 times higher than the speed at which the data is decrypted with a private key generated by the public key cryptography. Hence, print data with a large data amount can be decrypted rapidly with the common key.

Further, along with the above, according to the print system of this embodiment, the print client 20 can substantially restrict the printer able to print the encrypted print data which is encrypted and then transmitted, so that the execution of a print operation by a printer installed in a position where the user of the print client 20 does not intend to perform printing can be avoided.

### Third Embodiment

In the aforementioned second embodiment, the common key is generated on the printer 30 side, but in this embodiment, the common key is generated on the print client 20 side.

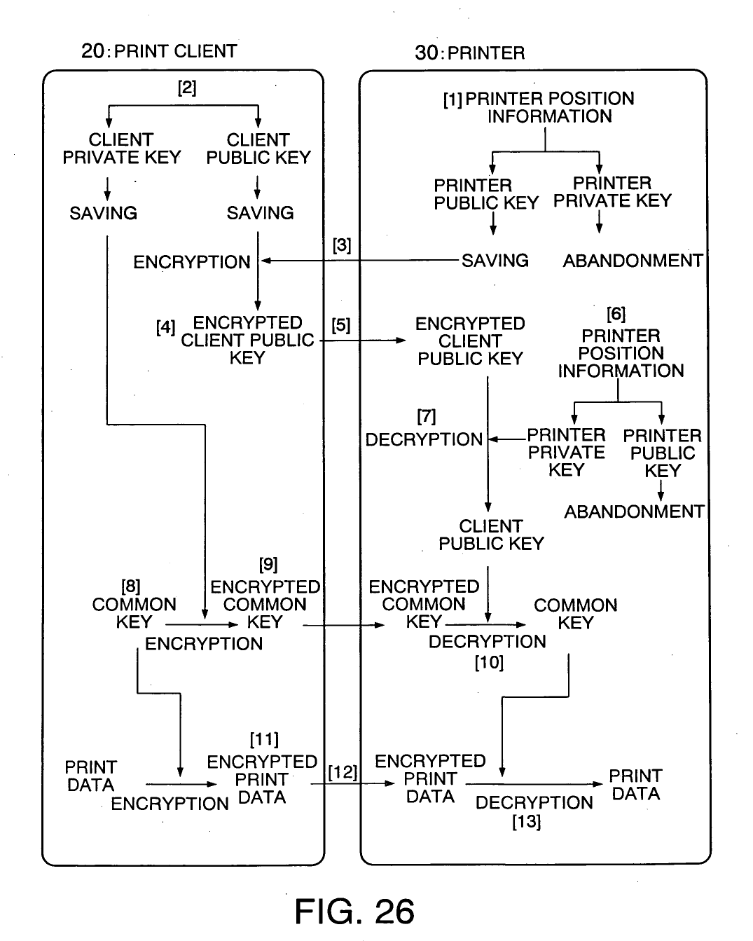

First, a summary of a process of a print system according to the third embodiment of the present invention will be presented based on FIG. 26. As shown in FIG. 26, in this embodiment, when the printer 30 is installed, the printer 30 generates a public key (printer public key) and a private key (printer private key) with a passphrase containing at least printer position information indicating a position where the printer 30 is installed, and holds the printer public key but abandons printer private key (step [1]).

On the other hand, the print client 20 generates a public key (client public key) and a private key (printer private key) with a passphrase or the like inputted by the user and holds both of these client public key and client private key (step [2]). The client public key and the client private key generated by the print client 20 are a public key and a private key which are independent of position information on the print client 20.

Then, the print client 20 requests the printer 30 to transmit the printer public key at any given timing, and the printer 30 transmits the printer public key to the print client 20 (step [3]).

The print client 20 which has received the printer public key encrypts the client public key with the printer public key to generate an encrypted client public key (step [4]). Then, this encrypted client public key is transmitted from the print client 20 to the printer 30 (step [5]).

The printer 30 which received the encrypted client public key decrypts this encrypted client public key at a point in time when the printer 30 has accepted a print request from the print client 20 to acquire the client public key. More specifically, the printer 30 acquires printer position information at this point in time and generates a printer public key and a printer private key with a passphrase containing at least this printer position information (step [6]). Then, the printer 30 decrypts the received encrypted client public key with the generated printer private key (step [7]). At this time, the printer public key is abandoned without being saved.

If the position of the printer 30 is not moved from a place where the printer public key was generated in step [1], the printer 30 can decrypt the encrypted client public key and acquire the client public key. However, if the position of the printer 30 is moved from the place where the printer public key was generated in step [1], the printer 30 cannot decrypt the encrypted client public key, and cannot acquire the client public key.

When making a print request to the printer 30, the print client 20 generates a common key with an appropriate random number or the like (step [8]), encrypts the common key with the client private key, and transmits it as an encrypted common key to the printer 30 (step [9]).

At a point in time when the encrypted common key has been received, the printer 30 decrypts the received encrypted common key with the client public key acquired in step [7] to acquire the common key (step [10]).

Moreover, the print client 20 generates print data, encrypts this print data with the common key (step [11]), and transmits it as encrypted print data to the printer 30 (step [12]).

The printer 30 which has received this encrypted print data decrypts the encrypted print data with the common key acquired in step [10] to acquire the print data (step [13]). After all, in this print system, the encrypted client public key can be decrypted with the printer private key acquired in step [6] in the printer 30 which is not moved from the installation position, but cannot be decrypted in the printer 30 which is moved therefrom. Hence, the position where the printer 30 can be properly used can be limited to the position where the printer public key was generated in step [1].

As can be known from the above description, in the print client 20, the client public key and the client private key are generated at any given timing, and they only need to be generated before a print request is made to the printer 30.

The encrypted client public key and the encrypted common key are also transmitted from the print client 20 to the printer 30 at any given timing. If they are transmitted to the printer 30 when a print request is made, this becomes a trigger for the print request, and hence the printer 30 is required to execute step [6] to acquire the printer private key at a point in time when the encrypted client public key or the encrypted common key has been received. On the other hand, if the encrypted client public key and the encrypted common key are transmitted from the print client 20 to the printer 30 before the print request is made, the printer 30 needs to hold the received encrypted client public key without decrypting it. Then, the printer 30 needs to execute the step [6] to acquire the printer private key at a point in time when the printer 30 has accepted the print request from the print client 20.

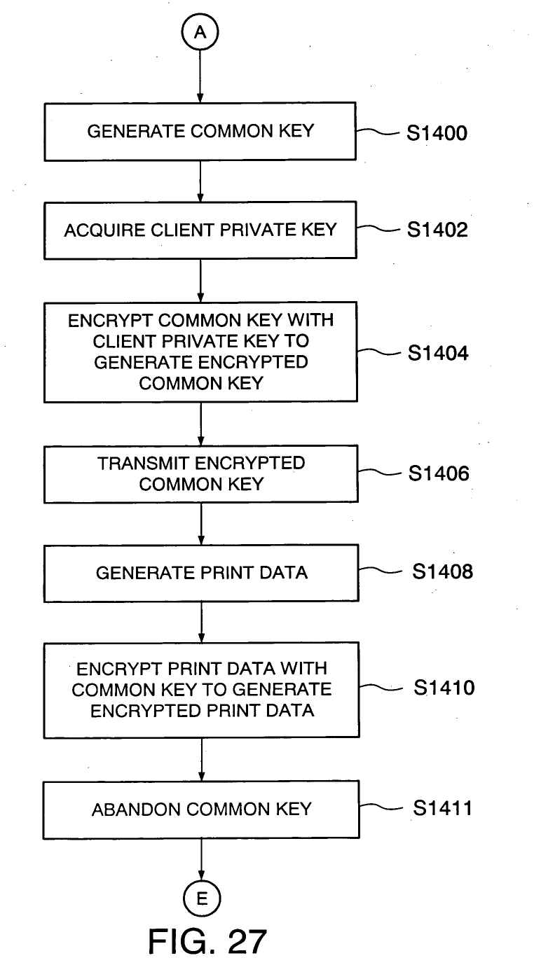

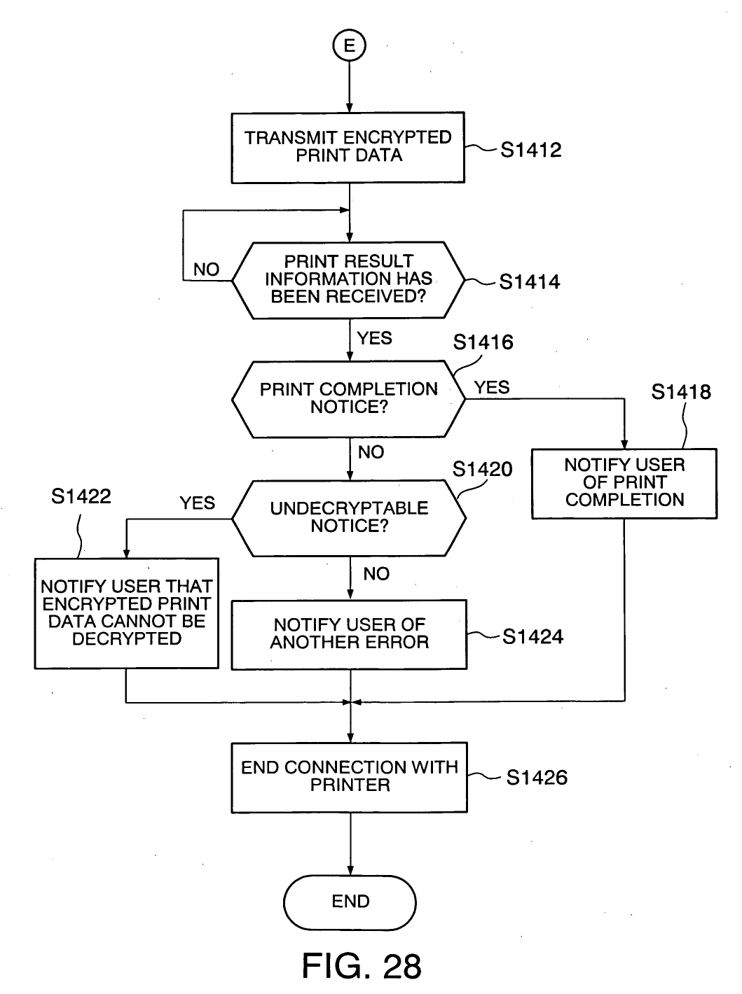

FIG. 27 and FIG. 28 are flowcharts explaining a print request process executed in the print client 20, and FIG. 27 shows a process subsequent to the aforementioned process in FIG. 20. This print request process is realized by making the CPU 64 read and execute a print request program stored in the ROM 68 or the hard disk 76 of the print client. In this embodiment, this print request process is started when the user creates data to be printed and instructs the print client 20 to print the data with the printer 30.

The process up to step S1400 in FIG. 27 is the same as that in FIG. 20 in the aforementioned second embodiment. Following step S1158 in FIG. 20, as shown in FIG. 27, the print client 20 generates a common key (step S1400).

Then, the print client 20 acquires the client private key from the client public key/private key storage TB60 (step S1402). Thereafter, the print client 20 encrypts the common key generated in step S1400 with this client private key to generate an encrypted common key (step S1404). Subsequently, the print client 20 transmits the encrypted common key to the printer 30 (step S1406).

Then, the print client 20 generates print data (step S1408). This print data is data required when the printer 30 actually executes a print operation.

Thereafter, the print client 20 encrypts the print data with the common key generated in step S1400 to generate encrypted print data (step S1410). Subsequently, the print client 20 abandons the common key generated in step S1400 (step S1411).

Then, as shown in FIG. 28, the print client 20 transmits this encrypted print data to the printer 30 (step S1412). More specifically, the print client 20 designates the network address of the printer 30 and sends out the encrypted print data to the network 10.

Thereafter, the print client 20 judges whether print result information has been received from the printer 30 (step S1414). When the print result information has not been received (step S1414: No), the print client 20 stands by while repeating the process in step S1414. On the other hand, when the print result information has been received (step S1414: Yes), the print client 20 judges whether the print result information is a print completion notice (step S1416).

When this print result information is the print completion notice (step S1416: Yes), it means that the printer 30 has properly completed the print operation, and hence the print client 20 notifies the user that the printer 30 has completed the print operation (step S1418). On the other hand, when the received print result information is not the print completion notice (step S1416: No), whether the print result information is an undecryptable notice is judged (step S1420).

When the print result information is the undecryptable notice (step S1420: Yes), the print client 20 notifies the user that since the encrypted client public key cannot be decrypted by the printer 30, the print operation has not been executed (step S1422). On the other hand, when the print result information is not the undecryptable notice (step S1420: No), some other error is thought to occur, and hence the print client 20 gives notice according to the type of the error to the user (step S1424).

After step S1418, step S1422, or step S1424, the print client 20 ends the connection with the printer 30 (step S1426), and the print request process is completed.

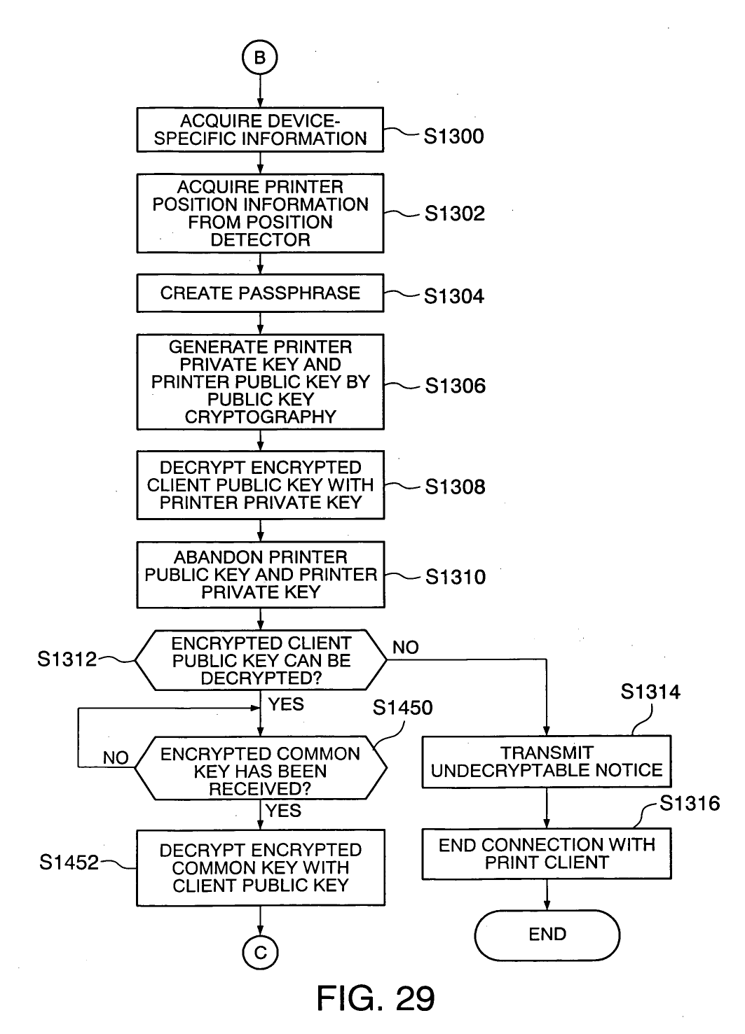

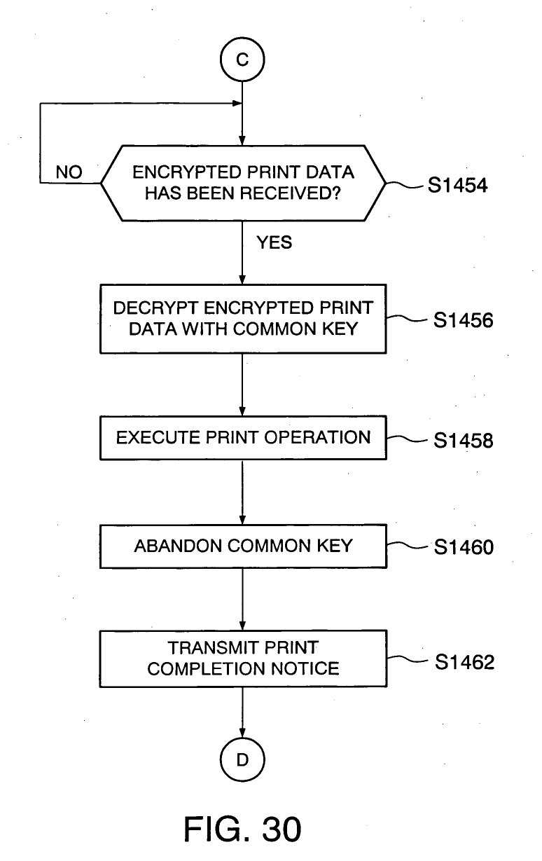

Next, a print execution process executed in the printer 30 corresponding to the print request process in the print client 20 will be explained based on FIG. 29 and FIG. 30. FIG. 29 and FIG. 30 are flowcharts explaining the print execution process executed in the printer 30, and FIG. 29 shows a process subsequent to the aforementioned process in FIG. 22. This print execution process is realized by making the CPU 40 read and execute a print execution program stored in the ROM 44 of the printer 30. In this embodiment, this print execution process is regularly executed.

The process up to step S1450 in FIG. 29 is the same as that in FIG. 22 and FIG. 23 in the aforementioned second embodiment. Following step S1312 in FIG. 23, as shown in FIG. 29, the printer 30 judges whether the encrypted common key has been received from the print client 20 (step S1450). When the encrypted common key has not been received (step S1450: No), the printer 30 stands by while repeating the process in step S1450.

On the other hand, when the encrypted common key has been received (step S1450: Yes), the printer 30 decrypts this encrypted common key with the client public key acquired in step S1308 to acquire the common key (step S1452).

Then, as shown in FIG. 30, the printer 30 judges whether the encrypted print data has been received from the print client 20 (step S1454). When the encrypted print data has not been received (step S1454: No), the printer 30 stands by while repeating the process in step S1454.

On the other hand, when the encrypted print data has been received (step S1454: Yes), the printer 30 decrypts the received encrypted print data with the common key acquired in step S1452 to acquire the print data (S1456). Subsequently, the printer 30 executes a print operation by driving the print engine 52 based on the acquired print data (step S1458). More specifically, the printer 30 performs a language interpretation of the print data and generates print request data fitting the print engine 52. Then, by transmitting this print request data to the print engine 52, print sheets or the like are printed by the print engine 52.

Thereafter, the printer 30 abandons the common key acquired in step S1452 (step S1460). Then, the printer 30 transmits the print completion notice to the print client 20 (step S1462). Subsequently, the printer 30 returns to the process in step S1260 in FIG. 22.

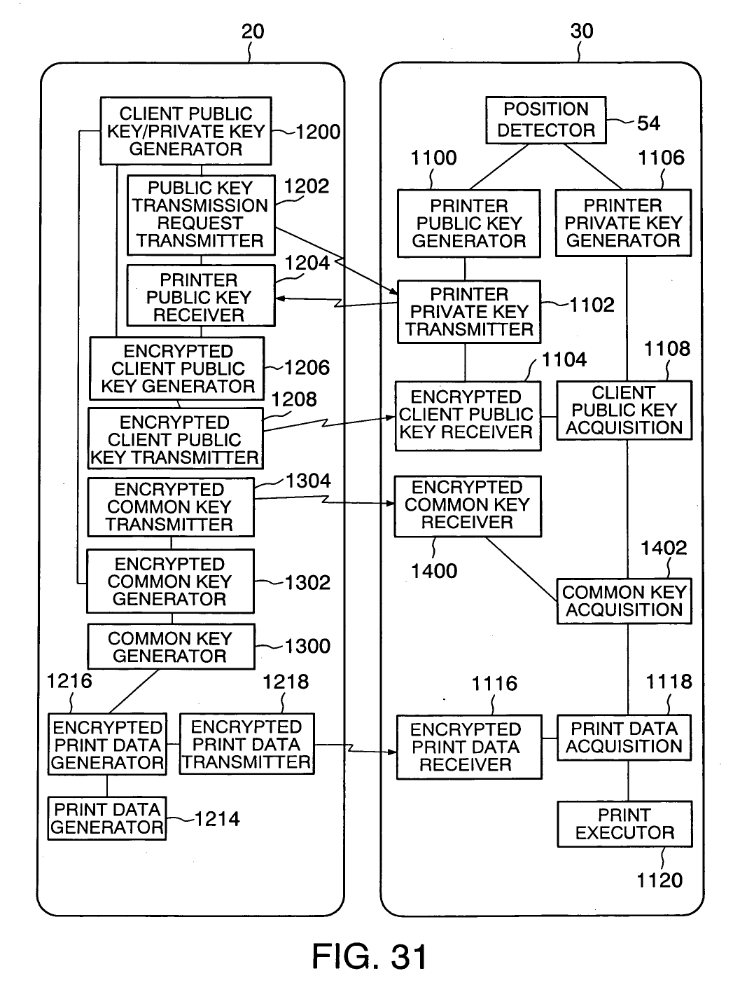

FIG. 31 is a functional block diagram showing a configuration when the aforementioned respective processes are realized by hardware, and corresponds to FIG. 25 in the aforementioned second embodiment. Only portions different from FIG. 25 will be explained. A common key generator 1300 of the print client 20 generates a common key by the common key cryptography. An encrypted common key generator 1302 encrypts the common key with the client public key generated by the client public key/private key generator 1200 to generate an encrypted common key. An encrypted common key transmitter 1304 transmits this generated encrypted common key to the printer 30.

An encrypted common key receiver 1400 of the printer 30 receives the encrypted common key transmitted from the print client 20. A common key acquisition 1402 decrypts the received encrypted common key with the client public key acquired by the client public key acquisition 1108 to acquire the common key.

On the other hand, the print data generator 1214 of the print client 20 generates print data. The encrypted print data generator 1216 encrypts the print data generated by the print data generator 1216 with the common key generated by the common key generator 1300 to generate encrypted print data. The encrypted print data transmitter 1218 transmits the generated encrypted print data to the printer 30.

The encrypted print data receiver 1116 of the printer 30 receives the encrypted print data transmitted from the print client 20. The print data acquisition 1118 decrypts the encrypted print data with the common key acquired by the common key acquisition 1402 to acquire the print data. Then, the print executor 1120 executes a print operation based on this print data.

Incidentally, processes other than the aforementioned processes executed by the print system according to this embodiment are the same as in the second embodiment, so that a detailed explanation thereof will be omitted.

As described above, also according to the print system of this embodiment, similarly to the aforementioned second embodiment, the printer 30 can execute a proper print operation only in a place where the printer public key was generated, whereby the place where the printer 30 can be used can be limited to the place where the printer public key was generated. Namely, in the printer 30 of this embodiment, when the printer 30 is moved to a place different from the place where the printer public key was generated, the encrypted client public key transmitted from the print client 20 cannot be decrypted correctly, so that the correct client public key cannot be acquired.

Moreover, in this embodiment, the print data is encrypted with the common key, so that the time needed to decrypt the encrypted print data in the printer 30 can be reduced to the shortest possible time.

It should be mentioned that the present invention is not limited to the aforementioned embodiments, and various changes may be made therein. For example, in the aforementioned embodiments, the device-specific information in addition to the printer position information is used for the passphrase, but the device-specific information is not always necessary.

Moreover, the explanation was given with the printer as an example of a data receiving device which restricts the position where it can be used, but the present invention is not limited to the printer. A data transmitting device is also not limited to the print client.

For example, in a data transmitting and receiving system, a data transmitting device may be a digital camera for taking images and the data receiving device may be a data server which stores data on the images taken by the digital camera. In this case, a client public key transmitted from the digital camera to the data server is encrypted with a public key received from the data server, and the data server which has received this encrypted client public key acquires the client public key in the aforementioned manner.

Further, data transmitted from the digital camera is encrypted with a common key generated by the data server (in the second embodiment) or a common key generated by the digital camera (in the third embodiment), and the data server which has received this encrypted data decrypts this encrypted data with the common key to acquire the data. Then, the data server stores the data when the data can be decrypted.

### Fourth Embodiment

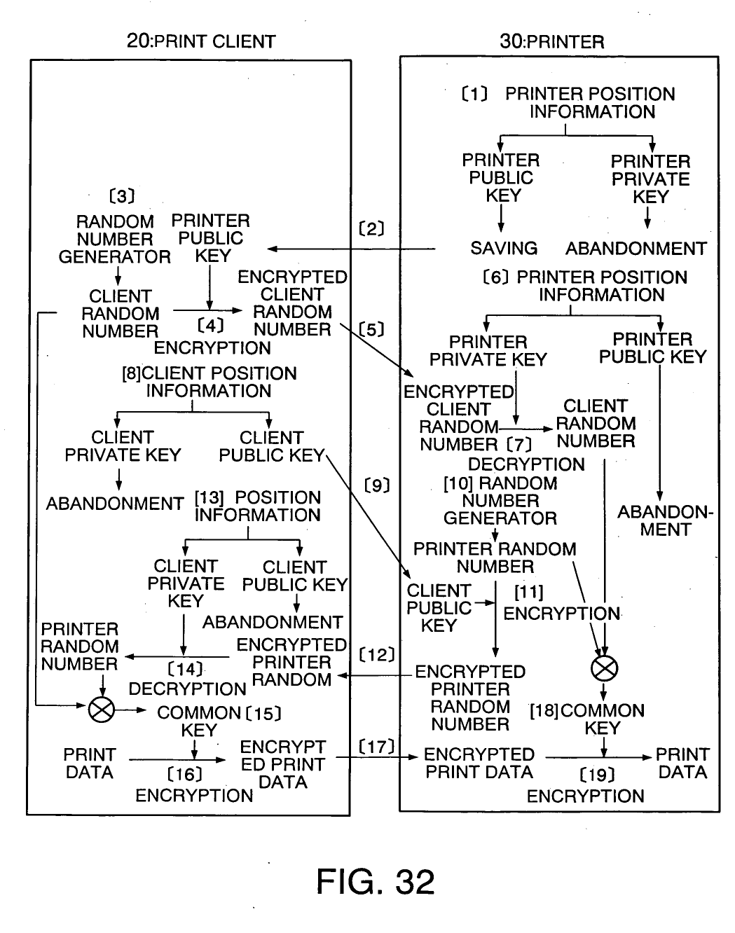

First, a summary of a process of a print system according to the fourth embodiment of the present invention will be presented based on FIG. 32. As shown in FIG. 32, in this embodiment, when the printer 30 is installed, the printer 30 generates a printer public key and a printer private key with a passphrase containing at least printer position information indicating a position where the printer 30 is installed, and holds the printer public key but abandons the printer private key (step [1]). Then, when the printer public key is requested by a print client 20 which wants to transmit print data, the printer 30 transmits the held printer public key to the print client 20 (step [2]).

The print client 20 generates an appropriate random number using a random number generator and regards this random number as a client random number (step [3]). Then, the print client 20 encrypts the client random number with the received printer public key to generate an encrypted client random number (step [4]). Subsequently, the print client 20 transmits this encrypted client random number to the printer 30 (step [5]).

The printer 30 which has received this encrypted client random number acquires again printer position information and generates a printer public key and a printer private key with a passphrase containing at least this printer position information (step [6]). Then, the printer 30 decrypts the encrypted client random number with the printer private key generated here to acquire the client random number (step [7]). Incidentally, the printer public key is abandoned without being saved, and the printer private key is also abandoned after the process in step [7].

On the other hand, when the print client 20 is installed, the print client 20 generates a client public key and a client private key with a passphrase containing at least client position information indicating a position where the print client 20 is installed, and holds the client public key but abandons the client private key (step [8]). Then, when the client public key is requested by the printer 30, the print client 20 transmits the held client public key to the printer 30 (step [9]).

The printer 30 creates an appropriate random number using a random number generator and regards this random number as a printer random number (step [10]). Then, the printer 30 encrypts the printer random number with the received client public key to generate an encrypted printer random number (step [11]). Subsequently, the printer 30 transmits this encrypted printer random number to the print client 20 (step [12]).

The print client 20 which has received this encrypted printer random number acquires again client position information and generates a client public key and a client private key with a passphrase containing at least this client position information (step [13]). Then, the print client 20 decrypts the encrypted printer random number with the client private key generated here to acquire the printer random number (step [14]). Incidentally, the client public key is abandoned without being saved, and the client private key is also abandoned after the process in step [14].

Subsequently, the print client 20 creates one variable based on the client random number and the printer random number and generates a common key with this variable (step [15]). There are various methods of generating the variable, for example, a method of multiplying the client random number by the printer random number, a method of calculating an exclusive-OR of the client random number and the printer random number, and a method of multiplying them by an appropriate expression.

Thereafter, the print client 20 generates print data and encrypts the print data with the common key to generate encrypted print data (step [16]). Then, the print client 20 transmits this encrypted print data to the printer 30 (step [17]).

On the other hand, the printer 30 creates one variable based on the client random number acquired in step [7] and the printer random number generated in step [10], and generates a common key with this variable (step [18]). Here, the method of creating the variable needs to be the same method in step [15] in the print client 20. In other words, the variable created here needs to be the same as the variable created in step [15]. Subsequently, the printer 30 decrypts the received encrypted print data with the generated common key to acquire the print data (step [19]). Then, the printer 30 executes a print operation based on this acquired print data.

After all, the printer 30 can decrypt the encrypted client random number if the printer 30 is not moved from a position where the printer public key was generated, and hence the proper common key can be generated. On the other hand, the print client 20 can decrypt the encrypted printer random number if the print client 20 is not moved from a position where the client public key was generated, and hence the proper common key can be generated. If both the printer 30 and the print client 20 can generate the proper common keys, it means that the printer 30 and the print client 20 hold the same common key. Namely, the encrypted print data encrypted with the common key in the print client 20 can be decrypted with the same common key in the printer 30.

As can be known from the above description, the timing when the printer public key is transmitted from the printer 30 to the print client 20 may be any given timing between the installation of the printer 30 and the occurrence of a print request. However, in order to restrict the position where the printer 30 can be used, it is desirable to perform the generation of the printer private key in step [6] after the occurrence of the print request in the print client 20. More specifically, it is desirable to perform the generation of the printer private key in step [6] after the printer 30 has received the encrypted client random number and/or after the printer 30 has received the encrypted print data.

Similarly, the timing when the client public key is transmitted from the print client 20 to the printer 30 may be any given timing between the installation of the print client 20 and the occurrence of the print request. However, in order to restrict the position where the print client 20 can be used, it is desirable to perform the generation of the client private key in step [13] after the occurrence of the print request in the print client 20. More specifically, it is desirable to perform the generation of the client private key in step [13] after the user instructs the print client 20 to execute a print operation.

Incidentally, the configuration of the print system according to this embodiment and the internal configuration of the printer 30 are the same as those in the first embodiment, but the internal configuration of the print client 20 is different from that in the first embodiment.

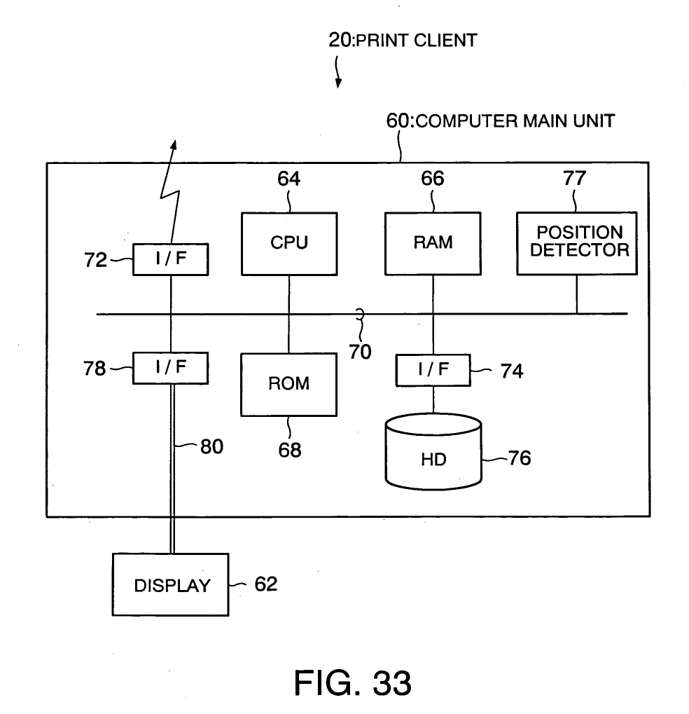

FIG. 33 is a block diagram for explaining the internal configuration of the print client 20 according to this embodiment. As shown in FIG. 33, the print client 20 according to this embodiment is configured by adding a position detector 77 to the print client 20 in the aforementioned first embodiment.

Namely, the position detector 77 is connected to the internal bus 70. This position detector 77 has a function of specifying a position where the print client 20 is installed. In this embodiment, the position detector 77 is constituted, for example, by a GPS (global positioning system), and the latitude, longitude, and altitude of the position where the print client 20 is installed can be specified.

However, the constitution of the position detector 77 is not limited to the constitution using the GPS, and, for example, when the print client 20 is connected to the network 10 by a wireless LAN, the position of the print client 20 may be specified based on a wireless base station which accommodates the print client 20. Alternatively, the position of the print client 20 may be specified by using mobile communication technology including the PHS (Personal Handyphone System).

Further, it is also possible that the position detector 77 includes both a GPS function and a PHS function and normally detects an installation position by the GPS, but when the position detector 77 cannot detect the position by the GPS due to radio wave conditions, it may detect the position by the PHS.

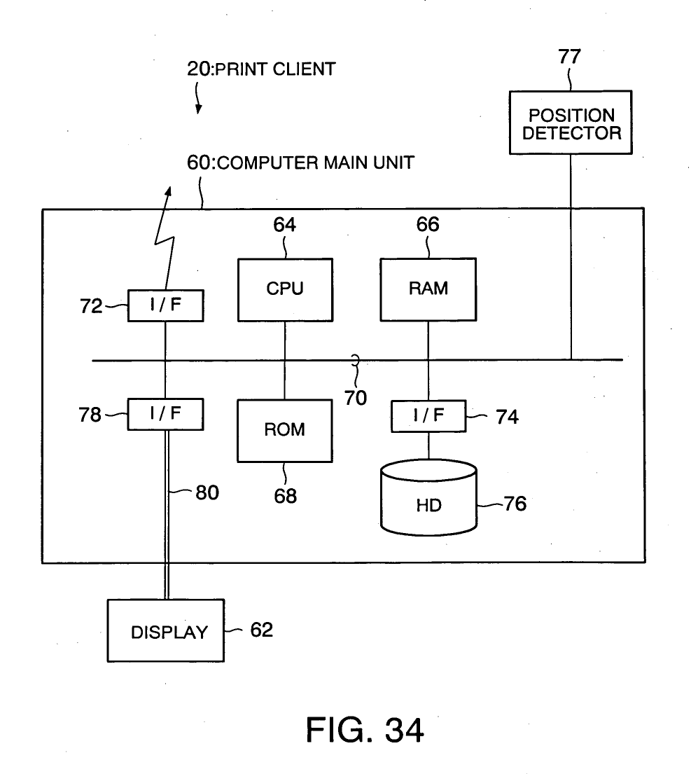

Furthermore, although the position detector 77 is contained in the print client 20 in FIG. 33, the position detector 77 may be provided outside the print client 20 as shown in FIG. 34. For example, it is possible that when the necessity arises, a cellular phone equipped with the GPS is connected to the print client 20, and thereby the print client 20 has a position detection function.

Next, processes executed in the printer 30 and the print client 20 to realize the process explained by means of FIG. 32 will be explained in detail.

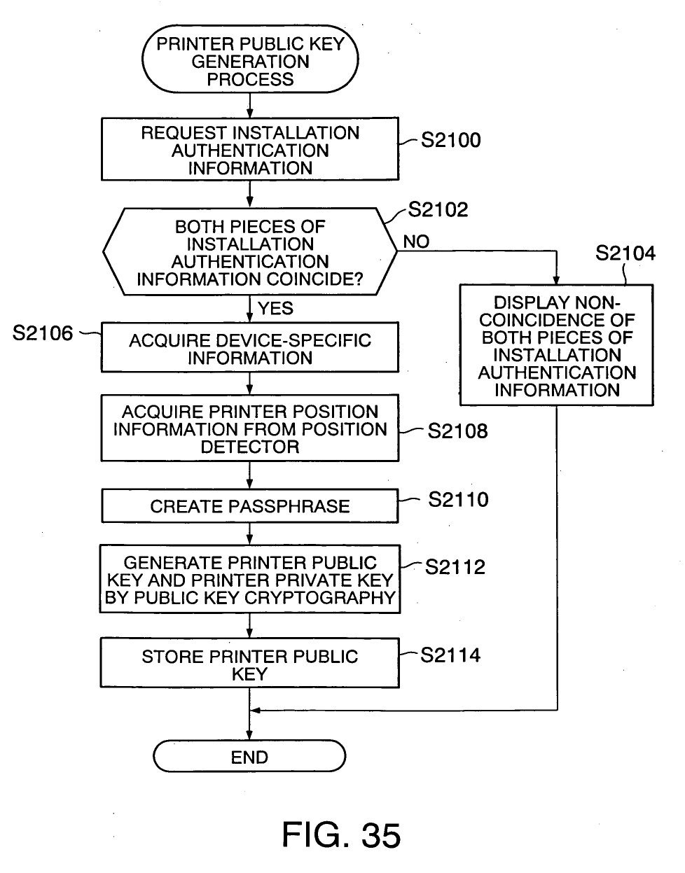

First, a printer public key generation process executed in the printer 30 when the printer 30 is installed will be explained based on FIG. 35. FIG. 35 is a flowchart explaining the printer public key generation process executed in the printer 30. This printer public key generation process is realized by making the CPU 40 read and execute a printer public key generation program stored in the ROM 44 of the printer.

As shown in FIG. 35, first, the printer 30 requests an operator of the printer 30 to input installation authentication information (step S2100). For example, the printer 30 displays an instruction to input installation authentication information on a display panel provided on this printer 30. The operator, for example, operates an operation panel provided on the printer 30 to input installation authentication information. For example, in this embodiment, the installation authentication information is composed of a combination of an ID and a password for installation authentication information. Hence, the operator inputs these ID and password for installation authentication information from the operation panel.

Then, the printer 30 judges whether the inputted installation authentication information coincides with installation authentication information previously registered with this printer 30 (step S2102). More specifically, the printer 30 judges whether the ID and the password for installation authentication information inputted by the operator as described above coincide with an ID and a password for installation authentication information previously registered with the printer 30. In this embodiment, for example, when the printer 30 is shipped, these ID and password for installation authentication information are stored in the EEPROM 56, and only a manufacturer of this printer 30 can know these ID and password for installation authentication information.

When these two pieces of installation authentication information do not coincide (step S2102: No), the printer 30 displays non-coincidence of the two pieces of installation authentication information on the display panel of the printer 30 (step S2104), and ends this common key generation process.

On the other hand, when these two pieces of installation authentication information coincide (step S2102: Yes), the printer 30 acquires device-specific information on the printer 30 (step S2106). Here, the device-specific information is identification information specifically assigned to the printer 30, and it is, for example, a manufacturer's serial number, a MAC address, or the like of the printer 30.

Then, the printer 30 acquires printer position information on the printer 30 at this point in time from the position detector 54 (step S2108). Subsequently, the printer 30 creates a passphrase with the device-specific information and the printer position information (step S2110). There are various methods of creating the passphrase, and in this embodiment, the passphrase is created by simply joining the printer position information after the device-specific information. Incidentally, the passphrase may contain data other than these device-specific information and printer position information.

Thereafter, the printer 30 generates a public key (printer public key) and a private key (printer private key) with the created passphrase by the public key cryptography (step S2112). The public key cryptography has the property that the same public key and private key are generated again if the same passphrase is used. Then, the printer 30 stores and holds only the printer public key out of the generated printer public key and printer private key (step S2114). Incidentally, the printer private key is abandoned without being saved. Thus, the printer public key generation process according to this embodiment is completed.

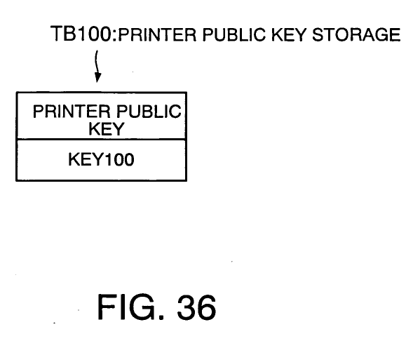

FIG. 36 is a diagram showing an example of a printer public key storage TB100 in which the printer public key is stored in step S2114. In this embodiment, this printer public key storage TB100 is formed in the EEPROM 56. Therefore, the printer public key stored in the printer public key storage TB100 is held in a nonvolatile manner even if the printer 30 is powered off.

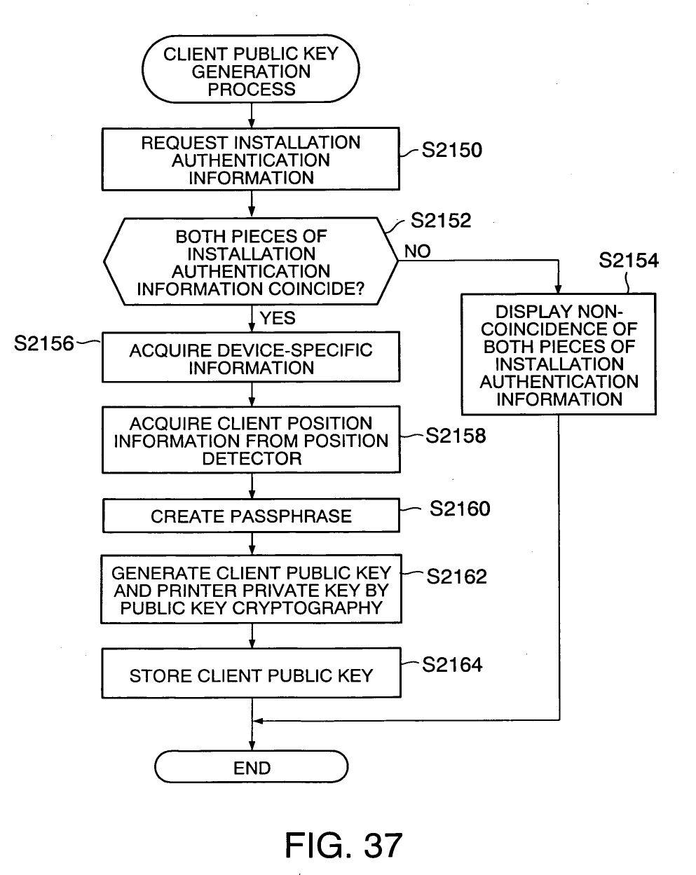

Next, a client public key generation process executed in the print client 20 when the print client 20 is installed will be explained based on FIG. 37. FIG. 37 is a flowchart explaining the client public key generation process executed in the print client 20. This client public key generation process is realized by making the CPU 64 read and execute a client public key generation program stored in the ROM 68 or the hard disk 76 of the print client 20.

As shown in FIG. 37, first, the print client 20 requests an operator of the print client 20 to input installation authentication information (step S2150). For example, the print client 20 displays an instruction to input installation authentication information on the display 62 of this print client 20. The operator, for example, operates a keyboard of the print client 20 to input installation authentication information. For example, in this embodiment, the installation authentication information is composed of a combination of an ID and a password for installation authentication information. Hence, the operator inputs these ID and password for installation authentication information from the keyboard.

Then, the print client 20 judges whether the inputted installation authentication information coincides with installation authentication information previously registered with this print client 20 (step S2152). More specifically, the print client 20 judges whether the ID and the password for installation authentication information inputted by the operator as described above coincide with an ID and a password for installation authentication information previously registered with the print client 20. In this embodiment, for example, when the print client 20 is shipped, these ID and password for installation authentication information are stored in the hard disk 76, and only a manufacturer of this print client 20 can know these ID and password for installation authentication information.

When these two pieces of installation authentication information do not coincide (step S2152: No), the print client 20 displays non-coincidence of the two pieces of installation authentication information on the display 62 of the print client 20 (step S2154), and ends this client public key generation process.

On the other hand, when these two pieces of installation authentication information coincide (step S2152: Yes), the print client 20 acquires device-specific information on the print client 20 (step S2156). Here, the device-specific information is identification information specifically assigned to the print client 20, and it is, for example, a manufacturer's serial number, a MAC address, or the like of the print client 20.

Then, the print client 20 acquires client position information on the print client 20 at this point in time from the position detector 77 (step S2158). Subsequently, the print client 20 creates a passphrase with the device-specific information and the client position information (step S2160). There are various methods of creating the passphrase, and in this embodiment, the passphrase is created by simply joining the client position information after the device-specific information. Incidentally, the passphrase may contain data other than these device-specific information and client position information.

Thereafter, the print client 20 generates a public key (client public key) and a private key (client private key) with the created passphrase by the public key cryptography (step S2162). The public key cryptography has the property that the same public key and private key are generated again if the same passphrase is used. Then, the print client 20 stores and holds only the client public key out of the generated client public key and client private key (step S2164). Incidentally, the client private key is abandoned without being saved. Thus, the client public key generation process according to this embodiment is completed.

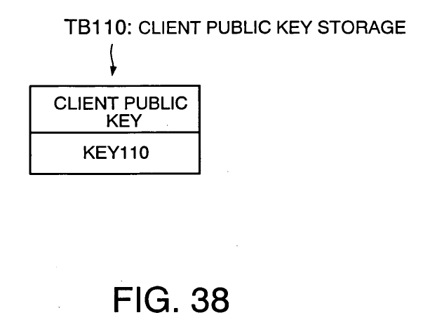

FIG. 38 is a diagram showing an example of a client public key storage TB110 in which the client public key is stored in step S2164. In this embodiment, this client public key storage TB110 is formed in the hard disk 76. Therefore, the client public key stored in the client public key storage TB110 is held in a nonvolatile manner even if the print client 20 is powered off.

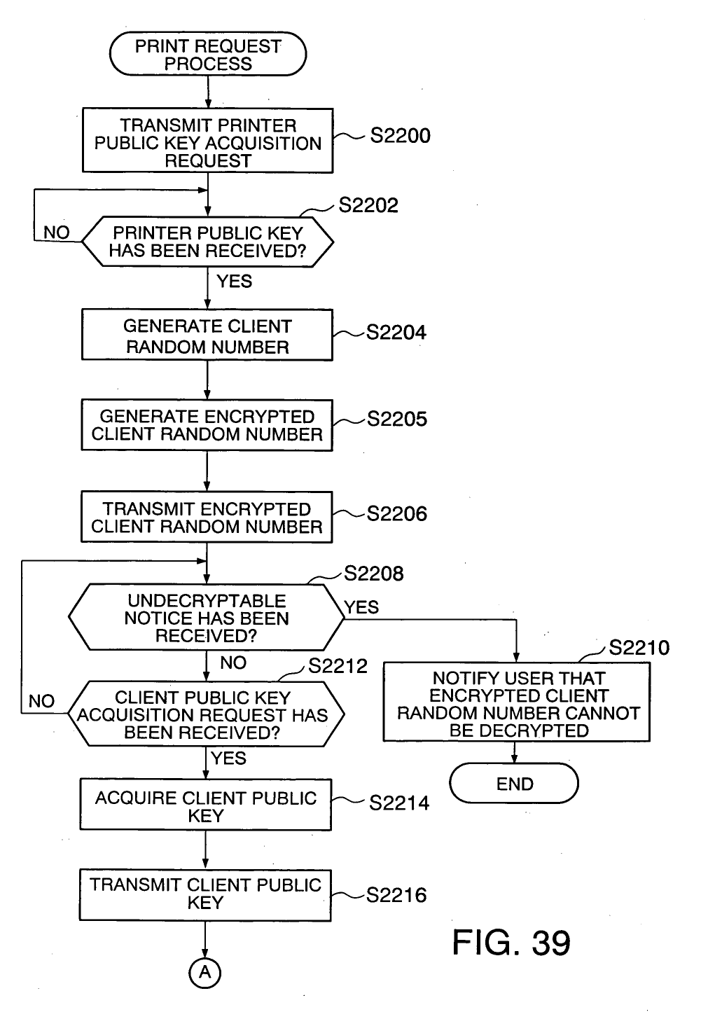

FIG. 39 to FIG. 41 are flowcharts explaining a print request process executed in the print client 20. This print request process is realized by making the CPU 64 read and execute a print request program stored in the ROM 68 or the hard disk 76 of the print client. In this embodiment, this print request process is started when the user creates data to be printed and instructs the print client 20 to print the data with the printer 30.

As shown in FIG. 39, first, the print client 20 transmits a printer public key acquisition request to request the transmission of the printer public key to the printer 30 (step S2220). Then, the print client 20 judges whether the printer public key has been received from the printer 30 (step S2202). When the printer public key has not been received (step S2202: No), the print client 20 stands by while repeating the process in step S2202.

On the other hand, when the printer public key has been received (step S2202: Yes), the print client 20 generates a random number and regards this random number as a client random number (step S2204). In this embodiment, the CPU 64 generates the random number in a software manner.

Then, the print client 20 encrypts the client random number generated in step S2204 with the printer public key received in step S2202 to generate an encrypted client random number (step S2205). Then, the print client 20 transmits this encrypted client random number to the printer 30 (step S2206).

Thereafter, the print client 20 judges whether an undecryptable notice has been received from the printer 30 (step S2208). When the undecryptable notice has been received (step S2208: Yes), the print client 20 notifies the user that the encrypted client random number cannot be decrypted by the printer 30 (step S2210), and ends this print request process.

On the other hand, when the undecryptable notice has not been received in step S2208 (step S2208: No), the print client 20 judges whether a client public key acquisition request has been received from the printer 30 (step S2212). When the client public key acquisition request has not been received (step S2212: No), the print client 20 repeats the aforementioned process from step S2208.

On the other hand, when the client public key acquisition request has been received (step S2212: Yes), the print client 20 acquires the client public key from the client public key storage TB110 (step S2214). Subsequently, the print client 20 transmits this client public key to the printer 30 (step S2216).

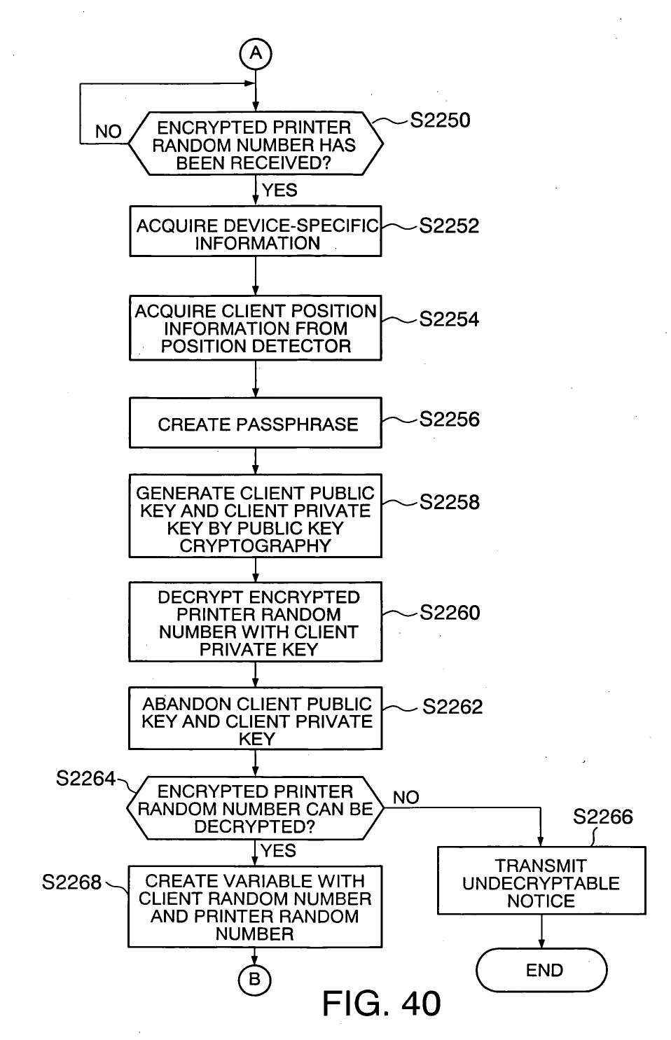

Then, as shown in FIG. 40, the print client 20 judges whether an encrypted printer random number has been received from the printer 30 (step S2250). When the encrypted printer random number has not been received (step S2250: No), the print client 20 stands by while repeating the process in step S2250.

On the other hand, when the encrypted printer random number has been received (step S2250: Yes), the print client 20 acquired device-specific information on the print client 20 (step S2252). Subsequently, the print client 20 acquires client position information on the print client 20 at this point in time from the position detector 77 (step S2254). The reason why the client position information is acquired from the position detector 77 each time as just described is that there is a possibility that the print client 20 is moved to a different place from a place where the print client 20 was initially installed, and in order that, in such a case, the print operation will not be executed by the print client 20.

Then, the print client 20 creates a passphrase based on the device-specific information and the client position information (step S2256). The method of creating the passphrase needs to be the same method as in step S2160 in the aforementioned client public key generation process. This is because, if the passphrases are different, the encrypted printer random number transmitted from the printer 30 cannot be decrypted with a client private key.

Thereafter, the print client 20 generates a client public key and a client private key with the passphrase generated in step S2256 by the public key cryptography (step S2258). Subsequently, the print client 20 decrypts the received encrypted printer random number with the generated client private key to acquire a printer random number (step S2260). Then, the print client 20 abandons the client public key and the client private key generated in step S2258 (step S2262).

Thereafter, the print client 20 judges whether the encrypted printer random number can be decrypted and the printer random number can be acquired in step S2260 (step S2264). When the encrypted printer random number cannot be decrypted (step S2264: No), the print client 20 notifies the user that since the print client 20 has been moved, the encrypted printer random number cannot be decrypted (step S2266), and ends this print request process.

On the other hand, when the encrypted printer random number can be decrypted (step S2264: Yes), the print client 20 creates one variable with the client random number generated in step S2204 and the printer random number acquired in step 52260 (step S2268). There are various methods of creating the variable, and in this embodiment, the variable is created by any of methods of (1) multiplying the client random number by the printer random number, (2) calculating an exclusive-OR of the client random number and the printer random number, and (3) multiplying them by an appropriate expression.

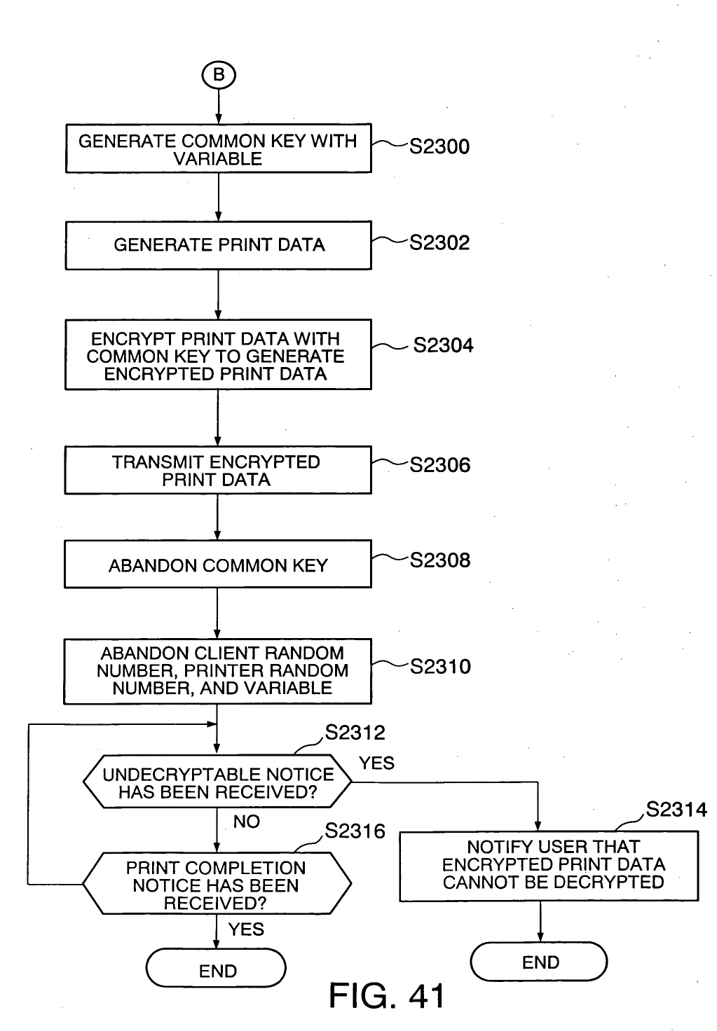

Thereafter, as shown in FIG. 41, the print client 20 generates a common key with the variable created in step S2268 (step S2300). Subsequently, the print client 20 generates print data (step S2302). This print data is data required when the printer 30 actually executes a print operation.

Subsequently, the print client 20 encrypts the generated print data with the common key generated in step S2300 to generate encrypted print data (step S2304). Then, the print client 20 transmits this encrypted print data to the printer 30 (step S2306). Thereafter, the print client 20 abandons the common key generated in step S2300 (step S2308). Then, the print client 20 abandons the client random number generated in step S2204, the printer random number acquired in step S2260, and the variable created in step S2268 (step S2310).

Thereafter, the print client 20 judges whether an undecryptable notice has been received from the printer 30 (step S2312). When the undecryptable notice has been received (step S2312: Yes), the print client 20 notifies the user that the encrypted print data cannot be decrypted, and ends this print request process.

On the other hand, when the undecryptable notice has not been received (step S2312: No), the print client 20 judges whether a print completion notice has been received from the printer 30 (step S2316). When the print completion notice has not been received (step S2316: No), the print client 20 repeats the aforementioned process from step S2312.

On the other hand, when the print completion notice has been received (step S2316: Yes), it means that the print operation has been properly completed, and thereby this print request process is completed.

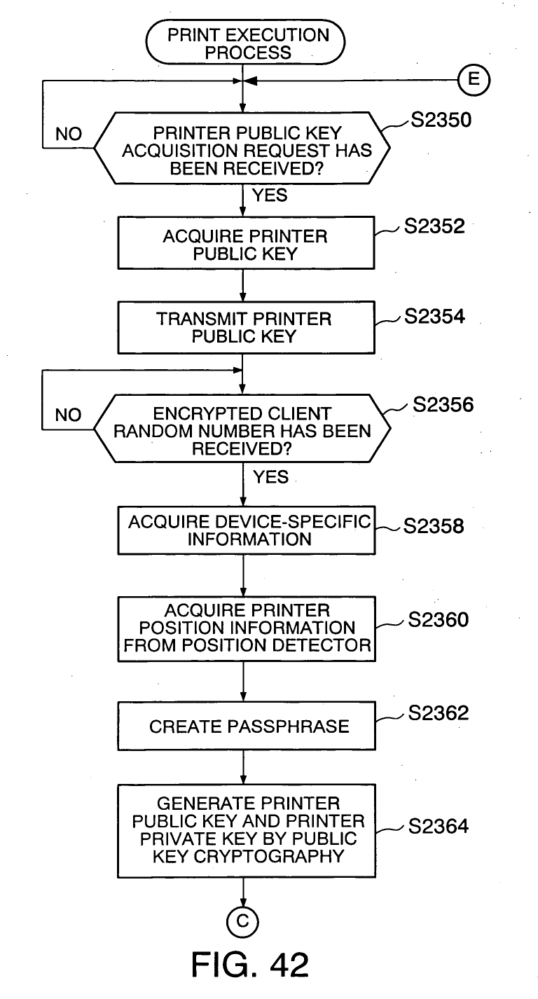

Next, a print execution process executed in the printer 30 corresponding to the print request process in the print client 20 will be explained based on FIG. 42 to FIG. 44. FIG. 42 to FIG. 44 are flowcharts explaining the print execution process executed in the printer 30. This print execution process is realized by making the CPU 40 read and execute a print execution program stored in the ROM 44 of the printer 30. In this embodiment, this print execution process is regularly executed.

As shown in FIG. 42, the printer 30 judges whether the printer public key acquisition request has been received from the print client 20 (step S2350). When the printer public key acquisition request has not been received (step S2350: No), the printer 30 stands by while repeating the process in step S2350.

On the other hand, when the printer public key acquisition request has been received (step S2350: Yes), the printer 30 acquires the printer public key from the printer public key storage TB100 (step S2352). Subsequently, the printer 30 transmits this printer public key to the print client 20 (step S2354).

Then, the printer 30 judges whether the encrypted client random number has been received from the print client 20 (step S2356). When the encrypted client random number has not been received (step S2356: No), the printer 30 stands by while repeating the process in step S2356.

On the other hand, when the encrypted client random number has been received (step S2356: Yes), the printer 30 acquires its own device-specific information (step S2358). Subsequently, the printer 30 acquires printer position information on the printer 30 on this point in time from the position detector 54 (step S2360). The reason why the printer position information is acquired from the position detector 54 each time as just described is that there is a possibility that the printer 30 is moved to a different place from a place where the printer 30 was initially installed, and in order that, in such a case, the print operation will not be executed by the printer 30.

Then, the printer 30 creates a passphrase based on the device-specific information and the printer position information (step S2362). The method of creating the passphrase needs to be the same method as in step S2110 in the aforementioned printer public key generation process. This is because, if the passphrases are different, the encrypted client random number transmitted from the print client 20 cannot be decrypted with a printer private key.

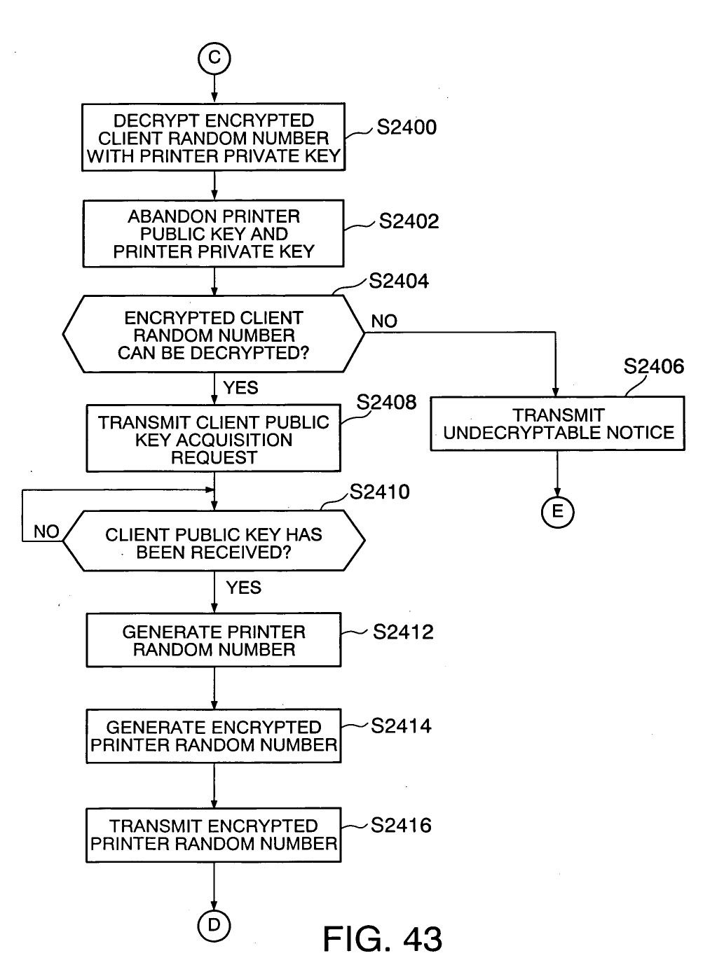

Thereafter, the printer 30 generates a printer public key and a printer private key with the passphrase by the public key cryptography (step S2364). Subsequently, as shown in FIG. 43, the printer 30 decrypts the received encrypted client random number with the generated printer private key to acquire the client random number (step S2400). Then, the printer 30 abandons the printer public key and the printer private key generated in step S2364 (step S2402).

Thereafter, the printer 30 judges whether the encrypted client random number can be decrypted and the client random number can be acquired in step S2400 (step S2404). When the encrypted client random number cannot be decrypted (step S2404: No), the printer 30 transmits the undecryptable notice that since the printer 30 has been moved, the encrypted client random number cannot be decrypted to the print client 20 (step S2406), and returns to the aforementioned process in step S2350.

On the other hand, when the encrypted client random number can be decrypted (step S2404: Yes), the printer 30 transmits the client public key acquisition request to request the transmission of the client public key to the print client 20 (step S2408). Subsequently, the printer 30 judges whether the client public key has been received from the print client 20 (step S2410). When the client public key has not been received (step S2410: No), the printer 30 stands by while repeating the process in step S2410.

On the other hand, when the client public key has been received (step S2410: Yes), the printer 30 generates a random number and regards this random number as a printer random number (step S2412). In this embodiment, the CPU 40 generates the random number in a software manner.

Then, the printer 30 encrypts the printer random number generated in step S2412 with the client public key received in step S2410 to generate the encrypted printer random number (step S2412). Subsequently, the printer 30 transmits this encrypted printer random number to the print client 20 (step S2416).

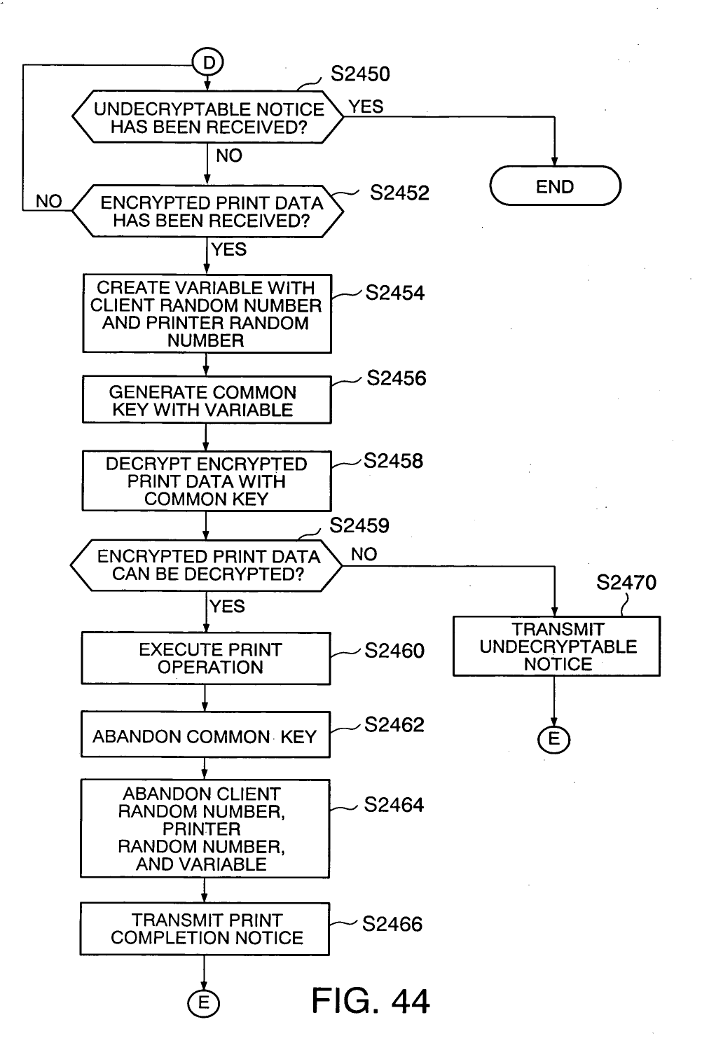

Thereafter, as shown in FIG. 44, the printer 30 judges whether the undecryptable notice has been received from the print client 20 (step S2450). When this undecryptable notice has been received (step S2450: Yes), the printer 30 returns to the aforementioned process in step S2350.

On the other hand, when the undecryptable notice has not been received in step S2450 (step S2450: No), the printer 30 judges whether the encrypted print data has been received from the print client 20 (step S2452). When the encrypted print data has not been received (step S2452: No), the printer 30 repeats the aforementioned process from step S2450.

On the other hand, when the encrypted print data has been received (step S2452: Yes), the printer 30 creates one variable with the client random number acquired in step S2400 and the printer random number generated in step S2412 (step S2454). The method of creating the variable in step S2454 needs to be the same as the aforementioned method of creating the variable in step S2268. Therefore, the variable created here becomes the same as that created in step S2268.

Then, the printer 30 generates a common key with the variable created in step S2454 (step S2456). The common key generated in step S2456 becomes the same as that generated in step S2300. This is because the variable used when the common key is generated is the same as that in step S2300.

Thereafter, the printer 30 decrypts the received encrypted print data with this common key to acquire the print data (step S2458). Subsequently, the printer 30 judges whether the encrypted print data can be decrypted (step S2459). When the encrypted print data cannot be decrypted (step S2459: No), the printer 30 transmits the undecryptable notice to the print client 20 (step S2470), and returns to the aforementioned process in step 52350.

On the other hand, when the encrypted print data can be decrypted (step S2459: Yes), the printer 30 executes a print operation by driving the print engine 52 based on the acquired print data (step S2460). More specifically, the printer 30 performs a language interpretation of the print data and generates print request data fitting the print engine 52. Then, by transmitting this print request data to the print engine 52, print sheets or the like are printed by the print engine 52.

Then, the printer 30 abandons the common key generated in step S2456 (step S2462). Subsequently, the printer 30 abandons the client random number acquired in step S2400, the printer random number generated in step S2412, and the variable created in step S2454 (step S2464). Thereafter, the printer 30 transmits the print completion notice that the print operation has been properly completed to the print client 20 (step S2466). Then, the printer 30 returns to the aforementioned process in step S2350.

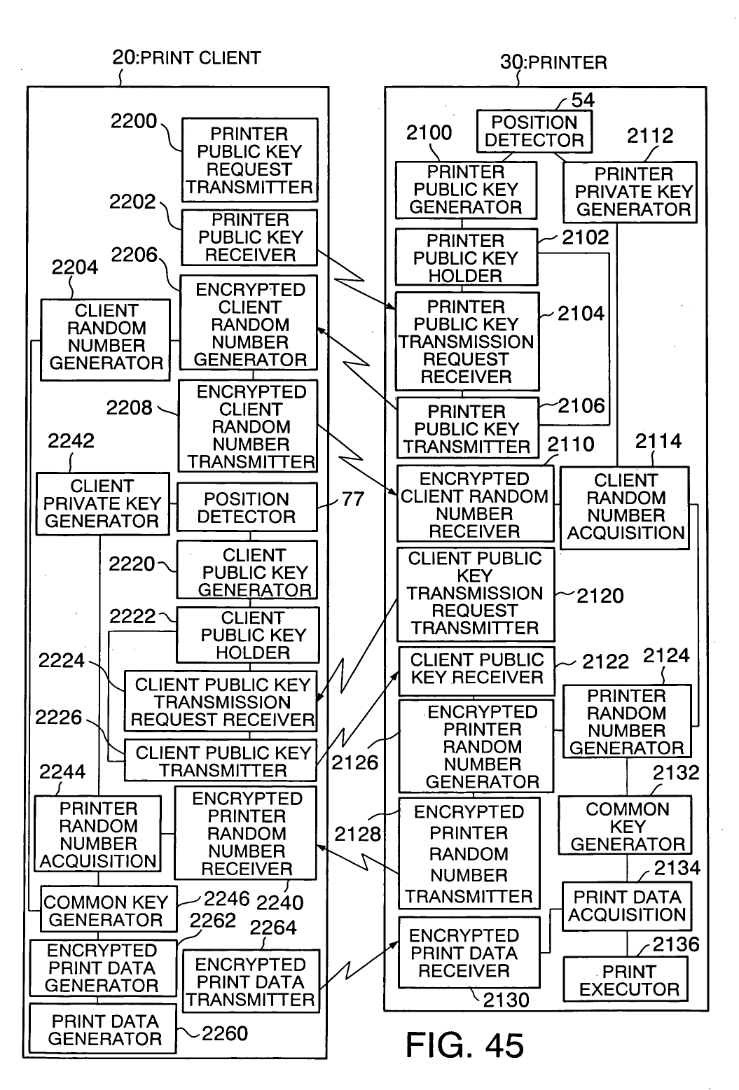

FIG. 45 is a functional block diagram showing a configuration when the aforementioned respective processes are realized by hardware. As shown in FIG. 45, after acquiring printer position information to specify a place where the printer 30 is installed from the position detector 54 and regarding this printer position information as first printer position information when the printer 30 is installed, a printer public key generator 2100 generates a printer public key with a passphrase containing at least this first printer position information. Then, a printer public key holder 2102 holds the printer public key generated by the printer public key generator 2100.

On the other hand, after acquiring client position information to specify a place where the print client 20 is installed from the position detector 77 and regarding this client position information as first client position information when the print client 20 is installed, a client public key generator 2220 generates a client public key with a passphrase containing at least this first client position information. Then, a client public key holder 2222 holds the client public key generated by the client public key generator 2220.

Then, in this embodiment, in the print client 20, when a print request is made from the user, a printer public key transmission acquisition transmitter 2200 transmits a printer public key transmission request to request the transmission of the printer public key to the printer 30. In the printer 30, a printer public key transmission request receiver 2106 receives the printer public key transmission request transmitted from the print client 20. When this printer public key transmission request has been received, in the printer 30, a printer public key transmitter 2016 reads the printer public key held by the printer public key holder 2102 and transmits it to the print client 20.

In the print client 20, a printer public key receiver 2202 receives the printer public key transmitted from the printer 30. Then, a client random number generator 2204 generates a client random number. Subsequently, an encrypted client random number generator 2206 generates an encrypted client random number by encrypting the client random number with the printer public key received by the printer public key receiver 2202. Thereafter, an encrypted client random number transmitter 2208 transmits this encrypted client random number to the printer 30.

An encrypted client random number receiver 2110 of the printer 30 receives the encrypted client random number transmitted from the print client 20. In the printer 30, printer position information is acquired from the position detector 54 and regarded as second printer position information. A printer private key generator 2112 generates a printer private key with a passphrase containing at least this second printer position information. A client random number acquisition 2114 decrypts the encrypted client random number with the printer private key generated by the printer private key generator 2112 to acquire the client random number.

A client public key transmission request transmitter 2120 of the printer 30 transmits a client public key transmission request to request the transmission of the client public key to the print client 20. This client public key transmission request is received by a client public key transmission request receiver 2224 of the print client 20. When the client public key transmission request has been received, a client public key transmitter 2226 of the print client 20 acquires the client public key from the client public key holder 2222 and transmits it to the printer 30.

The client public key transmitted from the print client 20 is received by a client public key receiver 2122 of the printer 30. When the client public key has been received, a printer random number generator 2124 of the printer 30 generates a printer random number. Then, an encrypted printer random number generator 2126 encrypts this printer random number with the client public key to generate an encrypted printer random number. Subsequently, an encrypted printer random number transmitter 2128 transmits the generated encrypted printer random number to the print client 20.

The encrypted printer random number transmitted from the printer 30 is received by an encrypted printer random number receiver 2240. In the print client 20 which has received the encrypted printer random number, a client private key generator 2242 acquires client position information at this point in time from the position detector 77, regards this client position information as second client position information, and generates a client private key with a passphrase containing at least this second client position information. A printer random number acquisition 2244 decrypts the encrypted printer random number with the generated client private key to acquire the printer random number. A common key generator 2246 generates one common key with the client random number generated by the client random number generator 2204 and the printer random number acquired by the printer random number acquisition 2244.

Then, in the print client 20, a print generator 2260 generates print data. Subsequently, an encrypted print data generator 2262 encrypts the print data with the common key to generate encrypted print data. Thereafter, an encrypted print data transmitter 2264 transmits this encrypted print data to the printer 30.

The encrypted print data transmitted from the print client 20 is received by an encrypted print data receiver 2130 of the printer 30. A common key acquisition 2132 generates a common key with the printer random number generated by the printer random number generator 2124 and the client random number acquired by the client random number acquisition 2114. Then, a print data acquisition 2134 decrypts the encrypted print data with this common key to acquire the print data, and a print executor 2136 executes a print operation based on this print data.

As described above, according to the print system of this embodiment, the print client 20 can make a proper print request only in a place where the client public key was generated, and the printer 30 can execute a proper print operation only in a place where the printer public key was generated. Therefore, the places where the print client 20 and the printer 30 can be used can be restricted.

Namely, in the printer 30 of this embodiment, when the printer 30 is moved to a place different from the place where the printer public key was generated, the encrypted client random number transmitted from the print client 20 cannot be decrypted correctly, so that the correct client random number cannot be acquired. Consequently, the printer 30 cannot generate the correct common key.

On the other hand, in the print client 20 of this embodiment, when the print client 20 is moved to a place different from the place where the client public key was generated, the encrypted printer random number transmitted from the printer 30 cannot be decrypted correctly, so that the correct printer random number cannot be acquired. Consequently, the print client 20 cannot generate the correct common key.

Moreover, in this embodiment, the print data is encrypted with the common key. It is generally said that the speed at which data is decrypted with a common key by the common key cryptography is approximately 1000 times higher than the speed at which the data is decrypted with a private key by the public key cryptography. Hence, print data with a large data amount can be decrypted rapidly with the common key.

Further, along with the above, according to the print system of this embodiment, the print client 20 can substantially restrict the position of the printer able to print the encrypted print data which is encrypted and then transmitted, so that the execution of a print operation by a printer installed in a position where the user of the print client 20 does not intend to perform printing can be avoided.

It should be mentioned that the present invention is not limited to the aforementioned embodiment, and various changes may be made therein. For example, in the aforementioned embodiment, in addition to the printer position information, the device-specific information is used for the passphrase, but the device-specific information is not always necessary.

Moreover, the explanation was given with the printer as an example of a data receiving device which restricts the position where it can be used, but the present invention is not limited to the printer. A data transmitting device is also not limited to the print client.

For example, in a data transmitting and receiving system, a data transmitting device may be a digital camera for taking images and a data receiving device may be a data server which stores data on the images taken by the digital camera. In this case, a random number transmitted from the digital camera is encrypted with a public key received from the data server, and the data server which has received this encrypted random number acquires the random number in the aforementioned manner, and acquires a common key. A random number transmitted from the data server is encrypted with a public key received from the digital camera, and the digital camera which has received this encrypted random number acquires the random number in the aforementioned manner and acquires a common key. Then, data transmitted from the digital camera is encrypted with the common key, and the data server which has received this encrypted data decrypts the encrypted data with the acquired common key to acquire the data. The data server stores the data when the data can be decrypted.

Moreover, in the aforementioned first embodiment to fourth embodiment, various changes may be made. For example, the explanation was given with the case where a print medium for the printer 30 is a print sheet as an example, but the print medium is not limited to this, and the present invention can be applied to other print media such as an OHP sheet and the like.

Besides, as for each process explained in the aforementioned first embodiment to fourth embodiment, it is possible to record a program to execute each process on a record medium such as a flexible disk, a CD-ROM (Compact Disc-Read Only Memory), a ROM, a memory card, or the like and distribute this program in the form of the record medium. In this case, the aforementioned embodiments can be realized by making the print client 20 and/or the printer 30 read the record medium on which this program is recorded and execute this program.

Additionally, the print client 20 and/or the printer 30 sometimes has other programs such as an operating system, other application programs, and the like. In this case, by using these other programs in the print client 20 and/or the printer 30, a command, which calls a program to realize a process equal to that in the aforementioned embodiments out of programs in the print client 20 and/or the printer 30, may be recorded on the record medium.

Moreover, such a program can be distributed not in the form of the record medium but in the form of a carrier wave via a network. The program transmitted in the form of the carrier wave over the network is incorporated in the print client 20 and/or the printer 30, and the aforementioned embodiments can be realized by executing this program.

Further, when being recorded on the record medium or transmitted as the carrier wave over the network, the program is sometimes encrypted or compressed. In this case, the print client 20 and/or the printer 30 which has read the program from the record medium or the carrier wave needs to execute the program after decrypting or expanding it.

1. A printer which executes a print operation based on print data, comprising:
a first printer position information acquisition which acquires first printer position information to specify a place where the printer is installed;
a first common key generator which creates a first variable based on the first printer position information and generates a first common key with the first variable;
a first common key storage in which the generated first common key is stored;
a first common key transmitter which transmits the first common key stored in the first common key storage to a print client in response to a request from the print client;
an encrypted print data receiver which receives encrypted print data generated by encrypting print data with the first common key from the print client;
a second printer position information acquisition which acquires second printer position information to specify a place where the printer is installed;
a second common key generator which creates a second variable based on the second printer position information and generates a second common key with the second variable; and
a print data acquisition which decrypts the encrypted print data with the second common key to acquire the print data.

2. The printer according to claim 1, further comprising:
a client public key receiver which receives a client public key from the print client, wherein
the first common key transmitter encrypts the first common key with the client public key and transmits this encrypted first common key to the print client.

3. The printer according to claim 1, wherein after the encrypted print data has been received by the encrypted print data receiver, the second printer position information acquisition acquires the second printer position information.

4. The printer according to claim 1, wherein the second common key generated by the second common key generator is abandoned after the encrypted print data has been decrypted by the print data acquisition.

5. The printer according to claim 1, wherein
the first common key generator creates the first variable based on the first printer position information and device-specific information which is information inherent in the printer, and
the second common key generator also creates the second variable based on the second printer position information and the device-specific information.

6. A control method of a printer which executes a print operation based on print data, comprising the steps of:
acquiring first printer position information to specify a place where the printer is installed;
creating a first variable based on the first printer position information and generating a first common key with the first variable;
storing the generated first common key in a first common key storage;
transmitting the first common key stored in the first common key storage to a print client in response to a request from the print client;
receiving encrypted print data generated by encrypting print data with the first common key from the print client;
acquiring second printer position information to specify a place where the printer is installed;
creating a second variable based on the second printer position information and generating a second common key with the second variable; and
decrypting the encrypted print data with the second common key to acquire the print data.

7. A print system including a printer which executes a print operation based on print data and a print client connected to the printer, wherein
the printer comprises:
a first printer position information acquisition which acquires first printer position information to specify a place where the printer is installed;
a first common key generator which creates a first variable based on the first printer position information and generates a first common key with the first variable; and
a first common key in which the generated first common key is stored,
the print client comprises:
a first common key transmission request transmitter which transmits a first common key transmission request to request transmission of the first common key to the printer,
the printer further comprises:
a first common key transmission request receiver which receives the first common key transmission request; and
a first common key transmitter which transmits the first common key stored in the first common key storage to the print client when the first common key transmission request has been received,
the print client further comprises:
a first common key receiver which receives the first common key;
an encrypted print data generator which encrypts print data with the first common key to generate encrypted print data; and
an encrypted print data transmitter which transmits the encrypted print data to the printer, and
the printer further comprises:
an encrypted print data receiver which receives the encrypted print data;
a second printer position information acquisition which acquires second printer position information to specify a place where the printer is installed;
a second common key generator which creates a second variable based on the second printer position information and generates a second common key with the second variable; and
a print data acquisition which decrypts the encrypted print data with the second common key to acquire the print data.

8. A control method of a print system including a printer which executes a print operation based on print data and a print client connected to the printer, comprising the steps of:
acquiring first printer position information to specify a place where the printer is installed;
creating a first variable based on the first printer position information and generating a first common key with the first variable in the printer;
storing the generated first common key in a first common key storage of the printer;
transmitting a first common key transmission request to request transmission of the first common key from the print client to the printer;
receiving the first common key transmission request in the printer;
transmitting the first common key stored in the first common key storage from the printer to the print client when the first common key transmission request has been received in the printer;
receiving the first common key in the print client;
encrypting print data with the first common key to generate encrypted print data in the print client;
transmitting the encrypted print data from the print client to the printer;
receiving the encrypted print data in the printer;
acquiring second printer position information to specify a place where the printer is installed;
creating a second variable based on the second printer position information and generating a second common key with the second variable in the printer; and
decrypting the encrypted print data with the second common key to acquire the print data in the printer.

9. A data receiving device which executes a process based on received data, comprising:
a first data receiving device position information acquisition which acquires first data receiving device position information to specify a place where the data receiving device is installed;
a first common key generator which creates a first variable based on the first data receiving device position information and generates a first common key with the first variable;
a first common key storage in which the generated first common key is stored;
a first common key transmitter which transmits the first common key stored in the first common key storage to a data transmitting device in response to a request from the data transmitting device;
an encrypted data receiver which receives encrypted data generated by encrypting data with the first common key from the data transmitting device;
a second data receiving device position information acquisition which acquires second data receiving device position information to specify a place where the data receiving device is installed;
a second common key generator which creates a second variable based on the second data receiving device position information and generates a second common key with the second variable; and
a data acquisition which decrypts the encrypted data with the second common key to acquire the data.

10. A data transmitting and receiving system including a data receiving device which executes a process based on data and a data transmitting device connected to the data receiving device, wherein
the data receiving device comprises:
a first data receiving device position information acquisition which acquires first data receiving device position information to specify a place where the data receiving device is installed;
a first common key generator which creates a first variable based on the first data receiving device position information and generates a first common key with the first variable; and
a first common key storage in which the generated first common key is stored,
the data transmitting device comprises:
a first common key transmission request transmitter which transmits a first common key transmission request to request transmission of the first common key to the data receiving device,
the data receiving device further comprises:
a first common key transmission request receiver which receives the first common key transmission request; and
a first common key transmitter which transmits the first common key stored in the first common key storage to the data transmitting device when the first common key transmission request has been received,
the data transmitting device further comprises:
a first common key receiver which receives the first common key;
an encrypted data generator which encrypts data with the first common key to generate encrypted data; and
an encrypted data transmitter which transmits the encrypted data to the data receiving device, and
the data receiving device further comprises:
an encrypted data receiver which receives the encrypted data;
a second data receiving device position information acquisition which acquires second data receiving device position information to specify a place where the data receiving device is installed;
a second common key generator which creates a second variable based on the second data receiving device position information and generates a second common key with the second variable; and
a data acquisition which decrypts the encrypted data with the second common key to acquire the data.

11. A printer which executes a print operation based on print data, comprising:
a first printer position information acquisition which acquires first printer position information to specify a place where the printer is installed;
a printer public key generator which generates a printer public key with a passphrase containing at least the first printer position information;
a printer public key storage in which the printer public key generated by the printer public key generator is stored;
a printer public key transmitter which transmits the printer public key stored in the printer public key storage to a print client in response to a request from the print client;
an encrypted client public key receiver which receives an encrypted client public key generated by encrypting a client public key with the printer public key from the print client;
a second printer position information acquisition which acquires second printer position information to specify a place where the printer is installed;
a printer private key generator which generates a printer private key with a passphrase containing at least the second printer position information; and
a client public key acquisition which decrypts the encrypted client public key received by the encrypted client public key receiver with the printer private key to acquire the client public key.

12. The printer according to claim 11, further comprising:
a common key generator which generates a common key;
an encrypted common key generator which encrypts the common key with the client public key to generate an encrypted common key; and
an encrypted common key transmitter which transmits the encrypted common key to the print client.

13. The printer according to claim 12, wherein after the encrypted common key has been generated by the encrypted common key generator, the client public key is abandoned.

14. The printer according to claim 13, further comprising:
an encrypted print data receiver which receives encrypted print data generated by encrypting print data with the common key from the print client; and
a print data acquisition which decrypts the encrypted print data with the common key generated by the common key generator to acquire the print data.

15. The printer according to claim 11, further comprising:
an encrypted common key receiver which receives an encrypted common key generated by encrypting a common key generated in the print client with a client private key; and
a common key acquisition which decrypts the encrypted common key with the client public key to acquire the common key.

16. The printer according to claim 15, wherein after the common key has been acquired by the common key acquisition, the client public key is abandoned.

17. The printer according to claim 16, further comprising:
an encrypted print data receiver which receives encrypted print data generated by encrypting print data with the common key from the print client; and
a print data acquisition which decrypts the encrypted print data with the common key acquired by the common key acquisition to acquire the print data.

18. The printer according to claim 11, wherein after a print request from the print client has been accepted, the second printer position information acquisition acquires the second printer position information.

19. The printer according to claim 18, wherein when the encrypted client public key has been received, this reception of the encrypted client public key is judged to be the print request.

20. The printer according to claim 11, wherein even if a printer private key is generated when the printer public key is generated by the printer public key generator, this printer private key is abandoned without being saved.

21. The printer according to claim 11, wherein even if a printer public key is generated when the printer private key is generated by the printer private key generator, this printer public key is abandoned without being saved.

22. The printer according to claim 11, wherein
the printer public key generator generates the printer public key with a passphrase containing device-specific information which is information inherent in the printer in addition to the first printer position information, and
the printer private key generator also generates the printer private key with a passphrase containing the device-specific information in addition to the second printer position information.

23. A control method of a printer which executes a print operation based on print data, comprising the steps of:
acquiring first printer position information to specify a place where the printer is installed;
generating a printer public key with a passphrase containing at least the first printer position information;
storing the generated printer public key in a printer public key storage;
transmitting the printer public key stored in the printer public key storage to a print client in response to a request from the print client;
receiving an encrypted client public key generated by encrypting a client public key with the printer public key from the print client;
acquiring second printer position information to specify a place where the printer is installed;
generating a printer private key with a passphrase containing at least the second printer position information; and
decrypting the received encrypted client public key with the printer private key to acquire the client public key.

24. A print system including a printer which executes a print operation based on print data and a print client connected to the printer, wherein
the printer comprises:
a first printer position information acquisition which acquires first printer position information to specify a place where the printer is installed;
a printer public key generator which generates a printer public key with a passphrase containing at least the first printer position information; and
a printer public key storage in which the printer public key generated by the printer public key generator is stored,
the print client comprises:
a public key transmission request transmitter which transmits a public key transmission request to request transmission of the printer public key to the printer,
the printer further comprises:
a public key transmission request receiver which receives the public key transmission request transmitted form the print client; and
a printer public key transmitter which transmits the printer public key stored in the printer public key storage to the print client in response to the received public key transmission request,
the print client further comprises:
a printer public key receiver which receives the printer public key transmitted from the printer;
an encrypted client public key generator which generates an encrypted client public key by encrypting a client public key with the printer public key; and
an encrypted client public key transmitter which transmits the encrypted client public key to the printer, and
the printer further comprises:
an encrypted client public key receiver which receives the encrypted client public key transmitted from the print client;
a second printer position information acquisition which acquires second printer position information to specify a place where the printer is installed;
a printer private key generator which generates a printer private key with a passphrase containing at least the second printer position information; and
a client public key acquisition which decrypts the encrypted client public key received by the encrypted client public key receiver with the printer private key to acquire the client public key.

25. A control method of a print system including a printer which executes a print operation based on print data and a print client connected to the printer, comprising the steps of:
acquiring first printer position information to specify a place where the printer is installed in the printer;
generating a printer public key with a passphrase containing at least the first printer position information in the printer;
storing the generated printer public key in a printer public key storage of the printer;
transmitting a public key transmission request to request transmission of the printer public key from the print client to the printer;
receiving the public key transmission request transmitted form the print client in the printer;
transmitting the printer public key stored in the printer public key storage from the printer to the print client in response to the received public key transmission request;
receiving the printer public key transmitted from the printer in the print client;
generating an encrypted client public key by encrypting a client public key with the printer public key in the print client;
transmitting the encrypted client public key from the print client to the printer;
receiving the encrypted client public key transmitted from the print client in the printer;
acquiring second printer position information to specify a place where the printer is installed;
generating a printer private key with a passphrase containing at least the second printer position information; and
decrypting the received encrypted client public key with the printer private key to acquire the client public key.

26. A data receiving device which executes a process based on received data, comprising:
a first data receiving device position information acquisition which acquires first data receiving device position information to specify a place where the data receiving device is installed;
a data receiving device public key generator which generates a data receiving device public key with a passphrase containing at least the first data receiving device position information;
a data receiving device public key storage in which the data receiving device public key generated by the data receiving device public key generator is stored;
a data receiving device public key transmitter which transmits the data receiving device public key stored in the data receiving device public key storage to a data transmitting device in response to a request from the data transmitting device;
an encrypted data transmitting device public key receiver which receives an encrypted data transmitting device public key generated by encrypting a data transmitting device public key with the data receiving device public key from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information; and
a data transmitting device public key acquisition which decrypts the encrypted data transmitting device public key received by the encrypted data transmitting device public key receiver with the data receiving device private key to acquire the data transmitting device public key.

27. A data transmitting and receiving system including a data receiving device which executes a process based on received data and a data transmitting device connected to the data receiving device, wherein
the data receiving device comprises:
a first data receiving device position information acquisition which acquires first data receiving device position information to specify a place where the data receiving device is installed;
a data receiving device public key generator which generates a data receiving device public key with a passphrase containing at least the first data receiving device position information; and
a data receiving device public key storage in which the data receiving device public key generated by the data receiving device public key generator is stored,
the data transmitting device comprises:
a public key transmission request transmitter which transmits a public key transmission request to request transmission of the data receiving device public key to the data receiving device,
the data receiving device further comprises:
a public key transmission request receiver which receives the public key transmission request transmitted form the data transmitting device; and
a data receiving device public key transmitter which transmits the data receiving device public key stored in the data receiving device public key storage to the data transmitting device in response to the received public key transmission request,
the data transmitting device further comprises:
a data receiving device public key receiver which receives the data receiving device public key transmitted from the data receiving device;
an encrypted data transmitting device public key generator which generates an encrypted data transmitting device public key by encrypting a data transmitting device public key with the data receiving device public key; and
an encrypted data transmitting device public key transmitter which transmits the encrypted data transmitting device public key to the data receiving device, and
the data receiving device further comprises:
an encrypted data transmitting device public key receiver which receives the encrypted data transmitting device public key transmitted from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information; and
a data transmitting device public key acquisition which decrypts the encrypted data transmitting device public key received by the encrypted data transmitting device public key receiver with the data receiving device private key to acquire the data transmitting device public key.

28. A printer which executes a print operation based on print data, comprising:
a first printer position information acquisition which acquires first printer position information to specify a place where the printer is installed;
a printer public key generator which generates a printer public key with a passphrase containing at least the first printer position information;
a printer public key storage in which the printer public key generated by the printer public key generator is stored;
a printer public key transmitter which transmits the printer public key stored in the printer public key storage to a print client in response to a request from the print client;
an encrypted client random number receiver which receives an encrypted client random number generated by encrypting a client random number with the printer public key from the print client;
a second printer position information acquisition which acquires second printer position information to specify a place where the printer is installed;
a printer private key generator which generates a printer private key with a passphrase containing at least the second printer position information;
a client random number acquisition which decrypts the encrypted client random number with the printer private key to acquire the client random number;
a printer random number generator which generates a printer random number;
a common key generator which generates a common key with the printer random number and the client random number;
an encrypted print data receiver which receives encrypted print data generated by encrypting print data from the print client; and
a print data acquisition which decrypts the encrypted print data with the common key to acquire the print data.

29. The printer according to claim 28, further comprising:
a client public key receiver which receives a client public key from the print client;
an encrypted printer random number generator which generates an encrypted printer random number by encrypting the printer random number with the client public key; and
an encrypted printer random number transmitter which transmits the encrypted printer random number to the print client.

30. The printer according to claim 28, wherein after the encrypted client random number has been received by the encrypted client random number receiver and/or the encrypted print data has been received by the encrypted print data receiver, the second printer position information acquisition acquires the second printer position information.

31. The printer according to claim 28, wherein even if a printer private key is generated when the printer public key is generated by the printer public key generator, this printer private key is abandoned without being saved.

32. The printer according to claim 28, wherein even if a printer public key is generated when the printer private key is generated by the printer private key generator, this printer public key is abandoned without being saved.

33. The printer according to claim 28, wherein the printer private key generated by the printer private key generator is abandoned after the encrypted client random number has been decrypted by the client random number acquisition.

34. The printer according to claim 28, wherein the common key generated by the common key generator is abandoned after the encrypted print data has been decrypted by the print data acquisition.

35. The printer according to claim 28, wherein
the printer public key generator generates the printer public key with a passphrase containing device-specific information which is information inherent in the printer in addition to the first printer position information, and
the printer private key generator also generates the printer private key with a passphrase containing the device-specific information in addition to the second printer position information.

36. A control method of a printer which executes a print operation based on print data, comprising the steps of:
acquiring first printer position information to specify a place where the printer is installed;
generating a printer public key with a passphrase containing at least the first printer position information;
storing the generated printer public key in a printer public key storage;
transmitting the printer public key stored in the printer public key storage to a print client in response to a request from the print client;
receiving an encrypted client random number generated by encrypting a client random number with the printer public key from the print client;
acquiring second printer position information to specify a place where the printer is installed;
generating a printer private key with a passphrase containing at least the second printer position information;
decrypting the encrypted client random number with the printer private key to acquire the client random number;
generating a printer random number;
generating a common key with the printer random number and the client random number;
receiving encrypted print data generated by encrypting print data from the print client; and
decrypting the encrypted print data with the common key to acquire the print data.

37. A print client which generates print data, comprising:
a first client position information acquisition which acquires first client position information to specify a place where the print client is installed;
a client public key generator which generates a client public key with a passphrase containing at least the first client position information;
a client public key storage in which the client public key generated by the client public key generator is stored;
a client public key transmitter which transmits the client public key stored in the client public key storage to a printer;
an encrypted printer random number receiver which receives an encrypted printer random number generated by encrypting a printer random number with the client public key from the printer;
a second client position information acquisition which acquires second client position information to specify a place where the print client is installed;
a client private key generator which generates a client private key with a passphrase containing at least the second client position information;
a printer random number acquisition which decrypts the encrypted printer random number with the client private key to acquire the printer random number;
a client random number generator which generates a client random number;
a common key generator which generates a common key with the printer random number and the client random number;
an encrypted print data generator which generates encrypted print data by encrypting print data with the common key; and
an encrypted print data transmitter which transmits the encrypted print data to the printer.

38. A control method of a print client which generates print data, comprising the steps of:
acquiring first client position information to specify a place where the print client is installed;
generating a client public key with a passphrase containing at least the first client position information;
storing the generated client public key in a client public key storage;
transmitting the client public key stored in the client public key storage to a printer in response to a request from the printer;
receiving an encrypted printer random number generated by encrypting a printer random number with the client public key from the printer;
acquiring second client position information to specify a place where the print client is installed;
generating a client private key with a passphrase containing at least the second client position information;
decrypting the encrypted printer random number with the client private key to acquire the printer random number;
generating a client random number;
generating a common key with the printer random number and the client random number;
generating encrypted print data by encrypting print data with the common key; and
transmitting the encrypted print data to the printer.

39. A print system including a printer which executes a print operation based on print data and a print client connected to the printer, wherein
the printer comprises:
a first printer position information acquisition which acquires first printer position information to specify a place where the printer is installed;
a printer public key generator which generates a printer public key with a passphrase containing at least the first printer position information; and
a printer public key storage in which the printer public key generated by the printer public key generator is stored,
the print client comprises:
a printer public key transmission request transmitter which transmits a printer public key transmission request to request transmission of the printer public key to the printer,
the printer further comprises:
a printer public key transmission request receiver which receives the printer public key transmission request transmitted from the print client; and
a printer public key transmitter which transmits the printer public key stored in the printer public key storage to the print client when the printer public key transmission request has been received,
the print client further comprises:
a printer public key receiver which receives the printer public key transmitted from the printer;
a client random number generator which generates a client random number;
an encrypted client random number generator which generates an encrypted client random number by encrypting the client random number with the printer public key; and
an encrypted client random number transmitter which transmits the encrypted client random number to the printer, and
the printer further comprises:
an encrypted client random number receiver which receives the encrypted client random number transmitted from the print client;
a second printer position information acquisition which acquires second printer position information to specify a place where the printer is installed;
a printer private key generator which generates a printer private key with a passphrase containing at least the second printer position information;
a client random number acquisition which decrypts the encrypted client random number with the printer private key to acquire the client random number;
a printer random number generator which generates a printer random number;
a common key generator which generates a common key with the printer random number and the client random number;
an encrypted print data receiver which receives encrypted print data generated by encrypting print data from the print client; and
a print data acquisition which decrypts the encrypted print data with the common key to acquire the print data.

40. A control method of a print system including a printer which executes a print operation based on print data and a print client connected to the printer, comprising the steps of:
acquiring first printer position information to specify a place where the printer is installed;
generating a printer public key with a passphrase containing at least the first printer position information in the printer;
storing the generated printer public key in a printer public key storage;
transmitting a printer public key transmission request to request transmission of the printer public key from the print client to the printer;
receiving the printer public key transmission request transmitted from the print client in the printer;
transmitting the printer public key stored in the printer public key storage from the printer to the print client when the printer public key transmission request has been received;
receiving the printer public key transmitted from the printer in the print client;
generating a client random number in the print client;
generating an encrypted client random number by encrypting the client random number with the printer public key;
transmitting the encrypted client random number from the print client to the printer;
receiving the encrypted client random number transmitted from the print client in the printer;
acquiring second printer position information to specify a place where the printer is installed;
generating a printer private key with a passphrase containing at least the second printer position information in the printer;
decrypting the encrypted client random number with the printer private key to acquire the client random number in the printer;
generating a printer random number in the printer;
generating a common key with the printer random number and the client random number in the printer;
transmitting encrypted print data generated by encrypting print data from the print client to the printer;
receiving the encrypted print data in the printer; and
decrypting the encrypted print data with the common key to acquire the print data in the printer.

41. A data receiving device which executes a process based on received data, comprising:
a first data receiving device position information acquisition which acquires first data receiving device position information to specify a place where the data receiving device is installed;
a data receiving device public key generator which generates a data receiving device public key with a passphrase containing at least the first data receiving device position information;
a data receiving device public key storage in which the data receiving device public key generated by the data receiving device public key generator is stored;
a data receiving device public key transmitter which transmits the data receiving device public key stored in the data receiving device public key storage to a data transmitting device in response to a request from the data transmitting device;
an encrypted data transmitting device random number receiver which receives an encrypted data transmitting device random number generated by encrypting a data transmitting device random number with the data receiving device public key from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information;
a data transmitting device random number acquisition which decrypts the encrypted data transmitting device random number with the data receiving device private key to acquire the data transmitting device random number;
a data receiving device random number generator which generates a data receiving device random number;
a common key generator which generates a common key with the data receiving device random number and the data transmitting device random number;
an encrypted data receiver which receives encrypted data generated by encrypting data from the data transmitting device; and
a data acquisition which decrypts the encrypted data with the common key to acquire the data.

42. A data transmitting device which generates data to be transmitted, comprising:
a first data transmitting device position information acquisition which acquires first data transmitting device position information to specify a place where the data transmitting device is installed;
a data transmitting device public key generator which generates a data transmitting device public key with a passphrase containing at least the first data transmitting device position information;
a data transmitting device public key storage in which the data transmitting device public key generated by the data transmitting device public key generator is stored;
a data transmitting device public key transmitter which transmits the data transmitting device public key stored in the data transmitting device public key storage to a data receiving device in response to a request from the data receiving device;
an encrypted data receiving device random number receiver which receives an encrypted data receiving device random number generated by encrypting a data receiving device random number with the data transmitting device public key from the data receiving device;
a second data transmitting device position information acquisition which acquires second data transmitting device position information to specify a place where the data transmitting device is installed;
a data transmitting device private key generator which generates a data transmitting device private key with a passphrase containing at least the second data transmitting device position information;
a data receiving device random number acquisition which decrypts the encrypted data receiving device random number with the data transmitting device private key to acquire the data receiving device random number;
a data transmitting device random number generator which generates a data transmitting device random number;
a common key generator which generates a common key with the data receiving device random number and the data transmitting device random number;
an encrypted data generator which generates encrypted data by encrypting data with the common key; and
an encrypted data transmitter which transmits the encrypted data to the data receiving device.

43. A data transmitting and receiving system including a data receiving device which executes a process based on received data and a data transmitting device connected to the data receiving device, wherein
the data receiving device comprises:
a first data receiving device position information acquisition which acquires first data receiving device position information to specify a place where the data receiving device is installed;
a data receiving device public key generator which generates a data receiving device public key with a passphrase containing at least the first data receiving device position information; and
a data receiving device public key storage in which the data receiving device public key generated by the data receiving device public key generator is stored,
the data transmitting device comprises:
a data receiving device public key transmission request transmitter which transmits a data receiving device public key transmission request to request transmission of the data receiving device public key to the data receiving device,
the data receiving device further comprises:
a data receiving device public key transmission request receiver which receives the data receiving device public key transmission request transmitted from the data transmitting device; and
a data receiving device public key transmitter which transmits the data receiving device public key stored in the data receiving device public key storage to the data transmitting device when the data receiving device public key transmission request has been received,
the data transmitting device further comprises:
a data receiving device public key receiver which receives the data receiving device public key transmitted from the data receiving device;
a data transmitting device random number generator which generates a data transmitting device random number;
an encrypted data transmitting device random number generator which generates an encrypted data transmitting device random number by encrypting the data transmitting device random number with the data receiving device public key; and
an encrypted data transmitting device random number transmitter which transmits the encrypted data transmitting device random number to the data receiving device, and
the data receiving device further comprises:
an encrypted data transmitting device random number receiver which receives the encrypted data transmitting device random number transmitted from the data transmitting device;
a second data receiving device position information acquisition which acquires second data receiving device position information to specify a place where the data receiving device is installed;
a data receiving device private key generator which generates a data receiving device private key with a passphrase containing at least the second data receiving device position information;
a data transmitting device random number acquisition which decrypts the encrypted data transmitting device random number with the data receiving device private key to acquire the data transmitting device random number;
a data receiving device random number generator which generates a data receiving device random number;
a common key generator which generates a common key with the data receiving device random number and the data transmitting device random number;
an encrypted data receiver which receives encrypted data generated by encrypting data from the data transmitting device; and
a data acquisition which decrypts the encrypted data with the common key to acquire the data.
